(19) United States
(12) Patent Application Publication
(10) Pub. No.: US 2005/0102374 A1
(43) Pub. Date: May 12, 2005

(54) System and method for integration of a universally publicly accessible global network

(75) Inventors: Jonathan D. Moragne, Burlington, NJ (US); Rupananda Misra, East Norriton, PA (US); Thomas S. Basmajian, Philadelphia, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: ZEPHYR MEDIA, INC.

(21) Appl. No.: 10/941,652

(22) Filed: Sep. 15, 2004

Related U.S. Application Data
(63) Continuation of application No. 09/732,581, filed on Dec. 8, 2000, now abandoned.
(60) Provisional application No. 60/169,894, filed on Dec. 9, 1999.
(60) Provisional application No. 60/177,499, filed on Jan. 21, 2000.

(51) Int. Cl. G06F 15/16

(52) U.S. Cl. 709/217

(57) ABSTRACT

The present invention is a system and method for integrated operation, provision of user services, and management and control, for a publicly accessible global network. The global network has one or more horizontal levels for the provision of user services, network operation, overall management and control in a vertical hierarchy, and one or more horizontal levels of data management, including data capture, processing, analysis, reporting, etc. The system further includes Universal Software which integrates the functionalities of various software platforms into one unified integrated software. The system incorporates a plurality of components for connecting any user directly to applications, and enterprise sites and consumer sites for connecting users via the global network directly to other networks, data bases and computer devices, of emergency services personnel/agencies, for performing simultaneously mathematical formulae, algorithms or procedures, and for displaying and updating advertisements appearing at specific points in a software operation.

### CROSS-REFERENCE TO RELATED APPLICATIONS

This application is a continuation of copending U.S. application Ser. No. 09/732,581, filed Dec. 8, 2000, which is incorporated herein by reference. This application claims the benefit of U.S. Provisional Patent Application No. 60/169,894, entitled “Total Integration of a Universally Publicly Accessible Global Network (RAN)”, filed Dec. 9, 1999. This application also claims the benefit of U.S. Provisional Patent Application No. 60/177,499, entitled “Total Integration of a Universally Publicly Accessible Global Network (RAN™)”, filed Jan. 21, 2000. The contents of both provisional applications are incorporated herein by reference.

### BACKGROUND OF THE INVENTION

1. Field of the Invention

The present invention relates generally to global networks which are generally accessible to the public, and particularly to a system and method for the integration of the provision of user services, operation of the network, and overall management and control of all aspects of the network.

2. Prior Art

There are local area networks with unified management and control across its horizontal levels of services to its users and/or data management throughout its vertical hierarchy, but by the very nature of such networks being ‘local,’ they are not ‘globally’ accessible to the public and they do not support the full spectrum of applications available and supportable by network technology throughout the world. There are wide area networks with unified management and control across the horizontal levels of its vertical hierarchy. But even when global in extension, such networks are not accessible to the public. They are networks for private use usually, if not exclusively, for the activities of private enterprises or governmental agencies. As such, their purposes are specialised, and by the very nature of their purpose are not accessible to all the people around the world. They are not ‘public’ networks.

Now let ‘horizontal extension’ at any given level in the vertical hierarchy mean ‘the number of users, both consumers and enterprises, which any one service provider at any such given level in the vertical hierarchy actually has as clients.’ Horizontal extension is ‘universal,’ when that actual, not potential, extension actually includes the totality of the universe of actual, not potential users. That is, the set of users as clients is identical with the total universe of users across such given horizontal plane in the vertical hierarchy.

There is currently one publicly accessible worldwide network, the Internet, supporting a wide range of applications available and supportable by network technology throughout the world. That worldwide network, however, is vacant of any form of unified management and control at any of its horizontal levels throughout any of its vertical hierarchy. At the level of its own base infrastructure, i.e. level 1, that world wide network is totally vacant of any management and control over any higher level in its vertical hierarchy in any form, unity or disunity. Further, at each other horizontal level across the totality of that world wide network's vertical hierarchy overall management and control, and data management, both are fragmented. The extension of overall management and control, and data management is markedly less than universal, i.e. spanning across the total set of users and the total set of user transactions and the total set of events during each user transaction.

Thus, there is no global publicly accessible network not characterised by either a total vacancy or fragmentation of overall management and control, and data management at each of its horizontal levels throughout the totality of its vertical hierarchy. This vacancy and fragmentation of overall management and control, and data management of logical and practical necessity leads to several deleterious effects for consumers and enterprises in the form of very large costs in the magnitude of millions, even billions, of dollars.

The Internet and all its uses is comprised of multiple layers in a vertical and horizontal structure. Level 0—the base public telecommunications infrastructure, comprised of hardware, software and telecommunications media and telecommunication service providers, facilitating all the higher levels in the Internet's own vertical hierarchy. Level 1—The base software and hardware infrastructure that constitutes the Internet, itself, referred to also as the Internet, the base platform through which all the higher levels of functionalities at each horizontal plane in that vertical hierarchy reside. Onto the Internet also is attached the World Wide Web, and for the purposes of comparison with the present invention, is posited at Level 1. Level 2—Higher in this vertical structure are base level Internet Service Providers, who operate on the base infrastructure constituted as the Internet, and provide users with an interface and access to sites on the Internet (as an alternative to users having to write their own program to interface and access sites on that Internet). Also on the Internet, individuals and enterprises can write or pay others to write programs to host their own sites, which Internet users can access. Level 3—A still higher level in the Internet's vertical hierarchy is comprised of ‘portal’ services, which attempt to organize a user's navigation to sites throughout the Internet. This structure allows for even higher levels in the vertical hierarchy to emerge to add further levels of attempts to organize a user's navigation among sites, and even among portals. There is no apparent logically necessary limit to the number of levels in the Internet's vertical hierarchy that can be constructed, given relevant fundamental technological parameters. Level N Data management and reporting services on consumer and enterprise user behaviour at one or more levels in the Internet vertical hierarchy.

Consideration of the evolution of the Internet and the World Wide Web reveals that the driving vision of both was connectivity. Thus, was yielded the connectivity of technology, as the base technical infrastructure of the Internet, and communications among people, as the software infrastructure of the World Wide Web.

This notion of connectivity, as such, however, remained formless, at least formless enough not to admit of a crystallization of a structure sufficient for the modern demands of the efficiency and quality of technology utilization and the efficacy and stability of market dynamics, which from this history were clearly beyond the outermost boundaries of the conceptions of connectivity, which inspired the establishment of world wide networking as a functionality. The initial and continued development of the Internet and World Wide Web have been very much thought and developed in terms of the ‘extension’ of connectivity and communication, respectively, across unilateral planes. There is nothing in the history of the Internet, which even suggests, a notion of a management model, a model not merely to technically enable, but beyond that to facilitate and integrate the dynamics of the multiple layers of operations and services, which eventually has become the totality of the relationships and structure of the modern information technology based global market.

With the structure of the Internet, as it was originally built and as it has actually evolved, the only horizontal level in the totality of the vertical hierarchy of the Internet, as such, which not only is vacant of, but actually logically and/or practically necessarily precludes universal horizontal extension, is Level 1—the very base level of the base infrastructure, itself, underpinning the totality of the Internet's own vertical hierarchy. Moreover, no other horizontal level of that vertical hierarchy, inherent to the concept of that level, had universal horizontal extension as a logically necessary attribute. Beyond logic, the fact of the actual reality is that none of the horizontal levels throughout any of the Internet's vertical hierarchy has universal extension.

Therefore, it is logically impossible that universal horizontal extension could ever have been a logically necessary component of the concept to be implemented at any of the horizontal levels in the Internet's vertical hierarchy from Level 1 or higher. It has observably been proven, that universal horizontal extension even at Level 1 in the Internet's vertical hierarchy is tantamount to a practical impossibility. It is likely that only a small number of users of the Internet would learn the program language(s) required to construct their own interface to the Internet. This is precisely what provided a market opportunity at Level 2 in the Internet's vertical hierarchy for base service providers. Moreover such universal horizontal extension is a practical impossibility at any Level 2 or higher in the Internet's vertical hierarchy, at this point in the Internet's evolution, because of firmly established law and business practices.

Not even one of the service providers at Level 2—the base service provider level or any higher level in the Internet's vertical hierarchy has universal horizontal extension, that is, has either service, or management and control, or data management extending to the total universe of users, consumers and enterprises, at that horizontal level in the Internet's vertical hierarchy. Moreover, there does not exist any central data system, including a central database, which captures, processes, analyzes and reports on the set of the total universe of any entity across the universal extension at even one horizontal level at any point in the vertical hierarchy of the Internet, let alone across the totality of the Internet's vertical hierarchy.

There is no point in constructing such a central database in the Internet with the capacity for total horizontal and vertical extension. The reason is, that attaining such universal horizontal extension at any level is a practical impossibility. The actual provision for such universal horizontal extension for overall management and control, and data management was never embedded in the actualized concept of the fundamental level of the base infrastructure of the Internet—Level 1, rendering attaining such universal horizontal extension at any level in the Internet's vertical hierarchy a practical impossibility due to firmly established legal restrictions on expansion through acquisition and due to market dynamics at each horizontal level in that vertical hierarchy. The Internet is a complex web of fragmented management and control, fragmented user service provision, fragmented data management systems and fragmented databases across each horizontal level throughout the totality of the vertical hierarchy of the Internet.

There are significant implications of this virtually necessary practical impossibility of universal horizontal extension at each and all of the horizontal levels in the vertical hierarchy of the Internet for the effectiveness of technology utilization, reflected in the pervasive and persistent state of inconsistent quality and efficiency of data transmission, and inadequacy of security regimes, and for the efficacy of the organization of markets as profit environments at each of the levels in the vertical hierarchy, and for the very rationale for equity capital investment, including public equity investment, in enterprises conducting business in the markets on each of those levels in the Internet's vertical hierarchy.

The concept of the level of the base infrastructure—Level 1, which constitutes the ‘Internet,’ excluded from its actual construction all consideration and facilitation of such universal horizontal extension of overall management and control, and/or data management at each and any of those horizontal levels throughout any of its vertical hierarchy, which in time actually would be constructed on top of that base infrastructure. Another way to state this circumstance is, that the level of the base infrastructure of the Internet, Level 1, excluded from its concept for implementation and actual construction any management model of any type, as a component of that base infrastructure designed to be implemented, in order to result in universal horizontal extension of management and control, and/or data management at any and all of the horizontal levels in its vertical hierarchy.

Accordingly, the real observable benefits of universal horizontal extension at any level in the Internet's vertical hierarchy for the effectiveness of technology utilization, reflected in the pervasive and persistent state of inconsistent quality and efficiency of data transmission, and inadequacy of security regimes, for the efficacy of the organization of markets as profit environments, and for the very rationale for equity capital investment, including public equity investment, in enterprises conducting business in the markets on each of those levels in that vertical hierarchy, among other highly important issues, are observably absent from the Internet, and moreover, are a practical impossibility.

### SUMMARY OF THE INVENTION

The present invention named RAN™, provides a solution to this deficiency in the Internet as a market environment, and as an environment for the effective and efficient application of information, including telecommunications technologies as a support resource to such a market environment. The system and method of the invention is a worldwide telecommunications plane, expandable to interplanetary and intergalactic communications as a fundamental functional attribute inherent in its genitive concept. With the current state-of-information technology science and art, the system and method of the invention is a significant advance in the organization of a universally publicly accessible global network, the next step beyond the Internet, as a ubiquitous interconnected world wide telecommunication platform.

The present invention is a system with a totally horizontally and vertically integrated communications management network architecture with global or any more or less extension expandable to global, publicly accessible to any and all of the people around the world, with a Level 1—as its own base infrastructure, supporting all other levels in the system's vertical hierarchy, which does inherent to its very concept and its construction contain, as an integral component, a management model, i.e. a system and method, designed precisely to maintain and sustain the most flexible environment for achieving enhanced effectiveness of technology utilization, reflected in the more pervasive and persistent state of the consistency in quality and efficiency of data transmission, and efficacy of security regimes, for the effective organization of markets as profit environments at any two or more, at each and all of the levels in the system's vertical hierarchy, and for the maximization and stability of the very rationale for equity capital investment, including public equity investment, in enterprises conducting business in the markets on each and all of the levels in the RAN vertical hierarchy, among other highly important issues. Beyond a more elegant structural solution to the integration of world-wide information and telecommunication technologies among themselves and the integration of all of these technologies with business management theoretics, manifest as a specific business systems and method, the system and method of the invention also has real substantive benefits of significant financial magnitude to consumers and enterprises using world-wide communications technology.

Among these benefits, two of the chief benefits are a significant reduction in the total cost to a significant number of users, both consumers and enterprises, in terms of the resources they currently expend on quality, efficiency and security maintenance and upgrades, in order to compensate for the fact, that the base infrastructure of the Internet does not contain the universal applicability and accessibility of the most effective protocols for quality, efficiency and security. As a result, users must expend their own resources to exercise their responsibility for a very high proportion of the burden for quality, efficiency and security maintenance and upgrades. On RAN, the unified integrated management model enables the pervasive and consistent application and accessibility of higher, even the highest, standards and protocols for quality, efficiency and security, across of universal extension of each and all of the horizontal levels throughout the totality of its vertical hierarchy. Thus, the cost of pervasive and consistent quality, efficiency and security is absorbed by RAN's own base infrastructure and dispersed among the user population by a much more equitable formula.

As a system and method, the present invention is an innovative integration of market design and management theoretics with the totality of the current and future state of information and telecommunication technologies with substantial beneficial effects for the cost of services for users, both consumers and enterprises, and the manageability of market dynamics and profitability for enterprises.

In one aspect of the present invention, a ‘single point of entry’ is provided through which users in the total universe of actual and potential users around the world utilize ‘one’ interface point and ‘one’ account to access the full spectrum of applications on the system across the total horizontal extension of each and all horizontal levels throughout the totality of the vertical hierarchy of the world-wide network.

This system and method for a single point of entry and single account for the totality of the universe of users around the world for all applications across all the horizontal levels throughout RAN's total vertical hierarchy is enabled through another aspect of the invention, that is, the total integrated system and protocols, inherent in the concept, design, implementation and ongoing operation of the invention, for the overall management and control, and data management across the universal horizontal extension of any one or more or all (or any logical or actual combination of two or more) of the horizontal levels in the vertical hierarchy of a global publicly accessible network.

Another aspect of the invention is the integrated unified comprehensive central data system and set of databases utilizing relational, or any other effective current or future data base technology, embedded within Level 1, RAN's own base infrastructure, to which the totality of recordable events for the totality of user transactions for the totality of applications for the totality of user computer input/output devices for the totality of locations of those user computer devices for the totality of users across the universal horizontal extension of any one or more, or all of the horizontal levels in the vertical hierarchy of the present invention are transmitted from each and all of those horizontal levels to that integrated unified comprehensive central data system and database(s).

Another aspect of the present invention is the integrated unified comprehensive software which combines into one software platform the functionalities of providing the user interface to a network, including a publicly accessible global network such as RAN, the Internet etc. and/or the interfaces between/among user application softwares and/or the central data base(s).

This synthesis can entail the mutual integration of the level of the root public telecommunications system. Level 0 and/or the level of the base infrastructure—Level 1 and/or the level of base service provider—Level 2 and/or any two or more, or all of the higher levels in the vertical hierarchy and/or Level N—data services.

The preferred methods, through which the present invention operationalizes this integration, are as follows:

Method 1. The invention's total integration of the horizontal levels throughout the vertical hierarchy is enabled by incorporation into a single integrated unified comprehensive management—network system the overall management and control, and data management for any, any combination of, and all aspects of the provision of and operation of any combination, and all of the full spectrum of services, of products, and of information to each, any number, and all of the users of the system.

Method 2. The invention's integration of the horizontal levels throughout the vertical hierarchy can be enabled by incorporation into a single integrated unified comprehensive software platform of the functionalities required to operate any, any combination of, and all of the hardware, software and telecommunications media required to provide or support the provision of any combination, and all of the full spectrum of services, of products, and of information to each, any number, and all of the operator(s) of the software and user(s) of the system(s) utilizing the software.

Another embodiment of the invention comprises a global network, which also supports communications for the full spectrum not only of consumer activities, but also of intra and inter enterprise service delivery, operations, and management et al activities. As such, the invention incorporates innovative functionalities for a variety of technologies from smart cards to analytical software to advertising through software applications to integrating mobile visual technology in vehicles with network functionalities.

If at the time the Internet was being planned, the model of a totally integrated management—network architecture system had been thought, and the software and hardware technologies had been available, and the deleterious economic effects resulting directly from the fragmented management network architecture at all the horizontal levels throughout the Internet's vertical hierarchy, logically and practically deduced directly from the structureless management network system at the level of the base infrastructure of the Internet, had been foreseen, then they would have built the system of the present invention instead of the Internet. None of the conceivers and implementers of a worldwide network publicly accessible platform would rationally have wanted to saddle the whole world with a worldwide network with such major deleterious effects of such high magnitude for decades, perhaps even a century or more.

However, the deleterious effects of a structureless base infrastructure of a worldwide publicly accessible network were not foreseen. By the time the hardware and software technologies emerged to enable an architecture system that would remove these deleterious effects, which by then were becoming increasingly apparent, it was already too late. The non-existence, for all practical purposes, of any meaningful architecture integrating the Internet's base infrastructure with any of the higher levels in the Internet's vertical hierarchy rendered it a practical impossibility to construct an effectively integrated management network system to overcome the deleterious effects rampant throughout the Internet, which by now have become commonplace.

Another aspect of the invention is the system for downloading advertisements, when a user initially downloads or updates, i.e. refreshes, software applications, via any network, or via CD-ROM, diskette, et al. The system displays advertisements, when a user's computer is performing specific functionalities, related to those functionalities. The system also enables a user to select advertisements to be displayed at any other time(s), that the computer is in operation. The system also enables the cursor (utilized to point to locations on a display, e.g. a screen) to be utilized, itself, to display any type of advertisements. Any advertisement being displayed can also be utilized by a user to interconnect directly with the site (on a network), which sponsors that advertisement or is associated with that advertisement in any way. The system can update advertisements automatically. The system can render applications with this advertising functionality inoperable, unless the user updates the advertisement(s) or allows the advertisement(s) to be updated.

Another aspect of the invention is the system for displaying via a computer device, located within a motor vehicle, a visual representation of the objects around that vehicle and their spatial relationship to that motor vehicle and each other, whether that motor vehicle or any of those objects are stationary or in motion. The system utilizes interconnected devices for the capture and transmission of images, and conversion of information into statistics and text. The system can be interconnected to any network.

### BRIEF DESCRIPTION OF THE DRAWINGS

The foregoing summary, as well as the following detailed description of the preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a high level block diagram of an embodiment of the system of the present invention.

FIG. 2 is a high level block diagram of an embodiment of the system of the present invention illustrating the logic of the screen paths interconnecting user(s) with the application(s).

FIGS. 3-6 are a set of diagrams of a preferred embodiment of the present invention illustrating screen displays.

FIGS. 7-8 are element listings for a preferred embodiment of the present invention illustrating data base elements of the Central Unified Comprehensive Transaction Database.

FIG. 9 is an element listing for a preferred embodiment of the present invention illustrating data base elements of the Central Unified Comprehensive Device Database.

FIGS. 10A-10C, taken together, is an element listing for a preferred embodiment of the present invention illustrating data base elements of the Central Unified Comprehensive Consumer Database.

FIG. 11 is an element listing for a preferred embodiment of the present invention illustrating data base elements of the Central Unified Comprehensive Z-Card Database.

FIGS. 12A-12C, taken together, is an element listing for a preferred embodiment of the present invention illustrating data base elements of the RAN Central Unified Comprehensive Enterprise Database.

FIG. 13 is an element listing for a preferred embodiment of the present invention illustrating data base elements of the Central Unified Comprehensive Hypergate Database.

FIG. 14 is an element listing for a preferred embodiment of the present invention illustrating data base elements of the Central Unified Comprehensive Emergency Services™ Database.

FIGS. 15 and 16A-16C, taken together, are element listings for a preferred embodiment of the present invention illustrating data base elements of the Central Unified Comprehensive Shipping Database.

FIG. 17 is an element listing for a preferred embodiment of the present invention illustrating data base elements of the Central Unified Comprehensive Brain™ Database.

FIG. 18 is a high level block diagram of a preferred embodiment of the present invention illustrating the Universal Software™ Platform and the interaction among the single unified point of entry to the Universal Software and specific of the key functional modules of the Universal Software.

FIGS. 19A-19C, taken together, is a high level diagram of a preferred embodiment of the present invention illustrating the Universal Software™ Platform, and the unification and integration of the single unified integrated point of entry to the functionalities in the Universal Software™ Platform.

FIG. 20 is a high level diagram of the current state of software technology, and illustrates the fragmented nature of the relationships between and among the various existing software technology platforms.

FIG. 21 is a high level diagram of a preferred embodiment of the present invention illustrating the Advertising Via Software™ System and the interaction among components.

FIGS. 22-29 are a set of diagrams of a preferred embodiment of the present invention illustrating screen displays within the Advertising Via Software™ System or AVS™ System.

FIGS. 30-32 are a set of high level block diagrams of a preferred embodiment of the present invention illustrating from various visual perspectives the True View system and the interaction among components.

FIGS. 33-38 are a set of diagrams of a preferred design of a Graphical User Button Interface™ or GUBI™.

FIG. 39 is a diagram of a preferred design of an Intelligent Boom Box™ of an embodiment of the invention.

FIG. 40 is a diagram of a preferred design of an Intelligent Brief Case™ of an embodiment of the invention.

FIG. 41 is a diagram of a preferred design of the Merchandising Advertising Retailing Center™—MARC™.

FIG. 42 is a high level block diagram of another embodiment of the present invention.

FIG. 43 is another embodiment of the Intelligent Boom Box of an embodiment of the invention.

FIG. 44 is another embodiment of the Intelligent Briefcase of an embodiment of the invention.

FIG. 45 is a diagram of a preferred functionalities of the Intelligent Communicator™.

FIG. 46 is a high level block diagram of another embodiment of the present invention.

FIG. 47 is a high level block diagram of another embodiment of the present invention.

FIGS. 48A-48B, 49A-49B and 50A-50B are charts listing distinctions between the Internet and the system of the present invention.

### DESCRIPTION OF THE PREFERRED EMBODIMENTS

The present invention is a system and method for the integrated unified comprehensive operation, provision of user services, and management and control, for a publicly accessible global network with one or multiple levels of provision of service to users, operation of the network, and management and control of any, any combination of, and all of the aspects of the system. This system is an alternative to the Internet. There are consumers and enterprises. Enterprises are commercial for profit, non-profit, or governmental agencies which provide products and/or information and/or services for a price/fee or for free to customers, i.e. people, respectively, willing to pay, or retrieve or accept, those products and/or information and/or services. Consumers are people, who pay for or obtain for free those products and/or information and/or services, and/or engage in communications with other users for a variety of reasons and purposes. Consumers can be customers of enterprises via the global network. Consumers can be customers of other consumers via the global network. Enterprises can be customers of other enterprises via the global network. By the first dimension, the global network has one or more horizontal levels of the provision of user services, network operation, and overall management and control in a vertical hierarchy. Level 0 is the base public telecommunications infrastructure and services provided by a large telecommunications carrier, such as, AT&T, MCI˜WorldCom, Sprint, Qwest et al. In the global network, itself, Level 1 is the base global network infrastructure, constitutive elements of which are its software and hardware platforms, its integrated unified comprehensive central set of relational databases, and its integrated unified comprehensive management and control systems and protocols, all of which elements support the universal horizontal extension of any one, two or more, or all of the horizontal levels in the vertical hierarchy of the global network. By the second dimension, the global network also has one or more horizontal levels of data management, including data capture, processing, analysis, reporting, etc. Level 0 is the base public telecommunications infrastructure and services provided by a large telecommunications carrier, such as, AT&T, MCI˜WorldCom, Sprint, Qwest et al. Level 1 is the base global network infrastructure, constitutive elements of which are its software, hardware and media platforms, its integrated unified comprehensive central set of relational databases, and its integrated unified comprehensive management and control systems and protocols, which elements are enabled by a software which provides integrated unified comprehensive data management for each and all recordable events during each and all user transactions by each and all users across the universal horizontal extension of any one, two or more, or all of the horizontal levels in the vertical hierarchy of the global network. Level 2 is the provision of base services to users to interface and access enterprise and non-enterprise sites on the global network, at which level data is captured for each and all recordable events during each and all user transactions by each and all users across the universal horizontal extension of this horizontal level in the global network's vertical hierarchy and transmitted to the integrated unified comprehensive central data system and database(s) at level 1. Level 3 is the provision of additional services to users through the integrated unified comprehensive system of Hypergateways™ to assist users in their navigation through the global network, at which level data is captured for each and all recordable events during each and all user transactions by each and all users at each and all computer devices across the universal horizontal extension of this horizontal level in the global network's vertical hierarchy and transmitted to the integrated unified comprehensive central data system and database(s) at level 1. There may be additional horizontal levels for the provision of special services or additional assistance to users in navigating through the global network, at each of which levels data is captured for each and all recordable events during each and all user transactions by each and all users across the universal horizontal extension of each of these horizontal levels in the global network's vertical hierarchy and transmitted to the integrated unified comprehensive central data system and database(s) at level 1. Level N is the provision of data management services to existing and prospective enterprises and consumers, and internally within the integrated unified comprehensive management and control entity of the global network, for which level the integrated unified comprehensive central data system and data base(s) at level 1 generates all analyses and reports. The total hierarchical integration of the system of the present invention is further facilitated by the Universal Software™, which integrates the functionalities of various software platforms into one unified integrated software. The global network provides for the incorporation of several specific components. One such component is a Graphical User Button Interfaces™—GUBI™ for connecting any user directly to applications, and enterprise sites and consumer sites on the global network. Another component is the Emergency Services™ System for connecting any user via the global network directly to other networks, data bases and computer devices, of emergency services personnel/agencies, law enforcement personnel agencies, and any other organizations and entities relevant to the purpose of this system, connected to the global network. Another component is the Z-Card™, a smart card, inserted into an electronic reader for displaying information stored on such card, including comparative information, such as interest rates, payments, etc. of each of several alternative credit card accounts, or debit accounts, or any other kinds of accounts, or any other kinds of functionalities, amenable to any user evaluating comparative information. Another component is The Brain™, a system and method for performing simultaneously any number of, or combination of, or all of the alternative mathematical formulae, algorithms or procedures, and programmable, given the current and any future state of knowledge and capability anywhere in the world concerning mathematics and/or programming mathematical formulae, algorithms or procedures. Another component is Advertising Via Software™—AVS™, a method for displaying and updating advertisements appearing at specific points in a software operation, when such software is performing specific functions. Another component is True View™, a system and apparatus for providing an operator inside a vehicle, while such vehicle is in motion or such vehicle is in still position, with a view via a monitor of any other moving or still vehicles, or other moving or still persons, or other moving or still objects, with the purpose of aiding such operator in avoiding colliding with such other vehicles, persons, or objects.

The RAN System

RAN is a publicly accessible global system, including network, in which consumers can communicate with one another and with enterprises, private-for-profit, non-profit and public et al., in order to access, retrieve, exchange and obtain information, services and products through purchase, barter or for free. Users preferably utilize one point of entry to the full spectrum of RAN services and applications, such that basic service for consumers is provided by one basic service provider, for free or at nominal cost to all consumers. RAN is a global universally publicly accessible horizontally and vertically integrated management—network architecture system for the overall management of, operation of, and provision of services and data related to users conducting transactions on the system comprising: any number of consumer computer devices; and any number of enterprise computer devices; a global network interconnecting those consumer computer devices and those enterprise computer devices. Consumers (either directly or indirectly via the Internet or any other network(s)) via all computer devices technologies, whether stationary or mobile, preferably utilize the same user interface to the RAN network, which comprises a single point of entry to the RAN network. This universal single point of entry for consumers and enterprises, and for all computer device technologies, is preferably connected to a central database. The central database captures, records, stores and processes a wide variety of data variables for each event in each transaction for each consumer and each enterprise on each device across the total universe of the user, enterprise and device populations utilizing the RAN System. A number of services and applications on the RAN System are preferably facilitated through interconnections with networks of external entities, such as, but not limited to emergency services, financial services, etc. The universal single point of entry and the unified integrated comprehensive central data base of the RAN System enable it to produce reports and analyses for RAN system's current and prospective users and investors, not merely for a fragmented subset of the population, but rather for the totality of the universe of users, enterprises and devices.

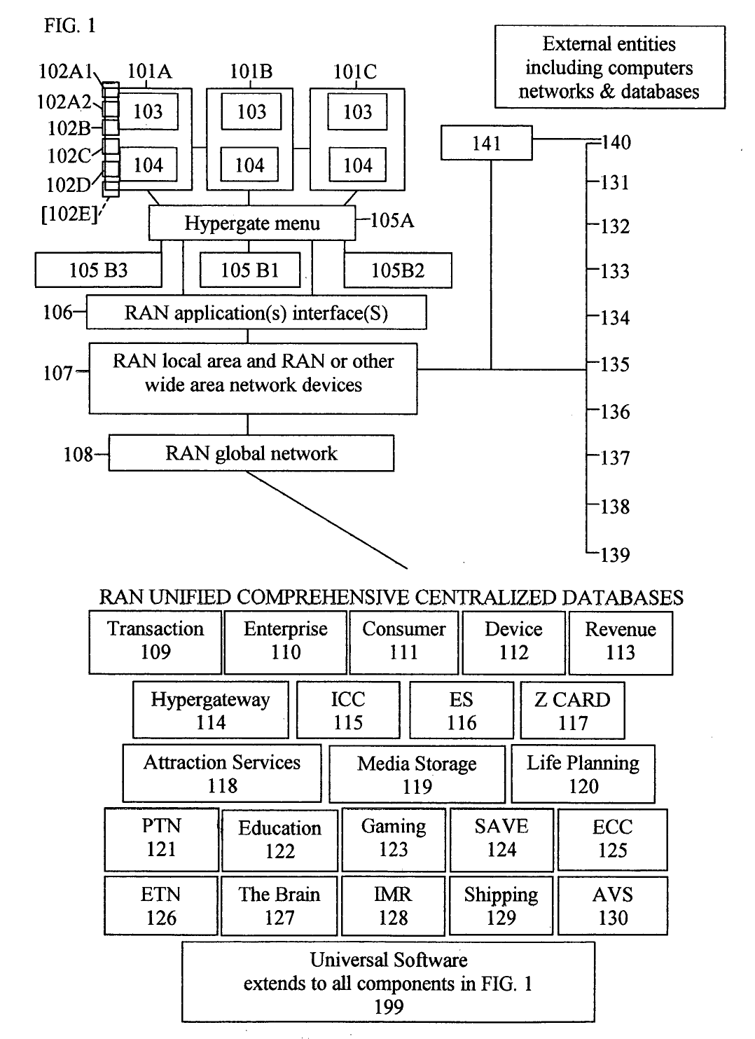

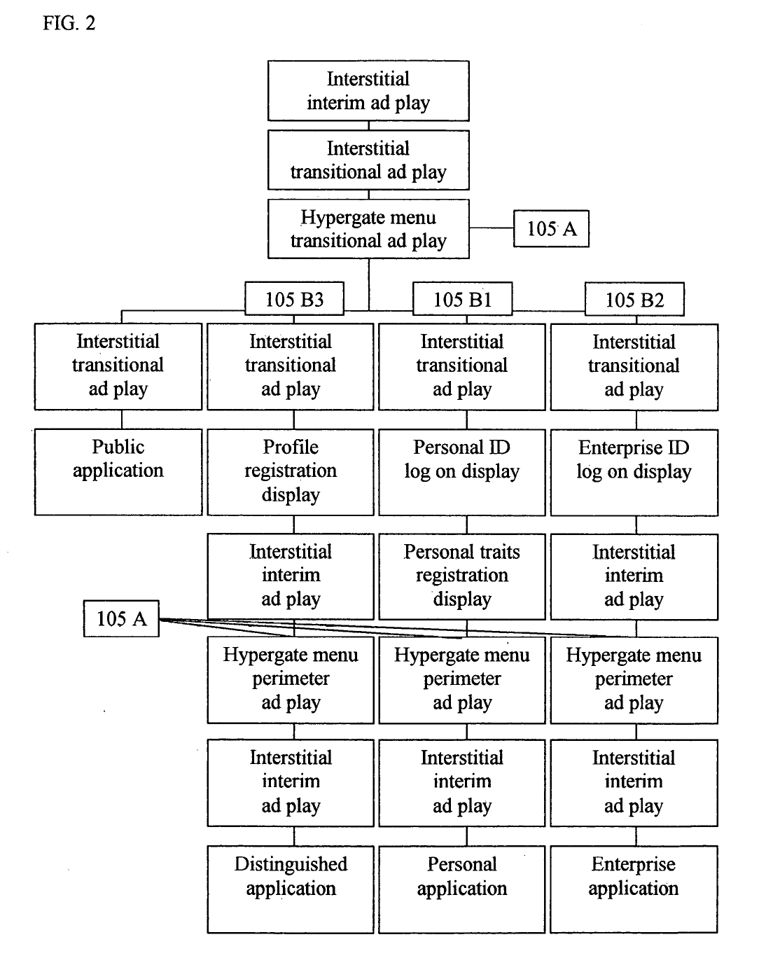

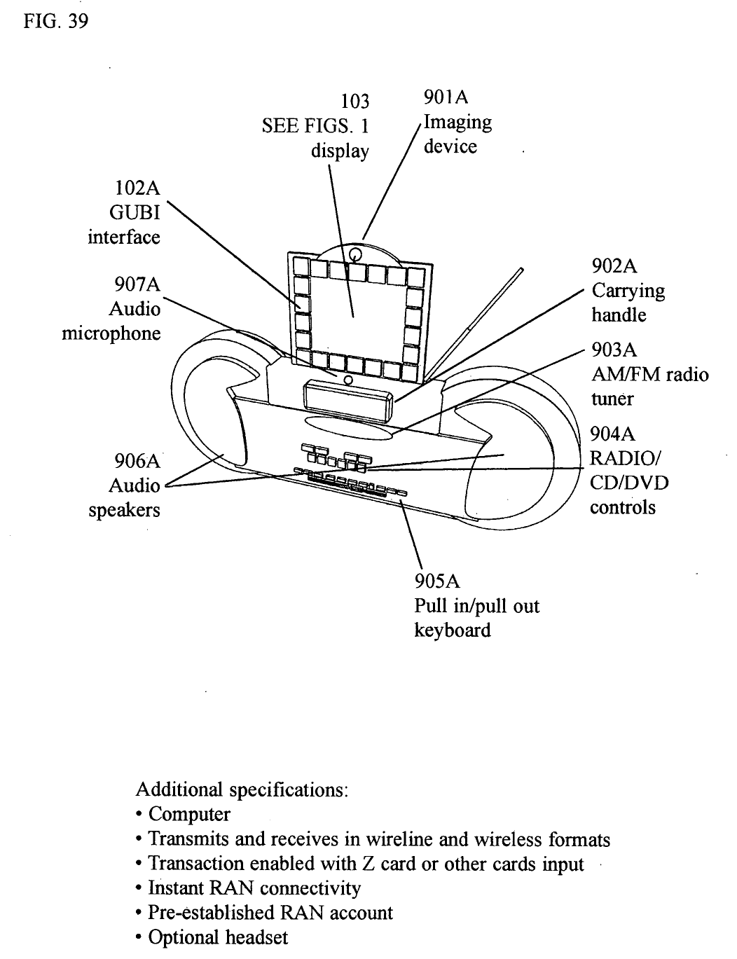

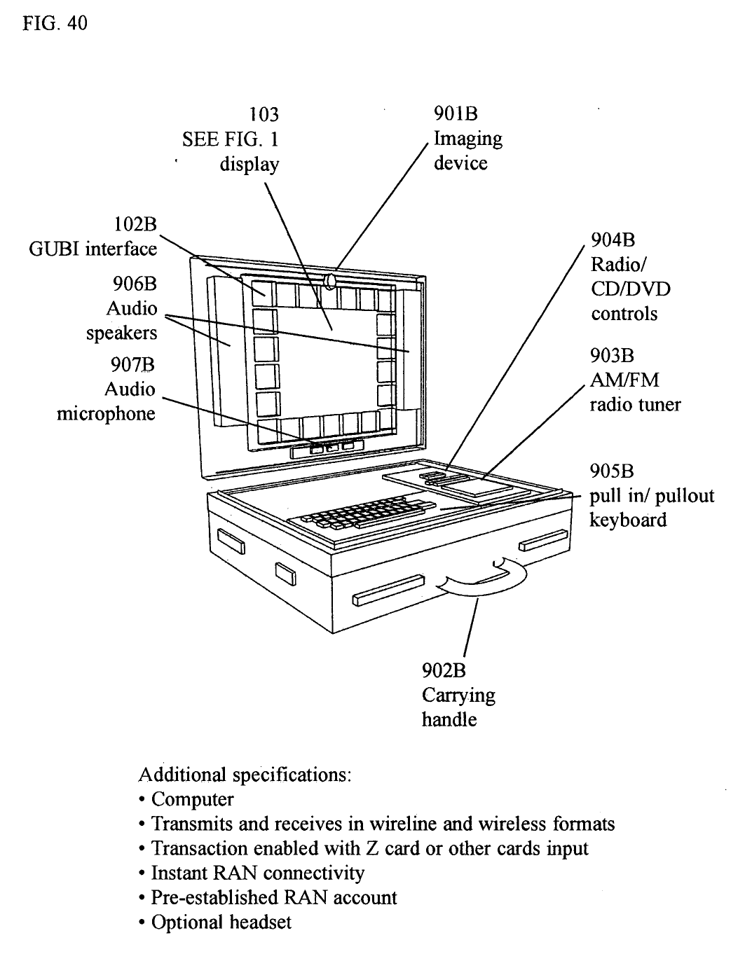

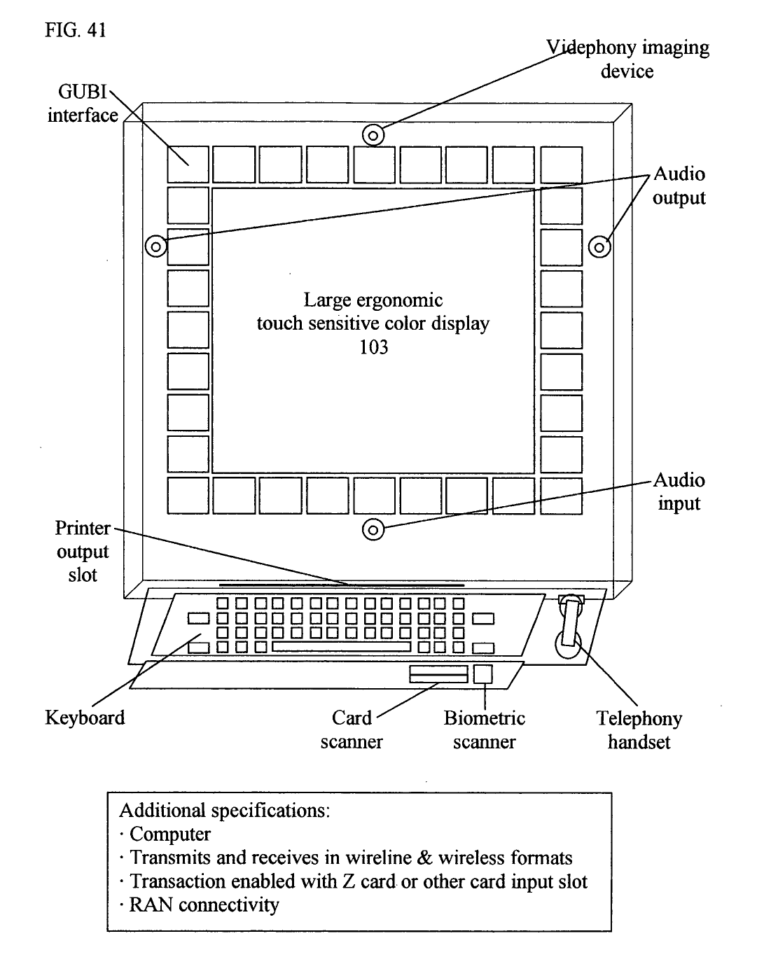

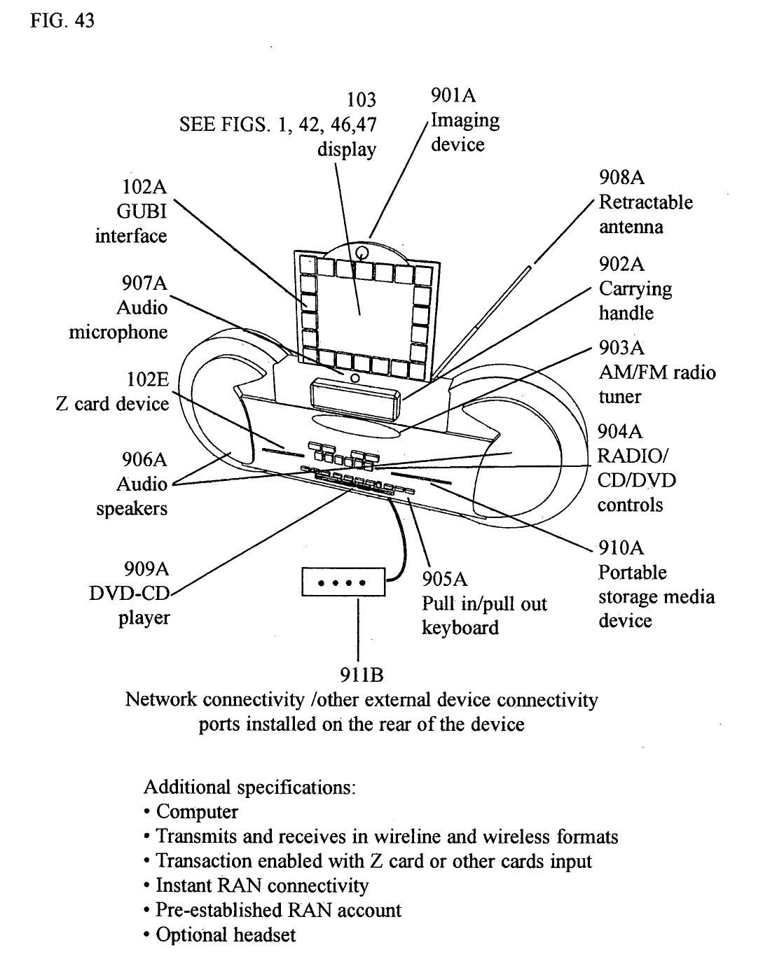

The RAN System preferably integrates the components in FIG. 1. With the RAN System, a large number of users with various purposes, such as consumers, business professionals, owners of enterprises, governmental officials, parents, students, educators, scientists, artists et al utilize computer devices 104, (example shown in FIG. 43), such as stationary MARC terminals 101A (hereafter, ‘terminals’ or ‘terminal’), personal computers 101C and various mobile devices 101C, referring to FIG. 39, such as Intelligent Boom Box, IB² 101B, and referring to FIG. 40, Intelligent Brief Case 101B, to access the RAN global network 108. Users can utilize Terminals 101A, personal computers and various mobile devices, such as Intelligent Boom Box and Intelligent Brief Case (all of which will be referred to as computer devices) to access the RAN global network 108 directly, that is, without utilizing any other network to access the RAN global network 108. Users can also access the RAN global network 108 via a RAN Interface on the Internet, which is interconnected with the RAN global network 108.

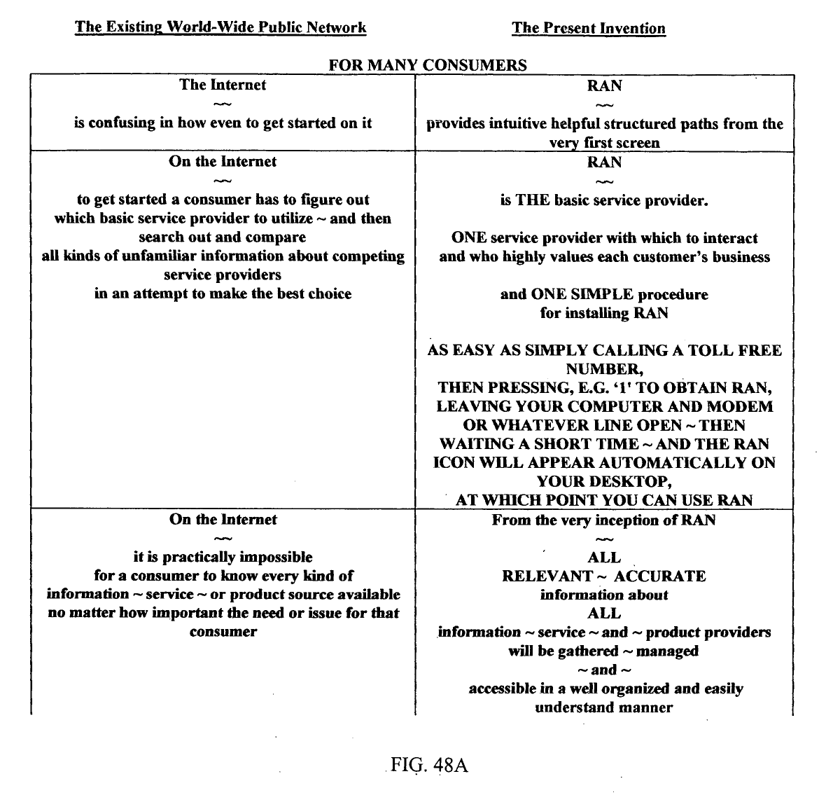

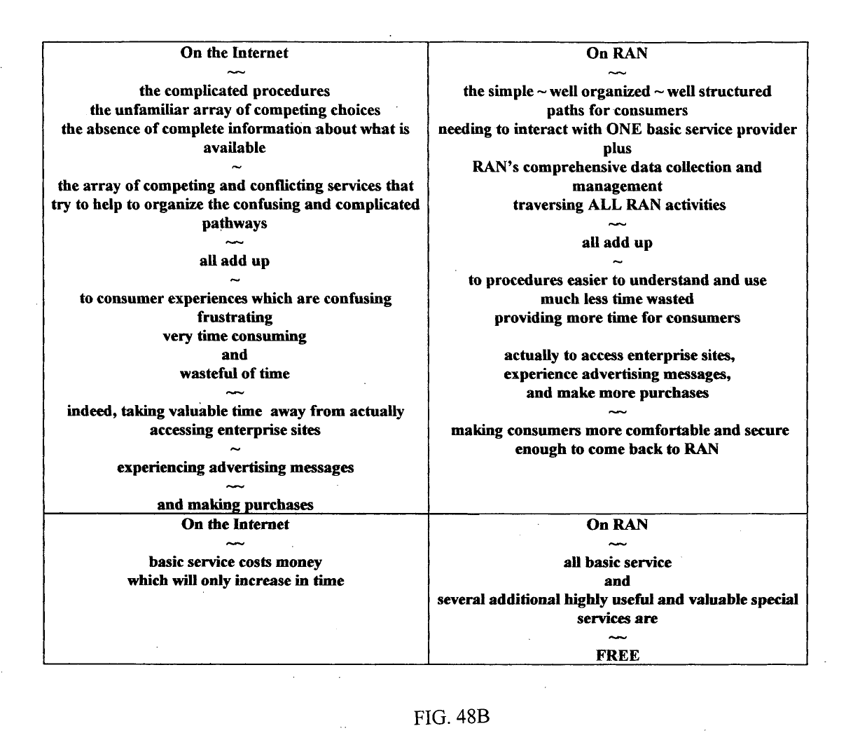

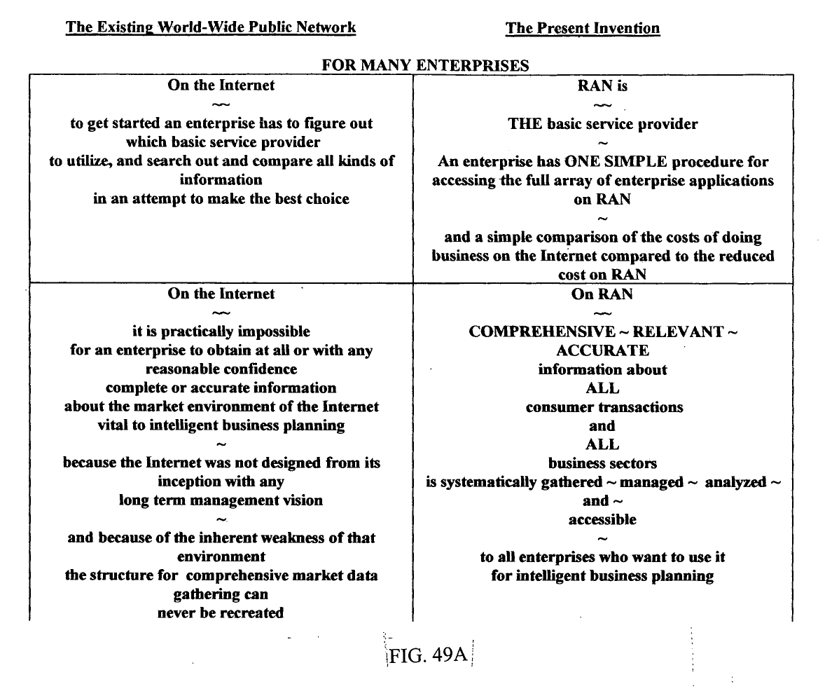

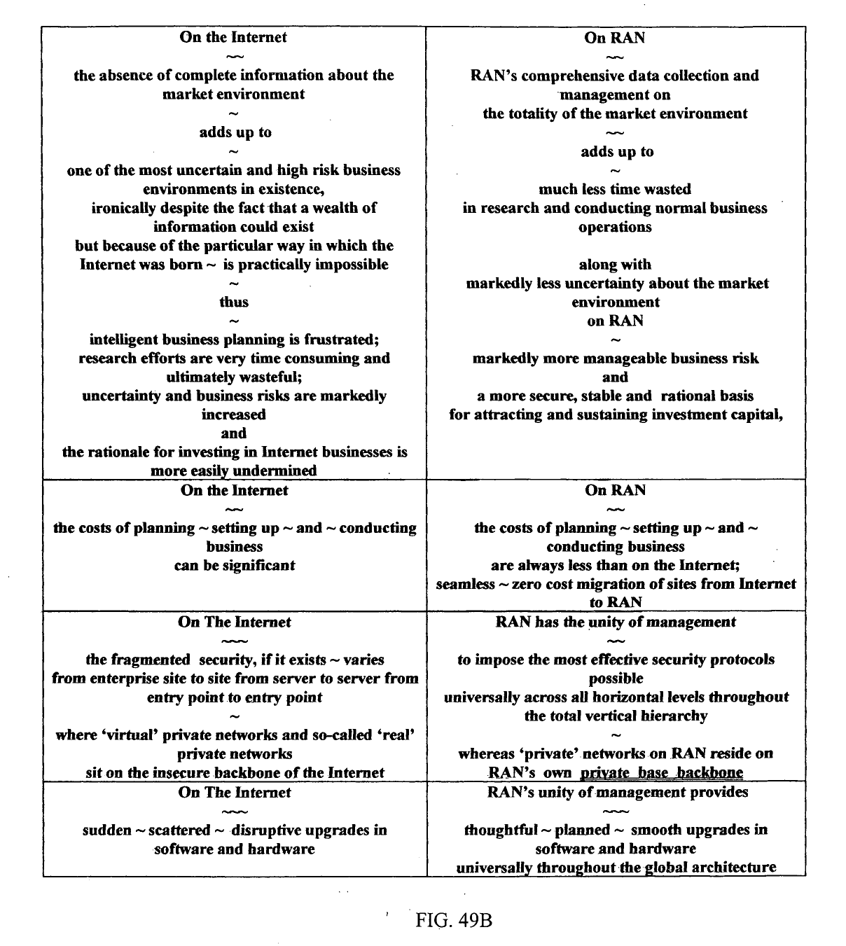

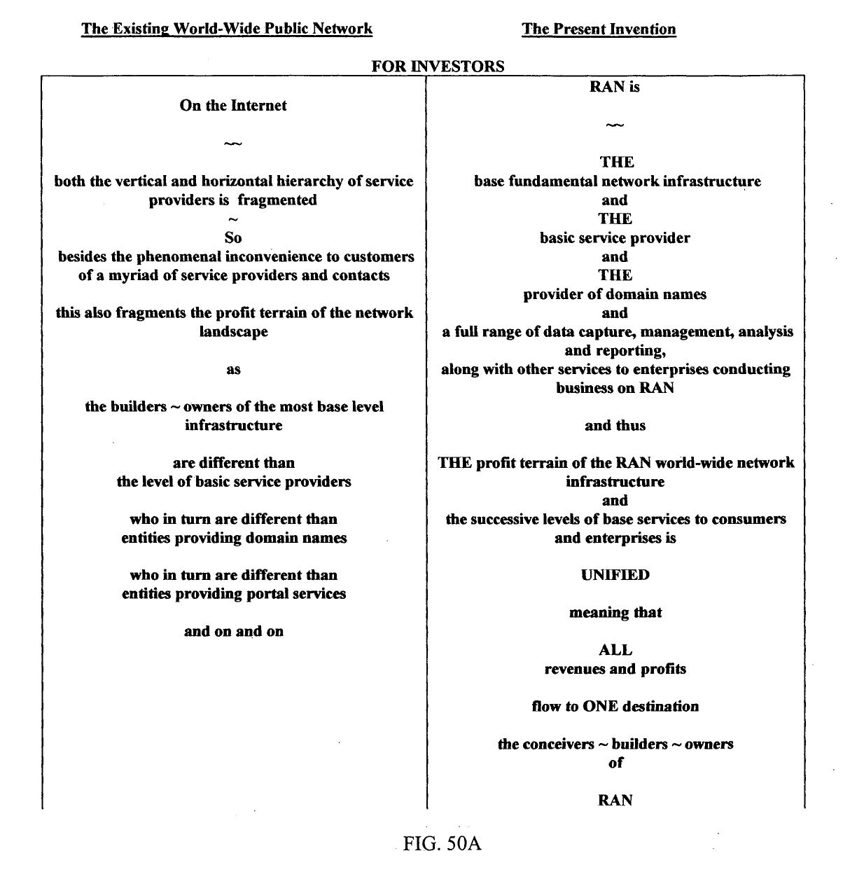

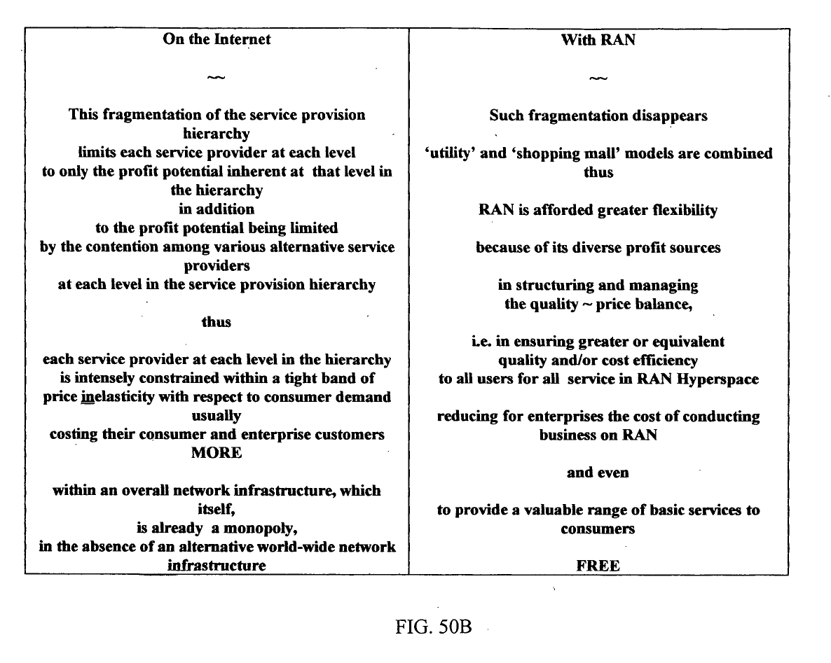

Comparative distinctions between the Internet and the system of the present invention are shown in FIGS. 48A through 50B.

This comparative analysis of the fragmented state of the operation and management of the Internet compared to the unified integrated comprehensive structure of the system and method of the present invention, logically implies the recognition of the current fragmented state of software platforms for design, operation and management of user applications, network communications, interfaces and data bases et al, characterized as they are by widely varying logics, protocols, conventions and styles et al. Even given the tendency towards the interoperability of software platforms, this state of affairs remains the interconnectivity of nonetheless different software entities.

Unavoidably, many different softwares, serve various functions throughout the hierarchy of a global network structure. In any case, the costs of this fragmentation, and the settling merely for ‘interoperability’ instead of true ‘integration’ is, that a great deal of time and cost must be incurred for any one programmer/analyst/systems manager to learn and master softwares across a number of disparate functions. This fragmented state poses a barrier to learning across software functions, which a great number of programmer/analysts/systems managers never overcome.

The system and method of the invention fuse the accidental traits of software platforms into a single unified set of logics, protocols, conventions, style, look, et al., retaining full interoperability, thus reducing learning across multiple software platform functions to concentration on the information and skills essential and uniquely associated with each platform function. Once, one platform, or module, is learned, all the logics, protocols, conventions, style et al of all the other modules has already been learned. The quality and efficiency of learning can be improved by honing the focus of the learning experience only on the essentially unique content of each of a multiplicity of software platform functionalities.

The unified integrated comprehensive structure of the system and method of the invention enables the greatly enhanced hierarchical integration of any network.

What follows is a more detailed illustration of key components of the RAN System and the interrelationships between and among the components.

Single Point of Entry

The single point of entry system of the global network, provides users access to the applications and to the enterprise sites and to the consumer sites on the global network. Via the single point of entry each user utilizes one account identifier providing each said user with access to the set of the total universe of applications, and the set of the total universe of enterprise sites and the set of the total universe of consumer sites, and each of the applications accessible at each of the enterprise sites across the universal extension of each of the horizontal levels in the totality of the vertical hierarchy of the global network containing such applications. Each user at any given time will preferably have access to the global network utilizing one account identifier, which will provide said user with access to any of the applications, including at any of the enterprise sites, to which that user's account identifier provides access. The single point of entry to the global network, in the form of a single Hypergate, provides users access to all of the applications and to all of the enterprise sites and to all of the consumer sites across the universal extension of each of the horizontal levels in the totality of the vertical hierarchy of the global network containing such applications. A single integrated system of Graphical User Button Interfaces (GUBI) can be used to provide users access to ‘Featured Applications™’ and ‘Attraction Services™’.

Universal Management System for RAN Global System and Network

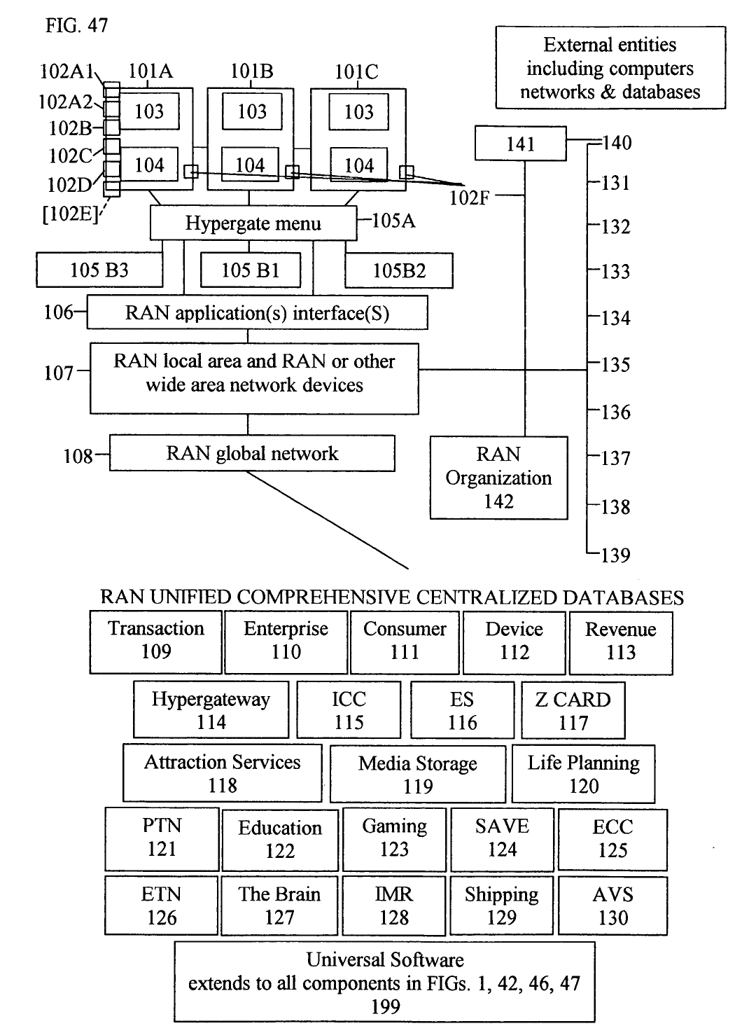

Referring to FIG. 47, the RAN Organization 142, interconnected with RAN network devices 107, preferably provides executive, middle management, supervisory and professional oversight of RAN network operations, (including via contractors, which provide various services). RAN staff provide services to consumer and enterprise users, all by executing decisions via said RAN network devices 107, interconnected with the RAN Global Network 108, interconnected with various RAN network devices 107, and databases, 109-129, to said various RAN network devices 107, and said databases 109-129, throughout the total extension of each horizontal level throughout the totality of the vertical hierarchy of the RAN Global Network; and via the RAN Global Network 108, interconnected with RAN network devices 107, interconnected with MARC terminals 104, Intelligent Mobile Devices 104, and other computing devices 104, and external networks and computer devices 131-140, directly to consumer and enterprise users.

Peer to Peer

As appropriate any, some, or all data transmissions are capable of being transmitted either, Client-Server, or Peer to Peer.

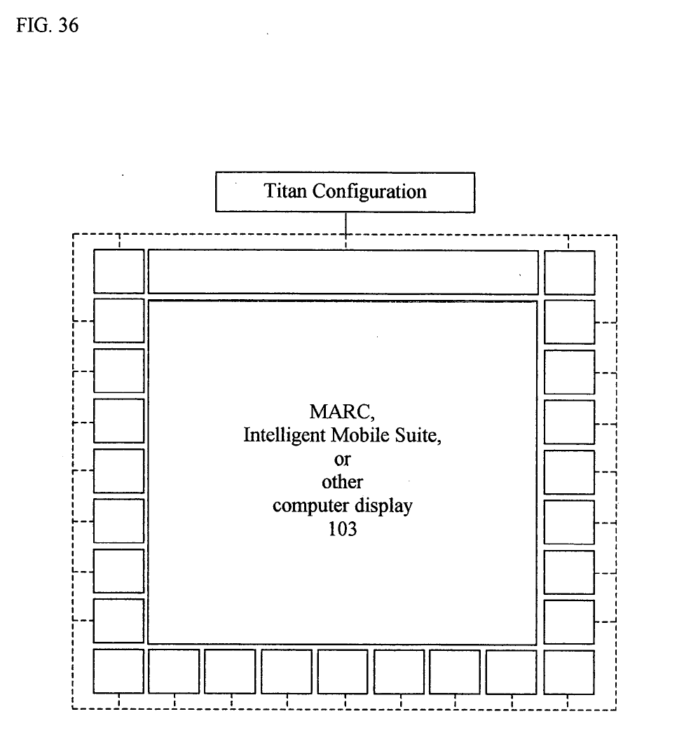

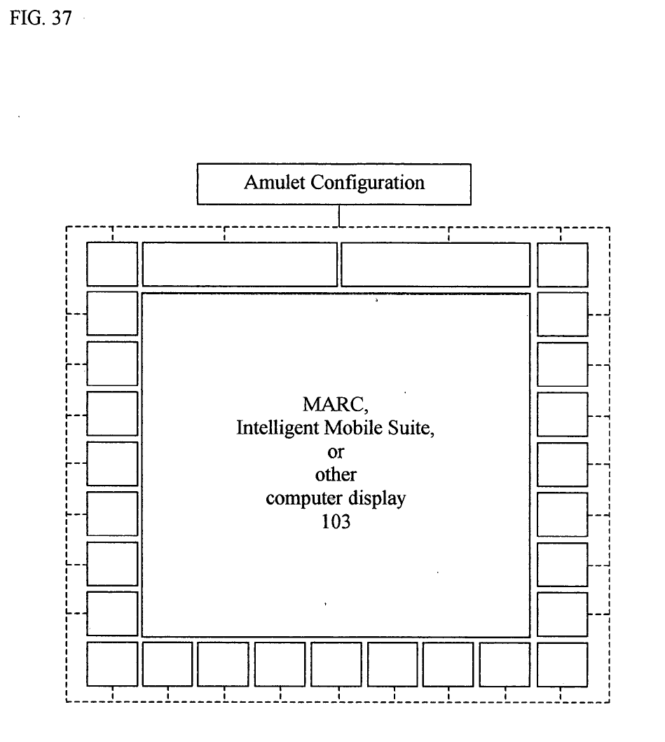

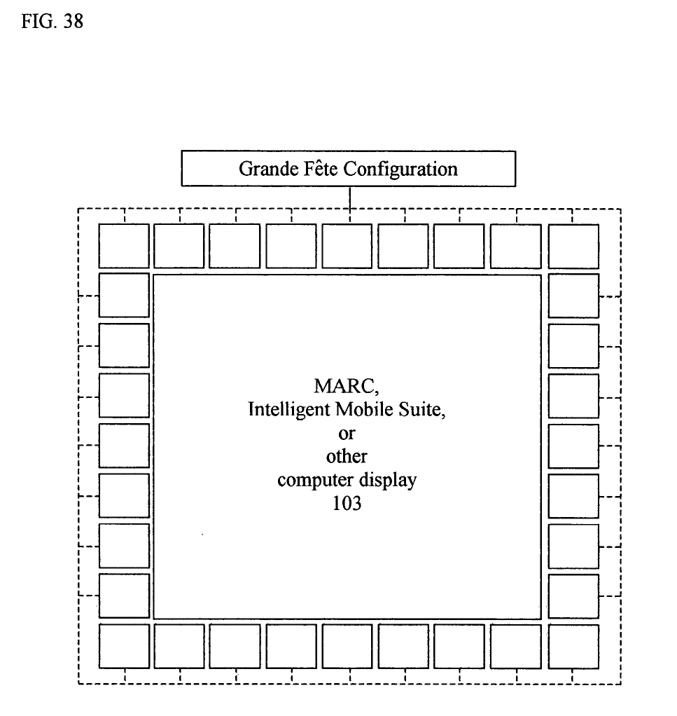

Graphical User Button Interface(s) (GUBI) is hardware based iconographic buttons positioned on the exterior of a stationary terminal or portable device to be activated around the outer edges of the screen or in the case of future interactive television via remote control, thus not taking up or interfering with any of the screen real estate, leaving the full screen available for information from businesses connecting with consumers and advertising messages to reach consumers, and for users to reach one another for various reasons and purposes. Indeed, in addition to providing access to these attraction services to the public, these buttons provide enterprises even more physical space, through which to reach out and connect with consumers. The buttons will preferably provide consumers with direct and immediate access to various Attraction Services, such as emergency services from law enforcement, medical professionals, etc.; videphony, i.e. network videoconferencing et al; telephony, i.e. network telephone services; Z-Card. i.e., electronic commerce & banking services via smart card technology et al; transportation terminal information on air & train & bus & cruise lines et al; accurate time where you are now & anywhere else in the world; accurate place locator, where you are now & how to get to anywhere else; etc. Referring to FIGS. 36-38, other buttons will be reserved as Featured Applications, via which enterprises can prominently display their messages, utilizing the area of several or all of the buttons around the perimeters of a display device, giving consumers direct and immediate pathways to enterprises. Enterprises are preferably able to position their own brand identity on the premium direct and immediate access points.

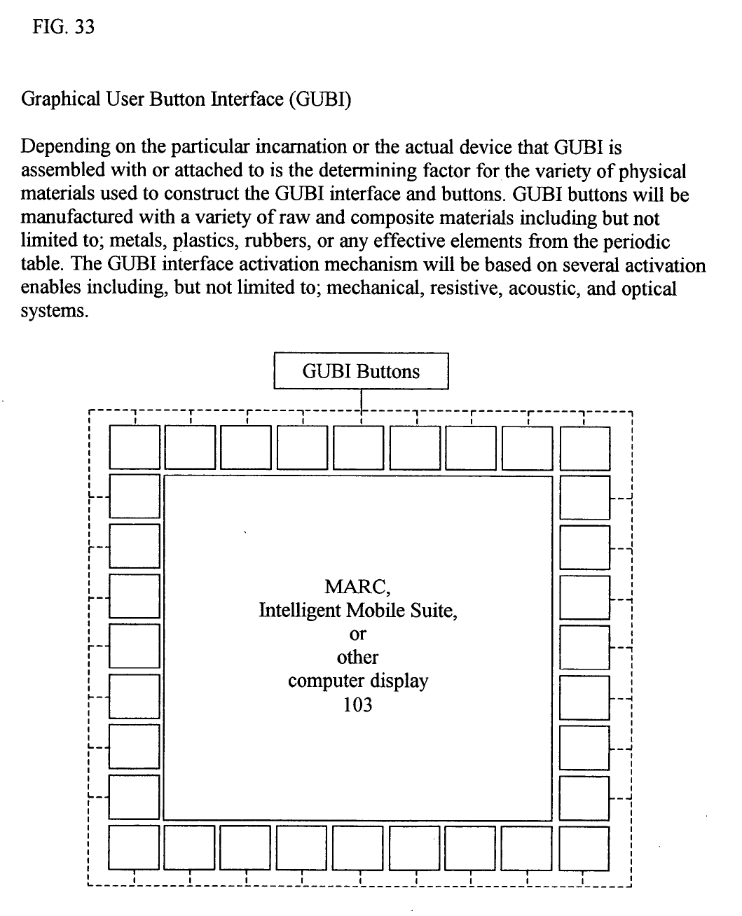

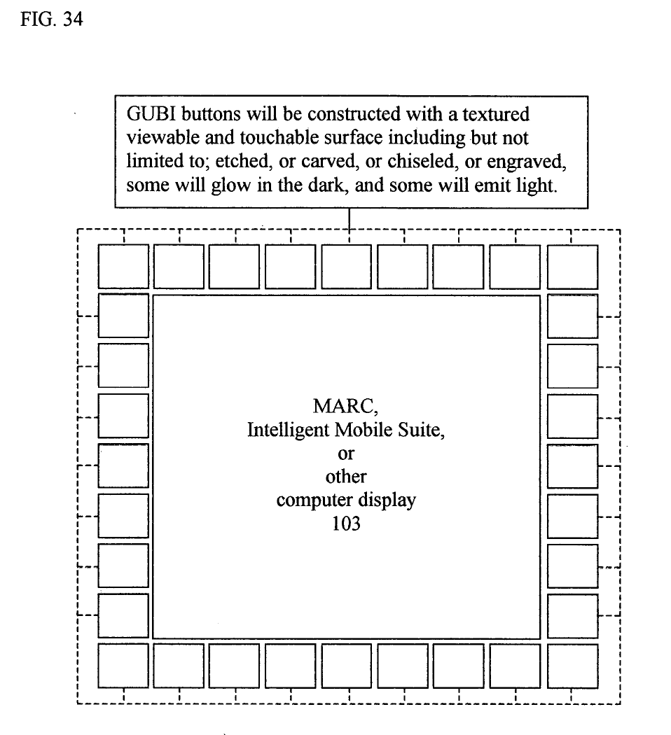

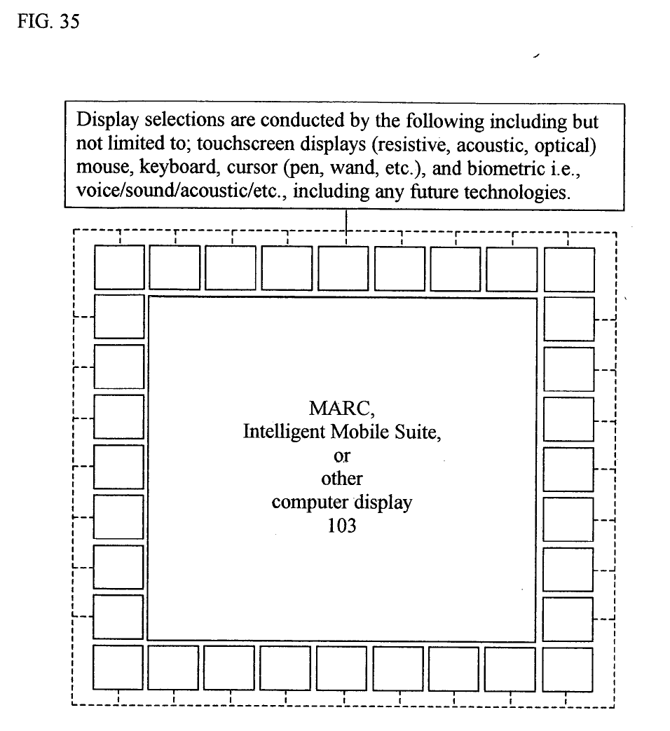

Preferably, a user can activate a RAN Graphical User Button Interface button (hereafter, ‘GUBI button’ or ‘GUBI’) 102A of FIG. 1. Referring also to FIG. 34, each of the Graphical User Button Interfaces is may be a hard button (or LCD, plasma or other) physically mounted around the exterior of, and interconnected to a display device 103 interconnected to any stationary or portable computer device 104 alternatively, the GUBI buttons 102A may be physically built into the exterior of the display device 103. Any number of GUBI buttons 102A can be interconnected with the display device 103. Each GUBI button 102A can be activated by any method, e.g. by pressing the button. Some GUBI buttons are preferably classified as RAN Attraction Services and some GUBI buttons are classified as RAN Featured Applications. Referring to FIGS. 1 and 33, there can be any number of Attraction Services GUBI buttons 102A1 and any number of Featured Application GUBI buttons 102A2 around the display device 103. An Attraction Service can include any type of accessed information or service, generally free to the public or at a nominal cost, such as, but not limited to, finding out the time, finding out directions on how to get from one place to another, communicating with emergency services or law enforcement personnel, etc. A Featured Application GUBI Button 102A2 preferably contains the logo, message, etc. of the entity, which paid for that button, and provides a user with direct access to the enterprise or consumer site 131 of such entity, on the RAN global network 108, or other network, interconnected to the RAN global network 108, of that entity. The relationships among the computer devices 104 utilized by a user, the RAN global network 108 and RAN Central Unified Comprehensive Data Bases (hereafter, ‘RAN Database’ or ‘RAN Databases’) and other networks external to and interconnected with the RAN global network 108 for all Attraction Services are preferably analogous to one another.

The description below illustrates specific components of the RAN System, and interrelationships between the components of the RAN system and network, which apply throughout the remainder of detailed description of the entire text of the Preferred Embodiment, and are not repeated, except in sections when additional unique aspects of the RAN system are also illustrated.

The Graphical User Button Interfaces system, GUBI, is preferably connected to the Ran Data Base of the global network. Once a user selects any of the GUBI Interfaces, the user accesses the enterprise site and applications at the enterprise site on the global network. Each user selection until and including the user exiting the global network constitutes an ‘event.’ The total set of such ‘events’ constitutes a ‘user transaction.’ At any point during a user transaction resulting from selecting a Graphical User Button Interface the user can select the Hypergate, providing the user with a single integrated systems of at least four Hypergateways: Public Hypergateway, Distinguished Hypergateway, Personal Hypergateway, and Enterprise Hypergateway. At any point during a user transaction and while on a path in one of the Hypergateways the user can select a Graphical User Button Interface, and the user crossing between any path in a Hypergateway and any path in a Graphical User Button Interface does not interrupt or end a user transaction.

Attraction Services, available by activating a GUBI button, are services, usually free, or at nominal cost, or for select applications/services at premium cost to consumers, providing them with direct and convenient access to a range of information or services they use in the course of a day, such as e-mail, telephony, videphony, current time and location, arrival and departure times at air, rail, bus et al terminals, etc.

As an example, the Time Attraction Service provides a consumer with the current time at the place where the consumer is located or for any other location around the world.

As an illustration, when said user activates the Time Attraction Services GUBI Button 102B, the Time Attraction Services GUBI Button 102B, attached to the display device 103, and interconnected to the computer device 104, via the computer device 104 transmits a message via the computer device 104, interconnected to the server 107, via the server 107, interconnected to the RAN global network 108, via the RAN global network, interconnected to the RAN Central Unified Comprehensive Transactions Data Base (hereafter, ‘RAN Transactions Data Base’) 109. The RAN Transactions Data Base 109 records data concerning various attributes of the user transaction, such as, concerning the application activated by the user, the unique identifier for the computer device 104 utilized by the user, the time the application was activated by the user, and in the case of an initial event in a transaction, the time of the initiation of the transaction by the user, etc.

A message is transmitted via said computer device 104, which computer device 104 having had its own time periodically updated by the RAN Central Unified Comprehensive Time Data Base (hereafter, “RAN Time Data Base”) 118, transmits a message back via the display device 103, which displays for the user the current time and date at that location of the computer device 104, at which the user is currently located.

An option is displayed for a user, by which the user can request the current time at other locations. Whereupon when the user selects another location and requests the current time for the other location, the display device 103, (interconnected to the computer device 104, which the computer device 104 utilizes an algorithm) (which is a function of the current time at the current location of the computer device 104 and the time zone of that other location) transmits a message back, which displays for the user the current time at that other location requested by said user. The user can select an option, which updates the time in the user's computer device 104, or on a stand alone or portable computer device 104 (i.e., not a Terminal), when interconnected to the RAN global network 108, while in the RAN Time Attraction Service Application.

Preferably, the RAN Time Data Base 118, interconnected to an external network(s)/data base(s) which maintain the accurate time 138, frequently retrieves the accurate time, back via said external data base(s)/network(s) 138, via said server 107, via the RAN global network 108, interconnected to the RAN Time Data Base 118. The RAN Time Data Base 118 is utilized to frequently update the current time in all said Terminals 101A interconnected to the RAN global network 108.

A Featured Application is preferably accessed by a consumer activating a GUBI button reserved for this purpose, i.e. not reserved for an Attraction Service. Consumers have direct and convenient access without having to utilize the main Hypergate Menu on the main screen, to enterprises who purchase Featured Application GUBI buttons. Buttons of varying physical lengths can be purchased for specific periods of time at one or more specific locations of stationary terminals, or personal computers, or mobile devices equipped with GUBI buttons. Enterprises place their logos or other multimedia messages on Featured Application GUBI buttons, in order to gain the attention of consumers and encourage them to visit their enterprise sites. GUBI buttons can utilize any variety of technology for visual-audial communication.

As a further illustration, when said user activates a Featured Application GUBI Button 102A2, that Featured Application GUBI Button 102A2, interconnected to said computer device 104, which said computer device transmits data via said computer device 104, interconnected to said server 107, via said server 107, interconnected to the RAN global network 108, via the RAN global network 108, interconnected to the RAN Transactions Data Base 109, which RAN Transactions Data Base 109 records data concerning various attributes of said user transaction, such as, concerning the application activated by said user, the identifier of the entity site being activated by said user, the identifier of said computer device 104 utilized by said user, the position of the display/computer device 104 being utilized by said user, in the case, e.g., of a MARC Terminal 101A with multiple displays, the time that the application was activated by said user, and in the case of an initial event in a transaction, the time of the initiation of the transaction by said user, etc. and the computer device transmits a message via said computer device 104, interconnected to said server 107, via said server 107, interconnected to the RAN global network 108, via the RAN global network 108, to the entity site 131, hosted on the RAN global network 108, (or on an external network 131, interconnected with the RAN global network 108, via that external network 131), to retrieve the entity site page 131. The entity site or external network 131 transmits the page back via said server 107, via the RAN global network 108, via said server 107, via said computer device 104 via said display device 103, which displays the entity page to be viewed by said user, who then can interactively communicate and access information with that entity site.

Emergency Services

Via the Emergency Services system portion of the invention, utilizing a GUBI reserved for access to the Emergency Services System, a user can identify said user's identity and communicate information about a medical, personal safety, public safety or other type of emergency to emergency services personnel or law enforcement personnel. Any user can communicate information in a variety of means, for example, voice, video image, text or the like.

Parents can use public terminals on the RAN Network at a wide number of locations, in their local communities, visiting another place, around the world (or any intelligent mobile device with wide area network access capability to the RAN Network) to register the disappearance or endangerment of a child, or any other person(s). The network alerts law enforcement of the threat to safety.

RAN can be integrated with 911, police, fire, medical and other emergency response systems. Officials and personnel can be quickly and precisely dispatched to respond to emergencies.

The network is preferably capable of accepting and transmitting still photographs and motion video of children or adults, so they can be identified by any authorized law enforcement or other officials. Across an effective geographic area a picture of a missing or abducted child or adult can be viewed immediately.

The network also is preferably capable of accepting and/or requiring, a unique identification of a person initiating an alert of a threat to or violation of individual or public safety. The instant capture of imagery enables law enforcement to validate the person posting an event and to glean information about the nature of that event.

A parent or guardian can have a special electronic card, on which to store information such as finger prints and perhaps other personal identification data. This card could be inserted into a terminal to quickly transmit critical information to law enforcement or emergency response units.

Children and adults can be educated to easily activate any terminal or intelligent mobile device. Through biometric technologies the person's identity and location may be recorded, and authorities notified of their location and the time.

Alerts of emergencies and contacts by missing, abducted or injured persons are preferably handled and managed with modern database technology to enhance the speed and effectiveness of the emergency response and also linked with authorized international, federal, state and local databases as an integral part of a comprehensive emergency response and management regime.

As a further illustration, when a user activates a RAN Emergency Services GUBI Button 102C. The RAN System preferably records an image of the user(s) at the computer device 104, and records an identifier of the computer device 10 being utilized by the user, to the Emergency Services Data Base 116.

The system also records data concerning various attributes of the user transaction to the RAN Transactions Database 109, such as the identification of the user, the application activated by the user, the identifier of the Emergency Services entity site being activated by the user, the identifier of the computer device 104 utilized by the user, the position of the display/computer device 104 being utilized by the user, in the case of a MARC Terminal 101A with multiple displays, the time that the application was activated by the user, and in the case of an initial event in a transaction, the time of the initiation of the transaction by the user, etc.

Interactive audio-visual communication is preferably established between the user and the Emergency Services entity 133, and also between the user and/or user device, and law enforcement officials located in vehicles in the vicinity of the computer device 104 being utilized by the user.

The RAN system is also preferably able to record, store, retrieve and process any part or all of the communication securely and confidentially, consistent with applicable laws and regulations and agreements with authorized law enforcement and emergency services entities, and also to transmit the communication to external network(s)/information storage systems of Emergency Services entity(ies) 133.

As a further illustration, whenever a person, (e.g. a child in distress) activates a RAN Emergency Services Distress Button 102D, via any number of current or future technologies, including biometrics, etc., that Emergency Services Distress Button 102D: transmits a message to the RAN Emergency Services Data Base 116. The RAN emergency Service Database 116 records the user's identification, and identifier of the computer device 104, being utilized by the user, and matches the user identification with any said user identification, already stored in the RAN Emergency Services Data Base 116.

The information is transmitted to the external network(s) of the appropriate Emergency Services and/or Law Enforcement entity(ies) 133, which can then act on the information received.

Hypergate and Hypergateway(s)

The main Hypergate, along with Featured Application GUBI buttons, preferably functions as the single universal unified point of entry to RAN Hyperspace.

A hypergateway is a ‘super’ site, that serves as a channel or pathway on the RAN network, through which people with similar interests, life style, or at a similar stage in their life cycle, can find a wide array of products, services and information that they desire or need. An important aspect of a hypergateway is, that it is organized around major groups or ‘clusters’ of customers, who want and need to navigate through what currently is the confusing and frustrating maze of the Internet.

Searching for something using a particular key name can be time consuming in the extreme. At a hypergateway product manufacturers, service providers, information sources, who appeal to a group of consumers with common wants and needs are connected at a common point of access on the network, a ‘super’ site. Through such a super sites consumers have structured access to purchase or inquire about a wide array of products, services and/or information relevant to satisfying their individual interests, desires or needs.

The conventional notion is the organization of ‘portals’ around either specific product or service concepts or to the general shopping mall concept, i.e., the mass market. Beyond this standard, conventional Internet marketing thinking the hypergateway is a portal, structured around the determining dimensions of the purchase decisions of major market clusters, a way of realizing the power and profitability of modern market segmentation theory and practice; organized around such segment dimensions as: gender, life style, life cycle, even psychographics. For the firm with insight, the hypergateway is designed to fulfill the promise of wide area network technology through the application of state-of-the art marketing.

Once a user selects any of the Hypergateways, the user can select any number of applications, enterprise sites and consumer sites on the global network connected to the RAN Data Base, to which the user has access. Each user selection until and including the user exiting the global network constitutes an ‘event.’ The total set of such ‘events’ constitutes a ‘user transaction.

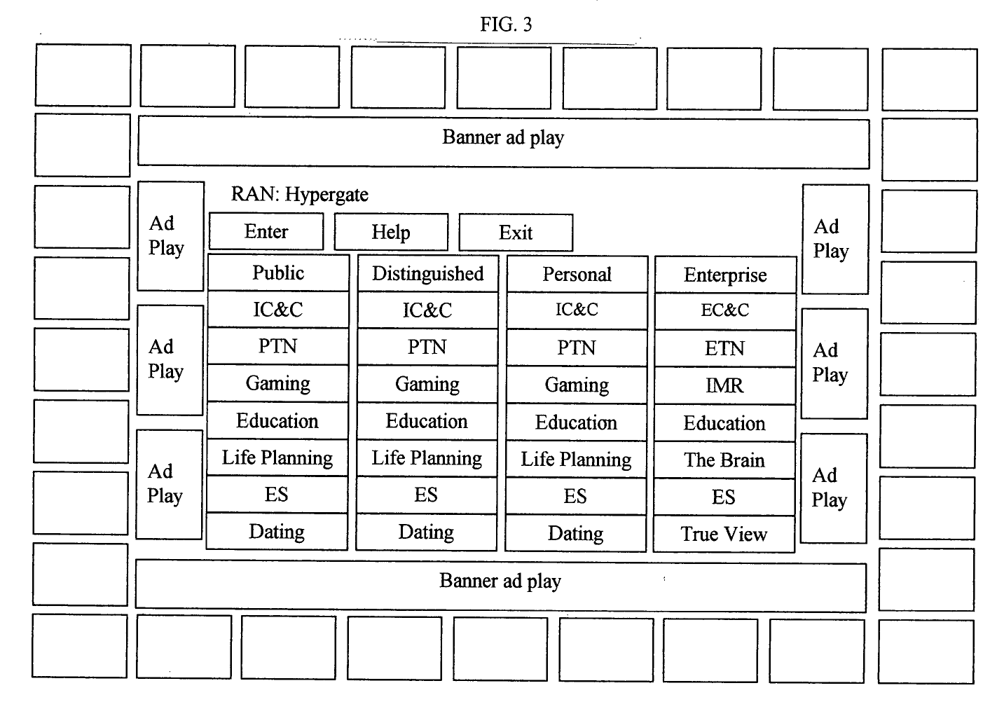

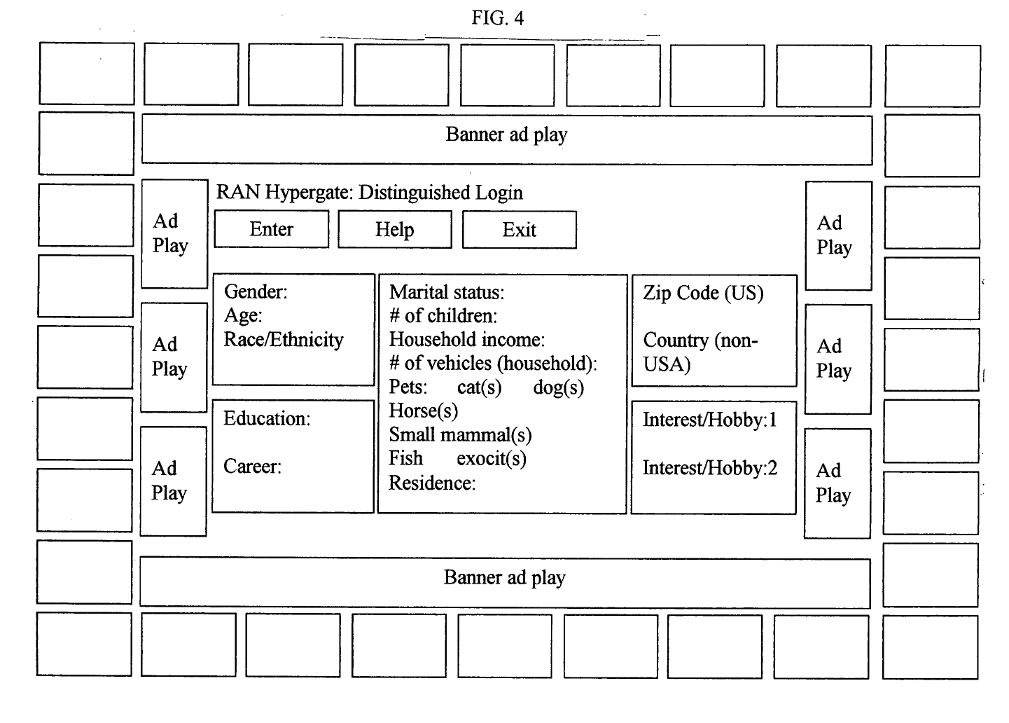

Referring to FIG. 4C, as a further illustration, when a user activates the initial screen of a display in an idle state at the computer device 104, the RAN System preferably displays the RAN Hypergate Menu Display 105A (also FIG. 3), which constitutes the unified integrated point of entry to RAN Hyperspace throughout the RAN System, as is comprised of any number of options, but for the sake of example: option A) Public; option B) Distinguished; option C) Personal; option D) Enterprise.

The system then records data concerning various attributes of the user transaction to the RAN Transactions Data Base 109.

When a user selects the Public option, the RAN System preferably displays the RAN Hypergate Menu Display 105A (and also FIG. 3), comprised of any number of options, for example: option A) Communications & Commerce —IC&C; option B) Public Trading Network —PTN; option C) Gaming; option D) Education & Training; option E) Life Planning; option F) Sound and View Everywhere —SAVE, option G) Emergency Services.

When a user selects the Interactive Communications & Commerce (IC&C) Option, the RAN System preferably displays a directory of enterprise sites and consumer sites 131 when the consumer who owns the consumer site lists the consumer site in the directory. Otherwise the consumer site does not appear in the directory. The directory can preferably be sub-divided in any number of classifications and any number of sub-classifications. The system displays an area into which the user can enter the name of an enterprise site or consumer site.

Data is recorded concerning various attributes of the user transaction to the RAN Transactions Data Base 109, such as the identification of the user if provided at this event, application activated by the user, the ‘level’ within the application being activated by the user, the time that the event was activated by the user, etc. A user, indicating an enterprise or consumer site or drilling down into any of the levels of the hierarchy of the directory, then indicates an enterprise or consumer site, or enters a enterprise or consumer site name in the area provided.

The RAN System preferably displays the enterprise or consumer site 131, and records data concerning various attributes of the user transaction to the RAN Transactions Data Base 109. The user is able to provide information and may also be able to communicate interactively via any means supported by the enterprise or consumer site. When the user communicates to the enterprise or consumer site 131, that user intends to access one or more applications or levels in applications of the enterprise or consumer site 131, requiring payment be made by the user to the enterprise or consumer site 131. The enterprise or consumer site 131 communicates a request to the user to provide specific information when the user communicates the requested specific information, including information to be utilized by the entity of the enterprise or consumer site 131 or the entity of or associated with the RAN global network 108 or one or more external entities 134 to authorize/validate the utilization of said method of payment by said user.

The RAN System then preferably transmits a message, containing the information to be utilized to authorize/validate said user purchase to an external network(s) and data base(s) 134. The database processes the information and transmits a message back to the user either of the authorization/validation or non-authorization/non-validation of the user utilization of the method of payment for the purchase, and records data concerning various attributes of the user event such as the specific enterprise or consumer site application(s) and level(s) to be able to be accessed by the user at that enterprise or consumer site 131, the specific method of payment utilized by the user, the identifier of the external entity(s) 134 to and from which the RAN global network 108 the authorization/validation event was transmitted, the authorization/validation or non-authorization/validation of said user utilization of said method of payment for said purchase of said access, identifier of said user if provided at this event, etc., price of service(s)/product(s)/information to be purchased to the RAN Transactions Data Base 109.

The RAN Transactions Data Base 109 preferably updates the user identifier immediately reflecting the user authorized/validated access to the applications and the levels at the enterprise or consumer site 131 and electronically passes a message to update the user identifier to the RAN Central Unified Comprehensive Consumer Data Base (hereafter, “RAN Consumer Data Base”) 111. The RAN Consumer Data Base updates the user identifier reflecting the user authorized/validated access to the applications and the levels at the enterprise or consumer site 131, and electronically passes the updated user identifier to the enterprise or consumer site 131.

The enterprise or consumer site 131 preferably processes the authorization/validation or non-authorization/non-validation and any other information the enterprise or consumer site 131 receives from said external entity(s) 134. Whereupon when the enterprise or consumer site 131 receives authorization/validation of the user utilization of the method of payment, and when the enterprise or consumer site 131 communicates any further instructions to the user, the user is able to access the specific applications and the levels as authorized/validated for the user as that enterprise or consumer site 131.

The user may either proceed into the enterprise or consumer site application(s) or not, whereupon when the user is making a purchase and communicates to the enterprise or consumer site 131 that the user intends to utilizes a method of electronic payment for the purchase, the RAN System, the external network(s) of payment authorizing entity(ies) 134, and any external network(s) of the enterprise 131 execute the authorization/validation, non-authorization/non-validation and purchase processes.

When the enterprise or consumer site 131 communicates a request to the user to provide any more specific information and the user communicates such requested specific information, including information to be utilized by the entity of the enterprise or consumer site 131 or the entity of or associated with the RAN global network 108 or one or more external entities to ship 135 such product(s)/service(s)/information(s) to the user, the enterprise or consumer site 131, preferably transmits a message via that shipping entity's own network 135, or transmits a message to an external network(s) of any other entity(s) 139, or transmits a message to the RAN Central Unified Comprehensive Shipping Data Base (hereafter, “RAN Shipping Data Base”) 129.

The RAN Shipping Data Base 129 preferably records data concerning various attributes of the user event, such as, concerning the specific product(s)/service(s)/information to be shipped, the address/location to which product(s)/service(s)/information are to be shipped, the method of shipment and the entity to be utilized to perform the shipment, the identifier of the external shipping entity(s) 135 to be utilized, and the identifier of the user, etc.

The RAN Shipping Database 129 transmits to any external network(s) of the external entity(s) to be utilized to ship 135, a message, including the product(s)/service(s)/information, to the external entity(s) to be utilized to ship 135 the product(s)/service(s)/information. Whereupon the external entity(s) to be utilized to ship 135 the product(s)/service(s)/information transmits a message back to the RAN Shipping Data Base 129. The RAN Shipping Data Base 129 preferably records data concerning various attributes of the user event, such as the confirmation/non-confirmation by that external entity(s) to be utilized to ship 135 the product(s)/service(s)/information of their availability/commitment to perform such shipping.

If the RAN Shipping Data Base 129 communicates a non-availability/non-confirmation, then a reiteration process ensues via the RAN global network 108 with/among the entity of the RAN global network 108. The other candidate entity(s) are utilized to ship the product(s)/service(s)/information, until there is a resolution of such issue in accordance with the authorized policies of the entity of the RAN global network 108.

The RAN Shipping Database 129 transmits a message to the user confirming that the product(s)/service(s)/information purchased by the user will be shipped along with various other relevant information. Whereupon the user is able to access the Interactive Communications & Commerce (IC&C) Directory or otherwise communicate via the computer device 104 display with another enterprise or consumer site within the IC&C Application. The user can access different RAN applications/services, or access a GUBI Button, or access the RAN Hypergate Menu Display 105A (and also FIG. 3), i.e. the main menu in RAN Hyperspace, or exit RAN.

When a user selects the Distinguished option the RAN System preferably records data concerning various attributes of the user transaction to the RAN Transactions Data Base 109, and displays for the user the Distinguished Display. The distinguished Display is preferably comprised of any number of options, for example: a listing of demographic, economic, occupational, life cycle, life style, psychographic, etc. traits. The user can select one or more, or for example, a listing of different composite profiles made up of various demographic, economic, occupational, life cycle, life style, psychographic, etc. traits. Such profiles are represented, for example, as icons with the ability to also display text listing/descriptions of the traits of which the profile is composed.

The user can select from among the options, whereupon when the user selects and confirms any options, for example, a set of traits or an icon, (and has the ability to have such selections be stored for the user's utilization in the future upon providing the user single unique account identifier), and when the user communicates the user's single unique account identifier, whereupon the RAN System records the user record such profile or selections to the RAN Interactive Communications & Commerce Data Base 115.

The RAN global network 108 preferably records the user's identification and the user's profile or selections to the RAN Consumer Data Base 111. The RAN Interactive Communications & Commerce Data Base 115 transmits a message, including that the user record has been updated to the RAN Hypergate Data Base 114.

The RAN Hypergate Data Base 114 preferably transmits a message, which displays the RAN Hypergate Menu Display 105A (See FIG. 3), comprised of any number of options, for example, option A) Interactive Communications & Commerce; option B) Public Trading Network (PTN); option C) Gaming; option D) Education & Training; option E) Life Planning; option; F) Sound and View Everywhere (SAVE), option G) Emergency Services; option H) Data Services.

If and when the user selects any application in RAN Hyperspace during the current transaction, other than an application requiring personal identification unless the user provided personal identification in order to store the user's profile or selections or during another transaction at any time in the future until the user disables the user's profile or selections), the RAN Data Base for that particular RAN Application, interconnected with the RAN Consumer Data Base 111 selects those enterprise sites and consumer sites in the RAN Data Base for that particular RAN Application, which according to the user's RAN Consumer Data Base 111 file are identified as being consistent with the current (which can mean, most recently selected by user) profile or selections of the user.

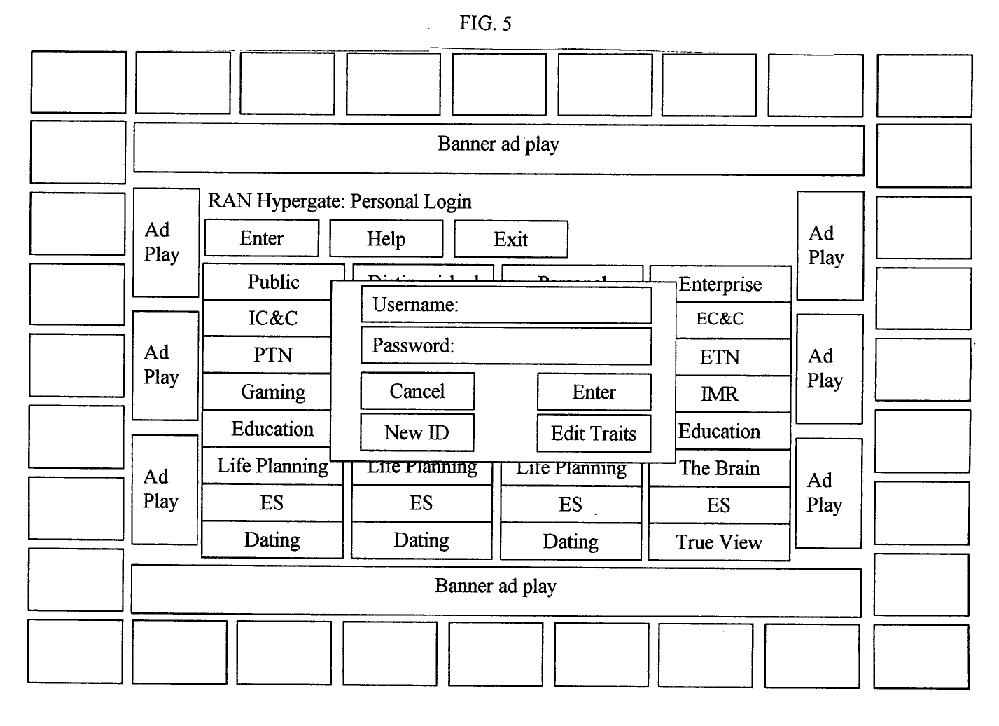

When a user selects the Personal option, the RAN System preferably records data concerning various attributes of the user transaction to the RAN Transactions Data Base 109. The Personal Menu Display 105B1 is displayed (and also FIG. 5), whereupon the computer device 104 communicates a request to the user for the user to communicate the user's personal identifier to the RAN global network 108 (unless said user desires to utilize the registration option, illustrated elsewhere).

Whereupon when the user communicates the user's personal identifier, the RAN System preferably records data concerning various attributes of the user transaction to the RAN Transactions Data Base 109. A message is transmitted which displays for the user at least two options, for example, option A) to record personalized traits to be utilized to customize said user's paths through RAN Hyperspace; and option B) to utilize already recorded traits.

When the user communicates the selection of the option to record personalized traits, the RAN System preferably transmits a message which displays a request for the user to communicate information to the RAN global network 108, in order for the RAN System to organize the directories and paths available to the user in RAN Hyperspace consistent with the user's personal needs and preferences, and traits of a wide variety of kinds, serving to ‘personalize,’ that is, ‘customize,’ or ‘individualize’ the users paths through RAN Hyperspace.

When the user communicates such information, The RAN System records the user information such as, personal profile, selections and/or other information by the user, to the RAN Consumer Data Base 111. The RAN Hypergate Data Base 114 transmits a message which displays for the user the RAN Hypergate Menu Display 105A (and also FIG. 3), comprised of any number of options, for example: option A) Interactive Communications & Commerce; option B) Public Trading Network; option C) Gaming; option D) Education & Training; option E) Life Planning; option F) Sound and View Everywhere; option G) Emergency Services.

If and when the user selects any application in RAN Hyperspace during the current transaction, or during another transaction at any time in the future until the user disables the user's personalized traits, the RAN Data Base for that particular Application, interconnected with the RAN Consumer Data Base 111, selects those enterprise sites and consumer sites in the RAN Data Base for that particular Application, which according to the user's RAN Consumer Data Base 111 file are identified as being consistent with such personalized traits of the user.

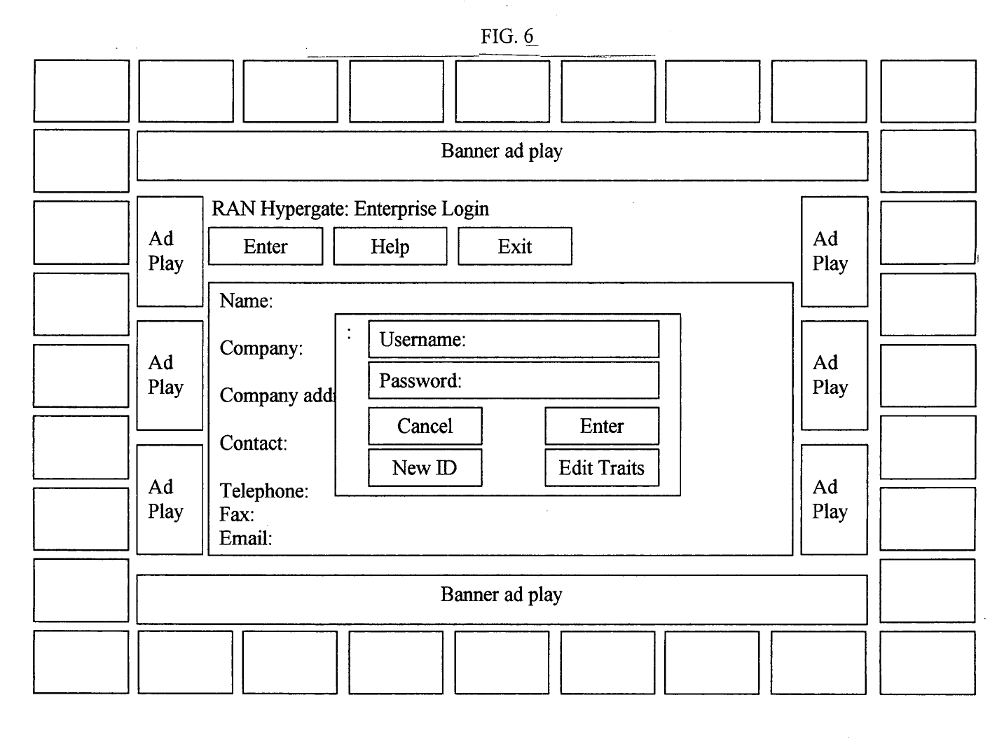

When a user selects the Enterprise option, the RAN System preferably records data concerning various attributes of the user transaction to the RAN Transactions Data Base 109. A message is transmitted which displays for the user the Enterprise Display Menu 105B2 (and also FIG. 6). A request is communicated for the user to communicate the user's personal enterprise identifier to the RAN global network 108 (unless the user desires to utilize the registration option, illustrated elsewhere). Whereupon when the user communicates the user's personal enterprise identifier, the RAN System preferably records data concerning various attributes of the user transaction to the RAN Transactions Data Base 109.

The RAN Transactions Data Base 109 preferably validates or non-validates the user component of such identifier and/or the enterprise component of such identifier, and transmits a message which displays for the user the RAN Hypergate Menu Display 105A (and also FIG. 3), comprised of any number of options, for example: option A) Interactive Communications & Commerce; option B) Enterprise Trading Network (ETN); option C) Gaming; option D) Education & Training; option E) Life Planning; option F) Sound and View Everywhere; option G) Emergency Services; option H) Interactive Market Research, I) Enterprise Communications & Commerce; option J) Brain; option K) Data Services.

If the user proceeds into a non-enterprise applications, such as IC&C or Gaming, the user can utilize the user's RAN personal enterprise identifier to access RAN Applications or applications at enterprise sites or consumer sites on the RAN global network 108. The user can also make purchases or perform any other activity chargeable to or to be associated with the user's own personal account(s) at the entity of the RAN global network 108 or some external entity 139, requiring a personal identifier. The user can utilize the user's personal enterprise identifier to access RAN Applications or applications at enterprise sites or consumer sites on the RAN global network 108, or to make purchases or perform any other activity chargeable to or to be associated with an enterprise, to which the user belongs either as employee or owner, requiring a personal identifier, along with the user identifying that the enterprise identifiable in the user's RAN personal enterprise identifier as the enterprise to or with which a purchase or activity is to be charged or associated, or in the case where the user is associated with more than one enterprise, along with the user indicating which of those enterprises to or with which a particular purchase or particular activity is to be charged or associated. Whenever a user is associated with one or more enterprises and has a RAN personal enterprise identifier, the identifiers for each and all those enterprises are preferably incorporated into the one single unified comprehensive account identifier of the user.

At any point in the user's experience in RAN Hyperspace said user is able from the display at that point to access the RAN Hypergate Menu Display 105A (and also FIG. 3) and utilize that menu to access the Enterprise Communications & Commerce option and any other of the options accessible via the RAN Primary Enterprise Hypergateway Menu Display 105B2.

Z-Card

The Z-CARD is a card with memory. This memory will preferably be used to store personal and business information, credit/debit card accounts, MAC card accounts, fingerprint information, child fingerprint information, electronic coupons, access to personalized paths on the RAN Network. The Z-CARD can store any kind of alpha-numeric and biometric security data.

Users will preferably be able to insert a special card, a Z-CARD, that is, a single card into any terminal or portable electronic device linked to the RAN Network and have access to all the capabilities of any, any combination of, and all of that customer's credit, debit, or other cards. Users will also have the ability to display and compare visually or have the Z-Card automatically compare interest rates, product protection plans, et al, so the consumer can make the most intelligent choice of which credit/debit, or whatever card to use at that particular place and time for that particular purchase.

By integrating all of one's cards that utilize smart card based technology the consumer will need only one card when transacting purchases or business on RAN. A consumer will be able to:
store credit card accounts
dynamically process interest rate and other competitive information for cost savings
store MAC card accounts
store debit card accounts (checking, savings, and other)
store emergency road service account
store phone, telephony, videphony and e-mail account information
store phone numbers, e-mail addresses, and all manner of lists and references
store video rental card information
store health care information
store social security number information
store vehicle registration information
store vehicle insurance information
store vehicle inspection information
store driver license information
store information for access to personalized paths through RAN
store personal access to secure enterprise applications on RAN
store biometric information, such as fingerprint information, for unique biometric security and authorization to accounts
store biometric information, such as a child's fingerprint for use of time-critical emergency services on RAN
store electronic equivalent to cash credits just like carrying cash with enhanced security features
store electronic coupons
store purchase receipts
use to make purchases on RAN
use to make telephony calls on RAN
use to make videphony calls on RAN
use to send and receive e-mail on RAN
use for access to remote video and audio security and other applications on RAN
use for traditional consumer purchasing just like any contemporary card based system anywhere at any time.

Security technology prevents others from using a consumer's Z-CARD. For example, use of the Z-CARD could require providing a finger print or application of other advanced personal identification methods. Thus, in the case of loss or theft of the Z-CARD, no one finding or stealing the card can use it. Since the Z-CARD is used on the RAN Network, the use of a Z-CARD utilizing any current and/or future detection technologies and methods, such as but not limited to imaging, video, biometrics et al. by anyone unauthorized to do so, can automatically result in the identification of the unauthorized person, that person's location and the time of the attempt of the unauthorized use of the Z-CARD. Such a capability could assist Law Enforcement in tracking down the unauthorized holder of a Z-CARD.

Additionally, with a Z-CARD a consumer could immediately access information about interest rates and special coverage et al., associated with various credit or debit cards, enabling the consumer to make an informed decision about which credit or debit card to use for a particular purchase, along with instant on-site reports comparing his or her usage of various credit or debit cards (or have reports mailed to him or her at home on request or on a regular basis).

A user can instruct the RAN System so that the secure electronic purchase transaction capability can reside on and be restricted to particular types of transactions and geographic areas, such as a public terminal, or on a local network of several public terminals at a single large location: like a mall or large store, office building, entertainment site such as a boardwalk, theme park, zoo or historical area, university campus, transportation service such as airport, train station, bus terminal, tourist spot, cruise ship, or on a wider area network, over a few contiguous townships, across a state, throughout a region, upward to national, continental or global coverage; or through home access to RAN or via any intelligent mobile device with wide area network access to RAN able to be used wherever and whenever a consumer desires. For example, parents could limit the locations of enterprise and consumer sites, geographic areas, etc. at/from which their children could utilize the Z-Card.

The Z-Card, a specific set of methods, utilizing smart card technology, can be used both independently or with the RAN System. When utilizing the RAN System, whenever a user interconnects the user's Z-Card with a device for that purpose 102E through any current or future technologies, including swiping, the RAN System preferably transmits data, such as the user's single unique account identifier to the RAN Consumer Data Base 111, which RAN Consumer Data Base 111 validates the user's single unique account identifier (or in the case of non-validation follows alternative procedures). A message is transmitted which displays for the user each of the alternative RAN Z-Card applications and any sub-applications and can also display some information about each application and sub-application, which for the purpose of illustration contains at least the following applications: option A) record personal account information to RAN; option B) information, comparative information option: for comparison of credit/debit card accounts, contents of driver license card or vehicle registration card information, or auto or homeowner's insurance policy, or any manner of information able to be stored in the Z-Card, etc.; option C) payment processing option; option D) Emergency Services.

When the user selects the RAN Z-Card record personal account information to RAN option, the RAN System preferably transmits a message which requests the user to communicate information, such as including the type of account to be recorded, that account identification code(s) and other data, and also to interconnect the user's other smart card with said device for that purpose interconnected to the computer device 104.

When the user communicates the requested information and interconnects said user's other smart card with the device for that purpose, the RAN System records the various data to the user's RAN Z-Card Data Base 117. The RAN Z-Card Data Base 117 transmits a message which displays for the user a message that the account information has been successfully recorded to the user's RAN Z-Card Data Base 117 file (or has not been successfully recorded, in which case alternate procedures are followed).

When the user selects the RAN Z-Card comparative information application and sub-application, the RAN System transmits a message which displays for the user the information in the RAN Z-Card Data Base 117 for all accounts of the user. When the user exits such particular sub-application, the user can access another sub-application, or access the payment processing option. When the user has made a decision to utilize the user's Z-Card in order to make a payment for a purchase and has selected the RAN Z-Card payment option, the RAN System and the network(s) of the enterprise process the authorization/validation/non-authorization/non-validation, and transmits a message, communicating to the user either the authorization/validation or non-authorization/non-validation of the user utilization of the method of payment for the purchase, and data concerning various attributes of the user event, to the RAN Transactions Data Base 109.

The network(s) of the shipping entity(ies) process said shipping information, and records data concerning various attributes of the user event to the RAN Shipping Data Base 129, and transmits a message, communicating to the user the confirmation/status of the user's shipment.

The user is able to access the IC&C Directory or otherwise communicate another enterprise or consumer site within the IC&C Application, or access different RAN applications/services, or access a GUBI Button 102A, or access the RAN Hypergate Menu Display 105A (and also FIG. 3), i.e., the main menu in RAN Hyperspace, or exit RAN.

Periodically, the RAN Z-Card Data Base 117 for each user with a file in the RAN Z-CARD Data Base 117 transmits a message to the external network(s)/data base(s) 134 of such entities to retrieve the most current account information for the user's accounts in the RAN Z-Card Data Base 117, whereupon the external network(s)/data base(s) 134 of such entities transmits back a message, including such account information, to the RAN Z-Card Data Base 117. The RAN Z-Card Data Base 117 records such account information to the user's file in the RAN Z-Card Data Base 117, from where such account information is available to the user, whenever the user communicates a request via the RAN System Z-Card Application for such account information or to perform any comparative information function.

The Brain

There are a plurality of mathematical formulas employed for forecasting the performance of variables into the future. They include, but are not limited to averaging, exponential smoothing, regression techniques and others.

With these methods the forecasted variable is often a function of one or more other ‘independent’ variables or a time series of past observations of the variables, itself, being forecasted. For example, the predicted growth rate for the economy might be a function of private consumption, private investment and public fiscal policy. Commonly, parameters are associated with the ‘independent’ variables, of which the forecast is a function and which specify their relationship to the performance variable being forecasted.

In terms of the work of generating a forecast, such as an analysis of stock market performance, or a product-service market, or currency exchange rates, or economic performance, or scientific research, or any number of other applications, when there are several independent variables or periods in a time series, there are also a large number of ways to allocate values among the parameters. For a twelve period moving average, the forecast of the next period is a function of the observed performance of the most recent twelve periods, e.g., months. If the parameters are required to sum to 1.00, then the number of ways to arrange, or ‘weight,’ numerical values among twelve periods is a very large number.

Many analysts and organizations do not have the computer capacity to test a very large number of alternative ways to allocate values among the parameters. This resource constraint, in part, forces them to use judgement to severely restrict the number of alternative arrangements of parameter values to test. It is often virtually impossible to know with anything near certainty, that the most preferable allocation of parameter values has not been ignored, sometimes just because the total possible set of arrangements of parameter values is too large to think of all possibilities, or even all likely effective possibilities.

A common approach is to test one allocation of values among parameters, and if the results do not provide desired levels of confidence, another allocation is tested, and so on and so on. This trial and error method can be extremely time-consuming. Another approach is to apply more than one alternative forecasting (or other analytical) method to obtain mutually confirming or non-confirming results. Still, performing these methods sequentially is time consuming.

The revolutionary advances in the efficiency, that is, cost effectiveness, that is, the relation of computing power to the cost, of computer technology has made it thinkable, that a much vaster array of alternative parameter value arrangements can be available to analysts world-wide across the whole spectrum of business and research endeavours. By assembling a huge array of alternative allocations of parameter values for the specific contexts of all applicable known quantitative forecasting (or other mathematical analytical) methods, a very large set of alternative sets of parameter values can be run and evaluated simultaneously, and the results provided to the analyst according to whatever criteria desired, for example, most promising, or least promising, to compare for a deeper insight into that promising set, and also many other statistical criteria that an analyst might desire. A large array of desired statistics evaluating each arrangement of parameter values can be provided to assist the analyst in understanding the forecast (or other kinds of analytical) results.

An analyst sends a data set via any number of secure data pathways available through modern telecommunications technology to the Brain, which tests a vast array of alternative mathematical algorithms, either limited or not limited by the analyst, and reports back to the analyst the forecast or other types of results and evaluative statistics, graphics, etc. or in whatever known form the analyst prefers.

Additional services, such as tracking the historical patterns of parameter sets and evaluative statistics, or any other kind of analytical services can also be provided. Beyond that analysts may need to access data from sources outside their own organizations to include as independent variables in their analysis or for other analytical purposes. The Brain can make available to analysts and organizations, at their choice: information on where to access a large number of data sources, or provide for them access through RAN to data sources, or capture (and search, if necessary) requested data for them and feed back the result to them.

The Brain portion of the invention is a system and method for performing simultaneously any number of, or combination of, or all of the alternative mathematical formulae, algorithms or procedures programmable, given the current and any future state of knowledge and capability anywhere in the world concerning mathematics and/or programming mathematical formulae, algorithms or procedures.

The RAN Brain is preferably a software application, which is capable of processing any number of mathematical formulas/procedures, including for forecasting, performed on a data set composed of one or more variables with data, such that whenever a user having accessed the RAN Hypergate 105A (and also FIG. 3) and Enterprise option, the RAN System records data concerning various attributes of said user transaction, such as the identification of the user if provided at this event, identification of the enterprise if provided at this event, application activated by the user, the ‘level within the application being activated by the user, the time that the event was activated by the user, any a number of other entities identified in a user's gaining access to the RAN Interactive Communications & Commerce Application, etc., to the RAN Transactions Data Base 109.

The RAN Transactions Data Base 109 preferably validates or non-validates the user identifier and the enterprise identifier. If the user's personal enterprise identifier is validated, the RAN Transactions Data Base 109 transmits a message which displays for the user the RAN Hypergate Menu Display 105A (and also FIG. 3), comprised of any number of options, but for the sake of example: option A) Interactive Communications & Commerce; option B) Enterprise Trading Network; option C) Gaming; option D) Education & Training; option E) Life Planning; option F) Sound and View Everywhere; option G) Emergency Services; option H) Interactive Market Research, I) Enterprise Communications & Commerce; option J) Brain.

When the user selects the RAN Brain option, the RAN System transmits a message which displays for the user options allowing the user to execute various commands within the Brain Application.

When the user identifies/selects/communicates a data set or file containing such data set to be analyzed, the RAN System transmits a message, including retrieving such selected data set or file to an external network(s)/database(s)/file(s) 139 of the user (or site on the RAN global network 108), which transmits a message, including the requested data set or file. The RAN System preferably displays to the user the options, allowing the user to execute various commands, and records the data set or file to the RAN Brain Data Base 127. When the user communicates/specifies A) one or more specific mathematical procedures; B) none, or one or more specific parameters utilizing in each mathematical procedures selected by the user; C) none, or one or more specific parameters of one or more of such variables selected by the user; D) none, or one or more specific statistics able to be utilized to evaluate the results of alternative mathematical procedures, or sets or combinations of parameters, or to be utilized for other analytical purposes, and any specific order in which to execute the mathematical procedures, parameters or statistics, or to execute all the selected mathematical procedures, parameters and statistics simultaneously, for which such simultaneous processing is consistent with generally accepted sound analytical protocols (all of which also can be selected from a menu of mathematical procedures, parameters, statistics, running sequence options, etc. as appropriate, appearing when such communicates/selects an option which results in the appearance of such menus) the RAN System transmits a message to the RAN Brain Application.

The RAN Brain Application preferably computes the estimated amount of time and cost to such user-enterprise to process the user selections. The RAN System communicates to the user said estimated amount of time and cost to the user-enterprise.

When the user communicates/selects approval of the execution of the user's selections of mathematical procedures, et al., the user's-enterprise's method payment is authorized/validated and recorded in the RAN Transactions Data Base 109. When the user communicates/selects confirmation of the user's approval of the execution of the user's selections of mathematical procedures et al. the RAN System transmits a message to execute the user's selections of mathematical procedures et al, to RAN Brain Application. The RAN Brain Application interconnected to the RAN Brain Data Base 127, transmits a message to retrieve such data set or file, interconnected to the RAN Brain Data Base 127, which RAN Brain Data Base 127 transmits the data set or file to the RAN Brain Application.

The RAN Brain Application preferably performs on such data set or file the mathematical procedures, parameters, statistics and running sequence selected by the user, and transmits a message, including the results of the execution of the mathematical procedures, et al., selected by the user, to the external network(s)/database(s)/application(s) 139 of the user-enterprise, and records, which records data concerning various attributes of the user transaction, such as, mathematical procedures, parameters, running sequences et al selected and executed/not-executed, amount of time estimated/actual start-end times for execution of the user selections, etc. to the RAN Transactions Data Base 109.

Unified Comprehensive Data Bases and Data Management and Services

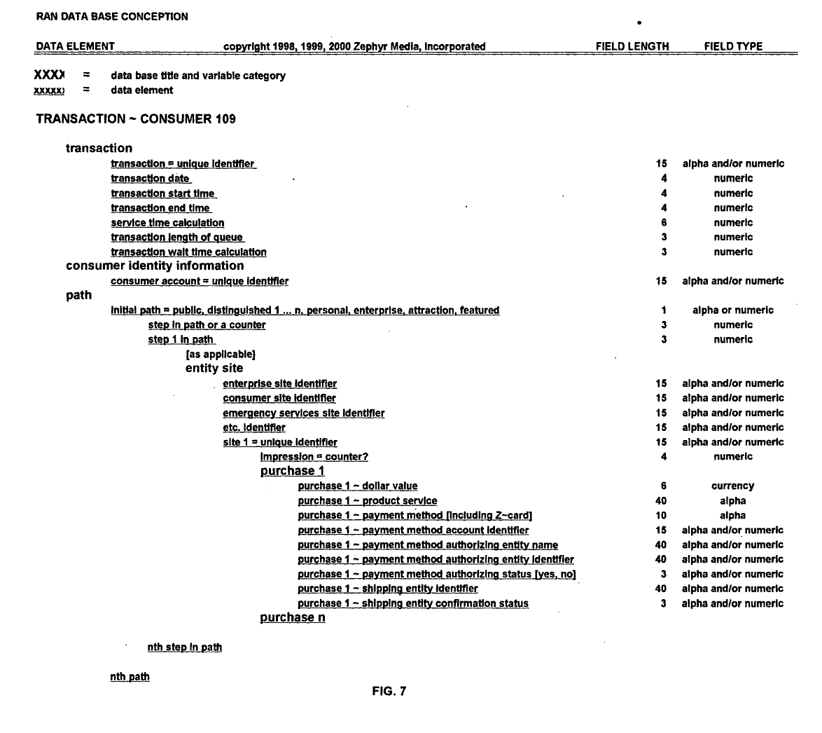

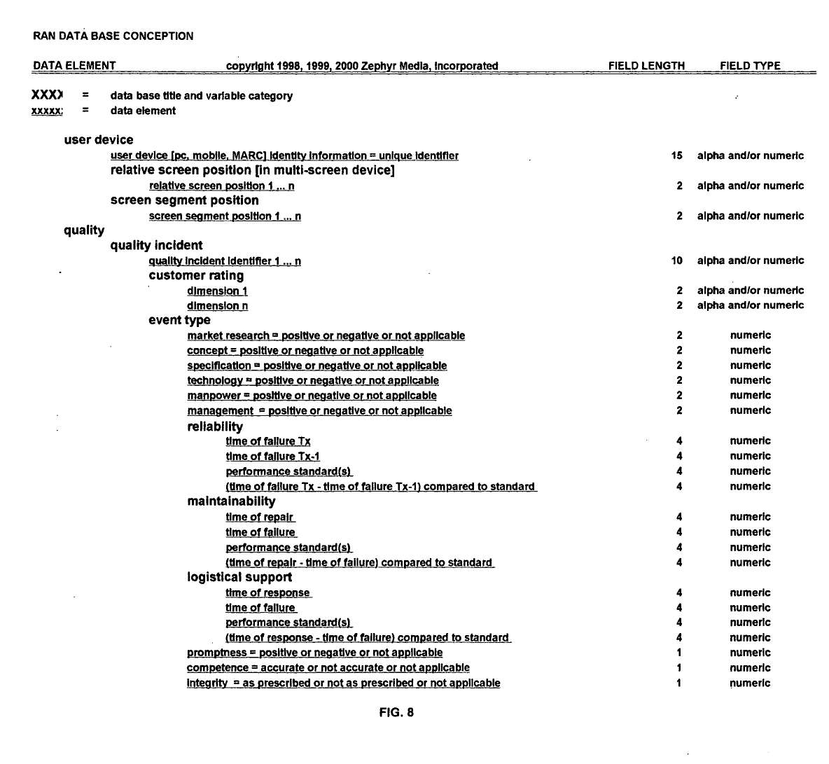

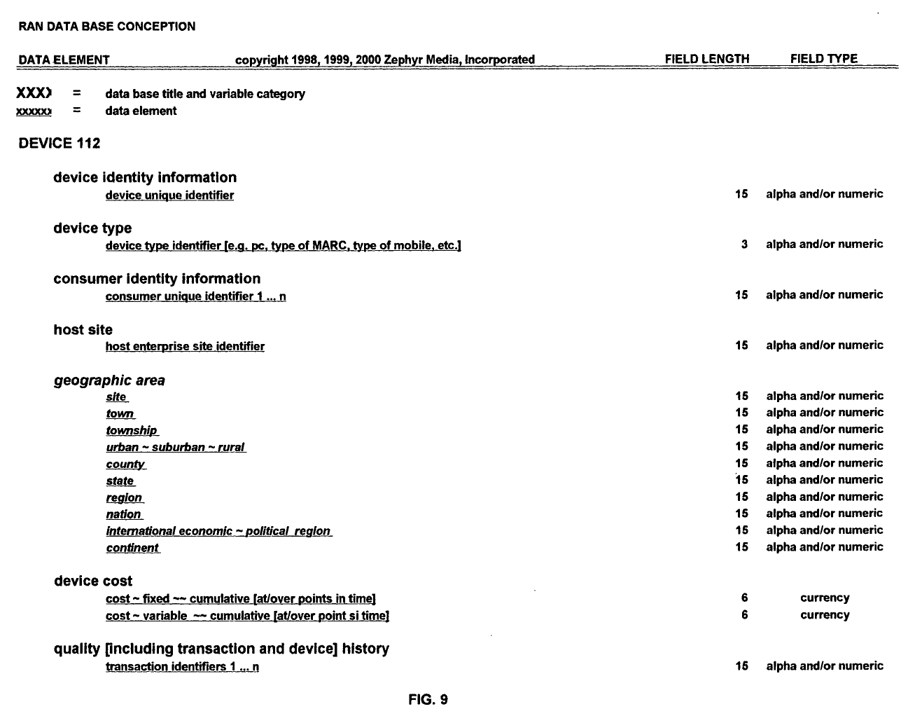

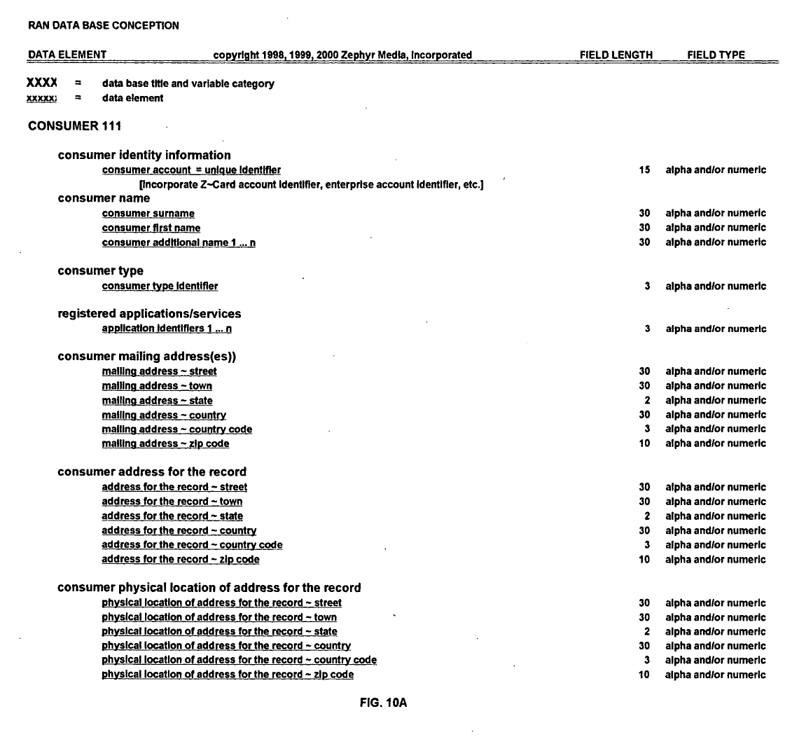

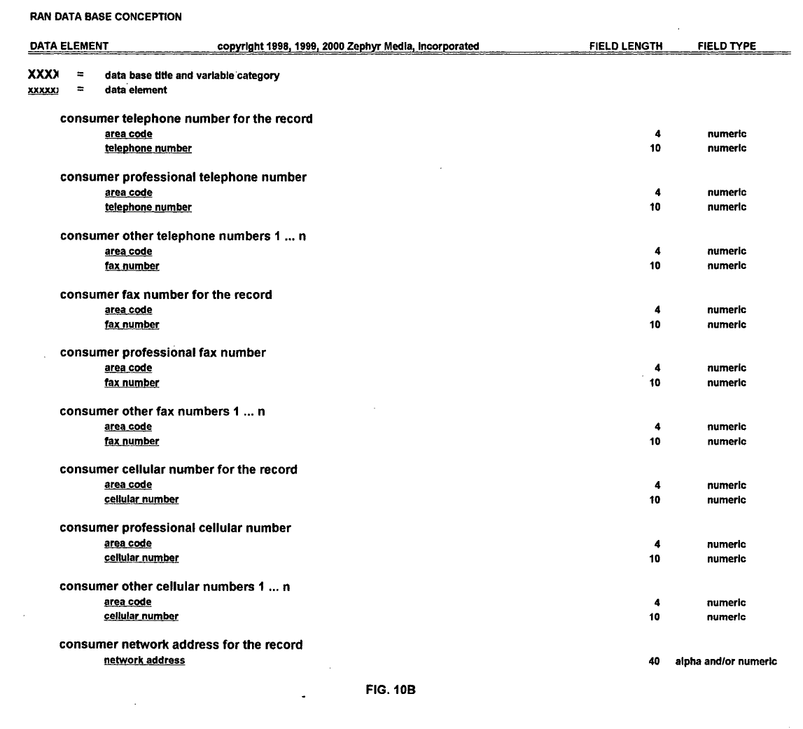

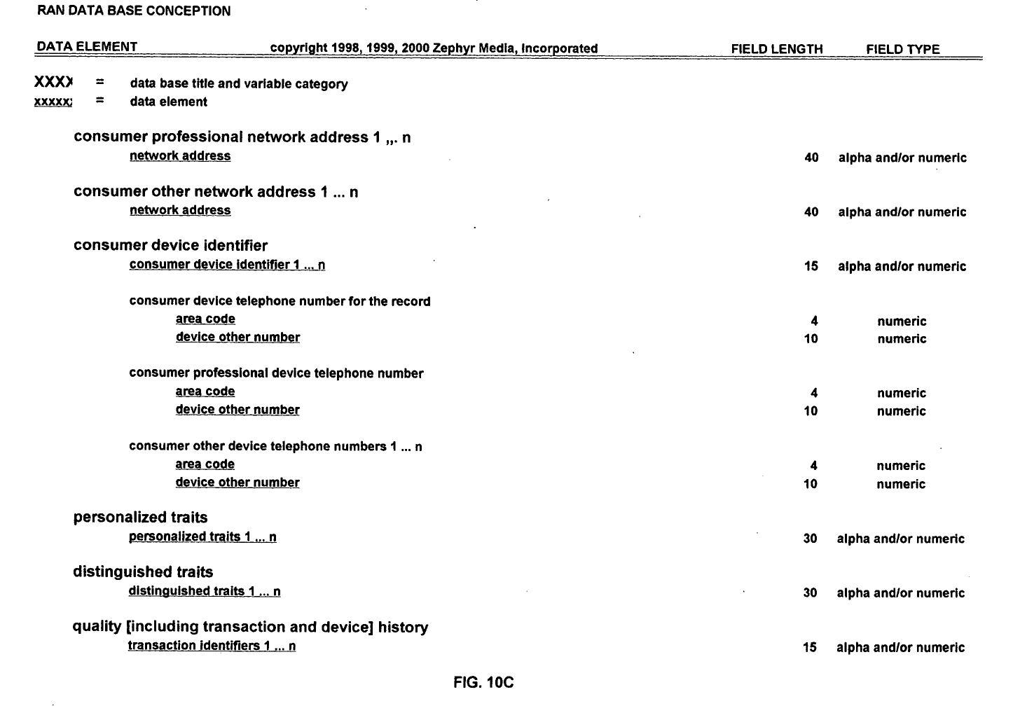

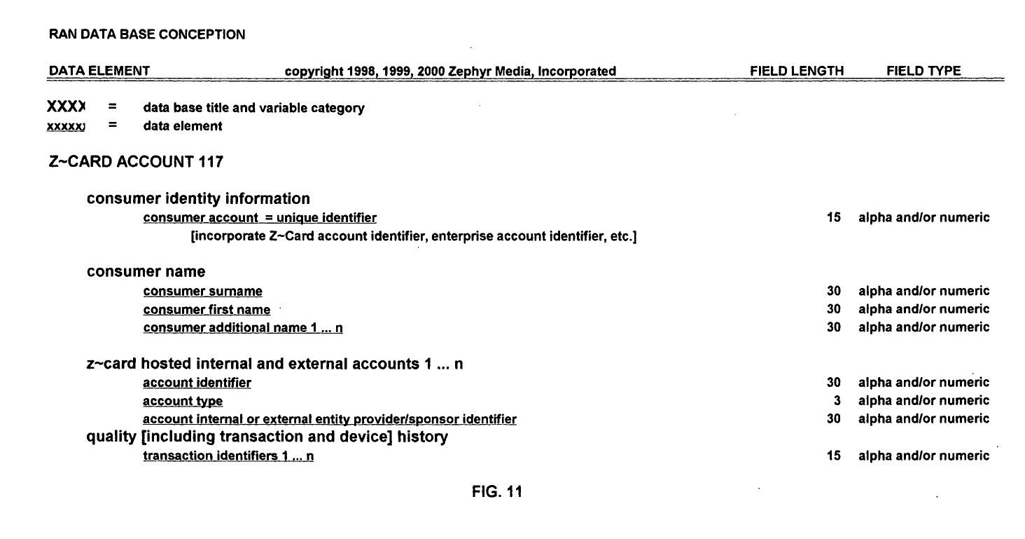

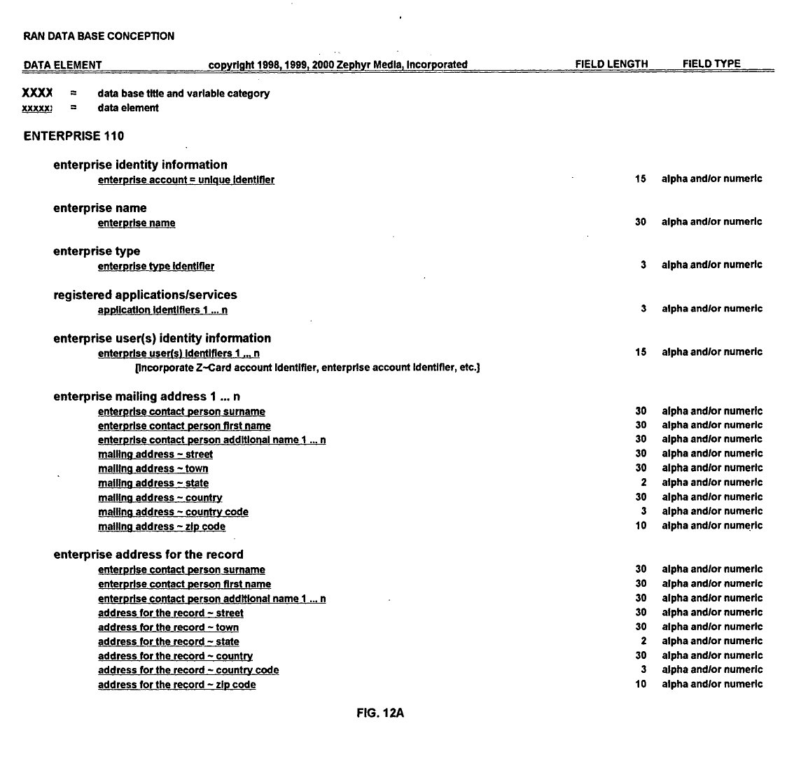

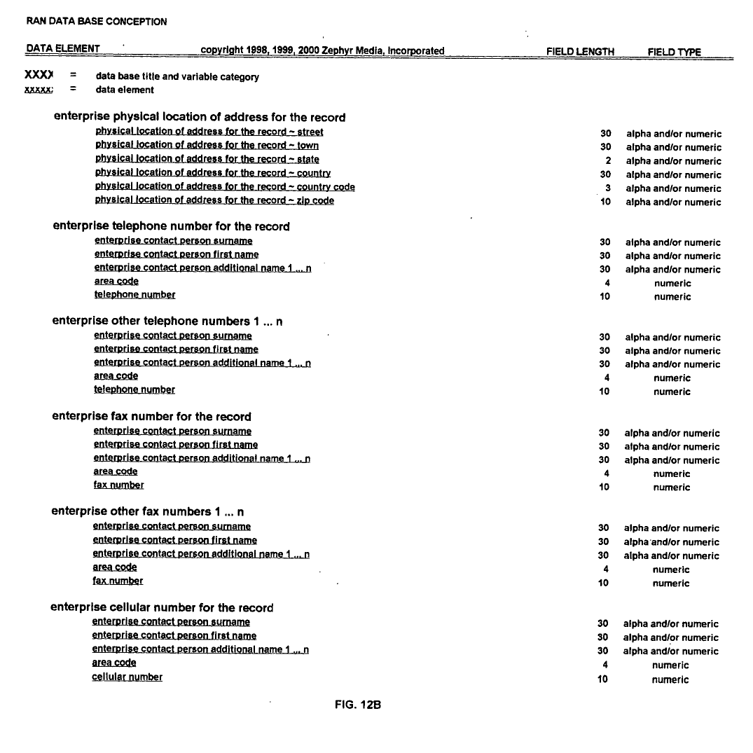

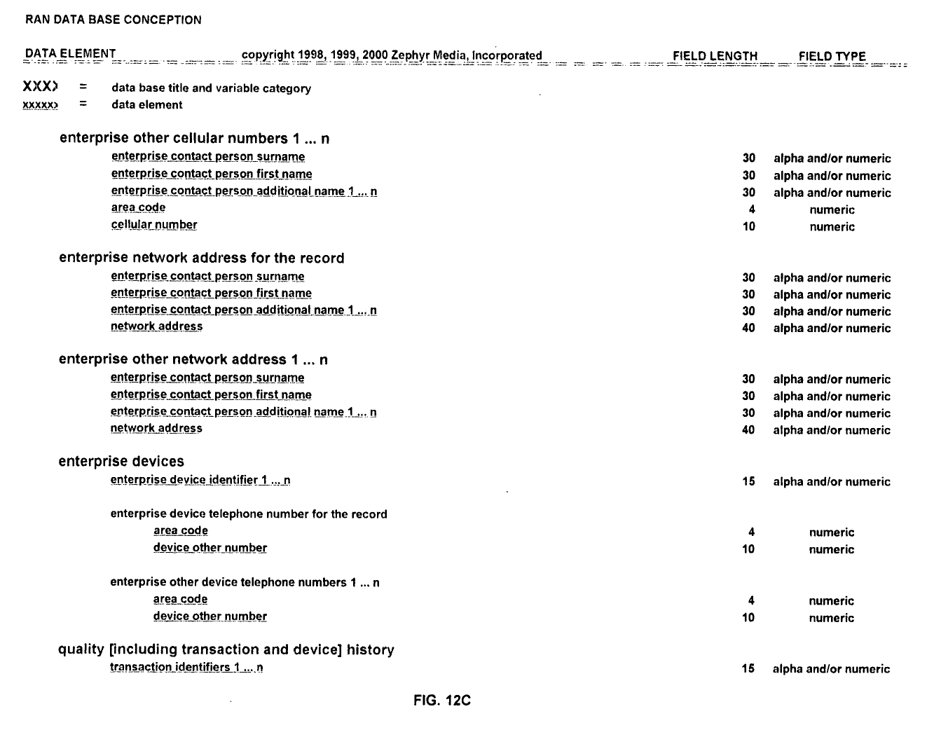

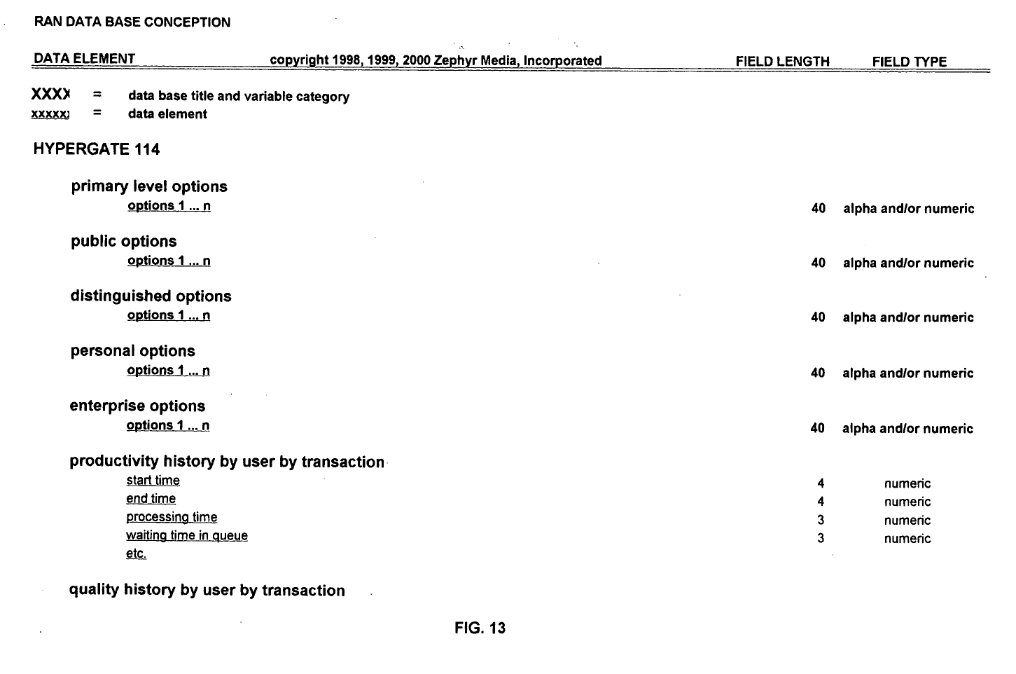

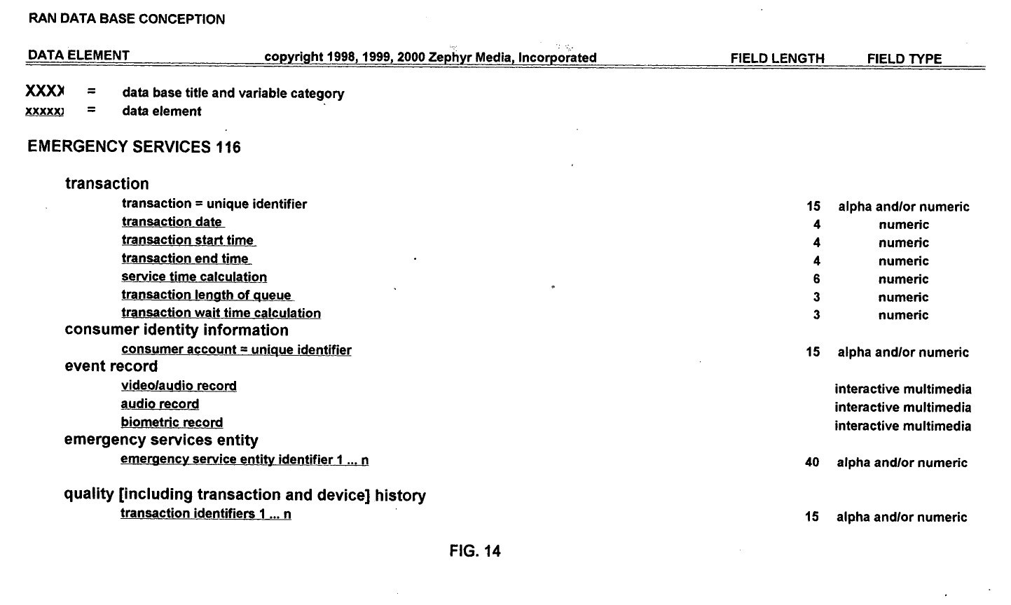

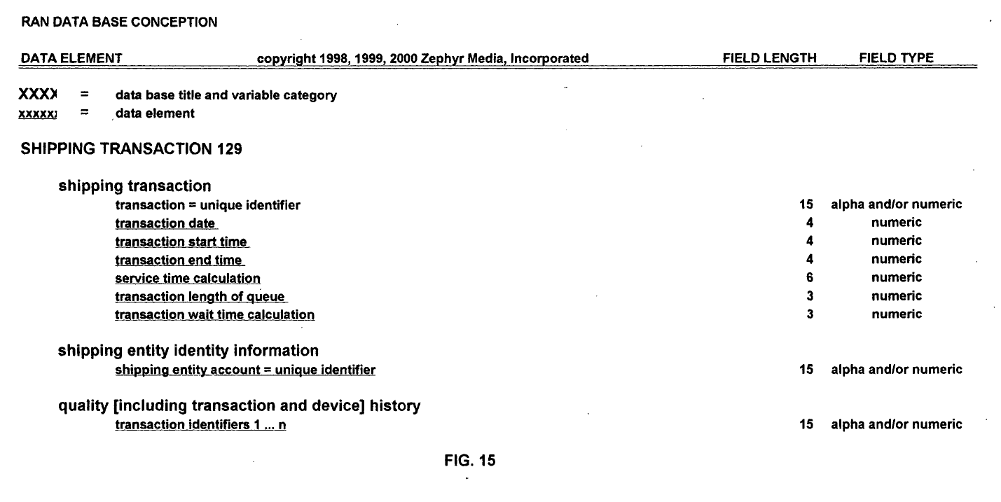

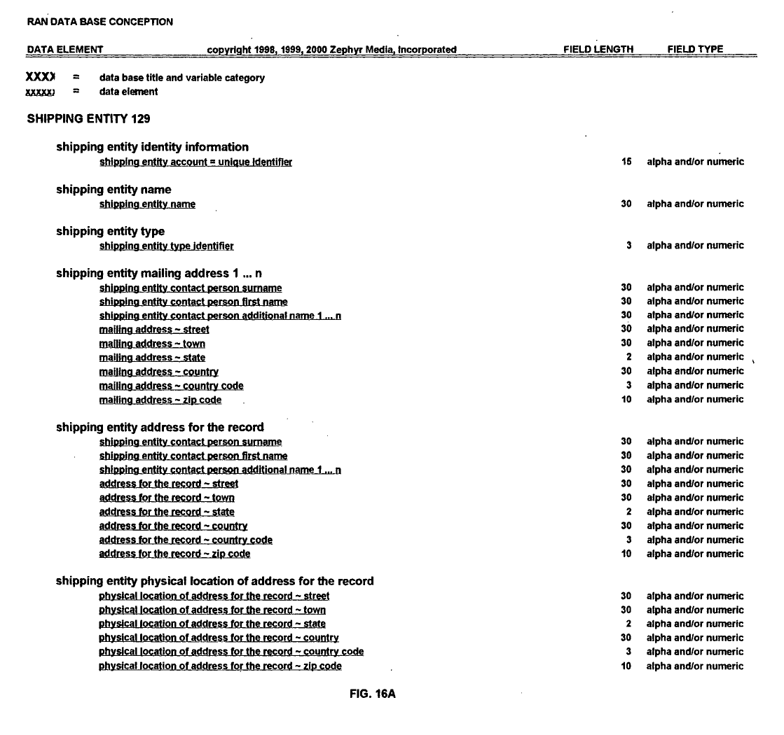

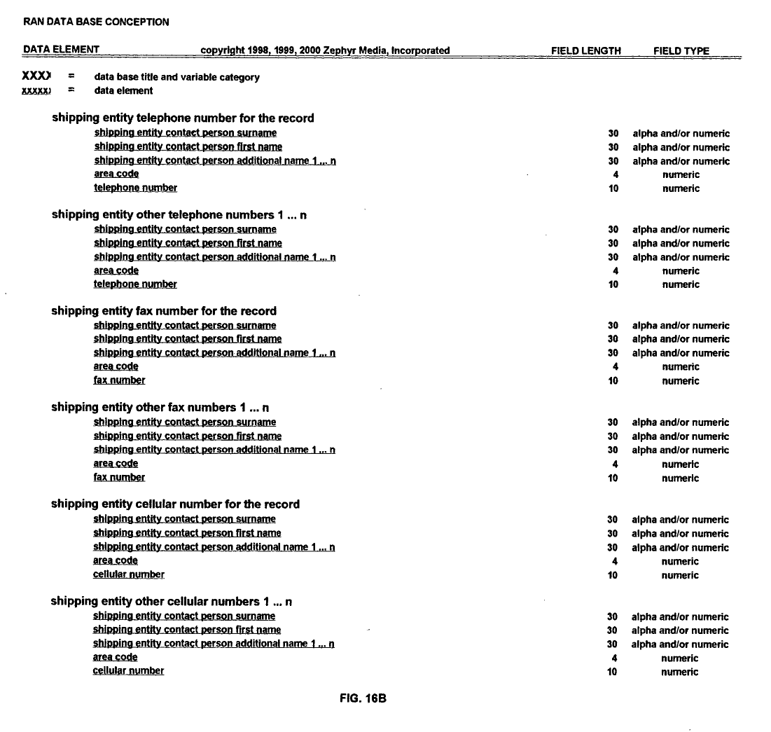

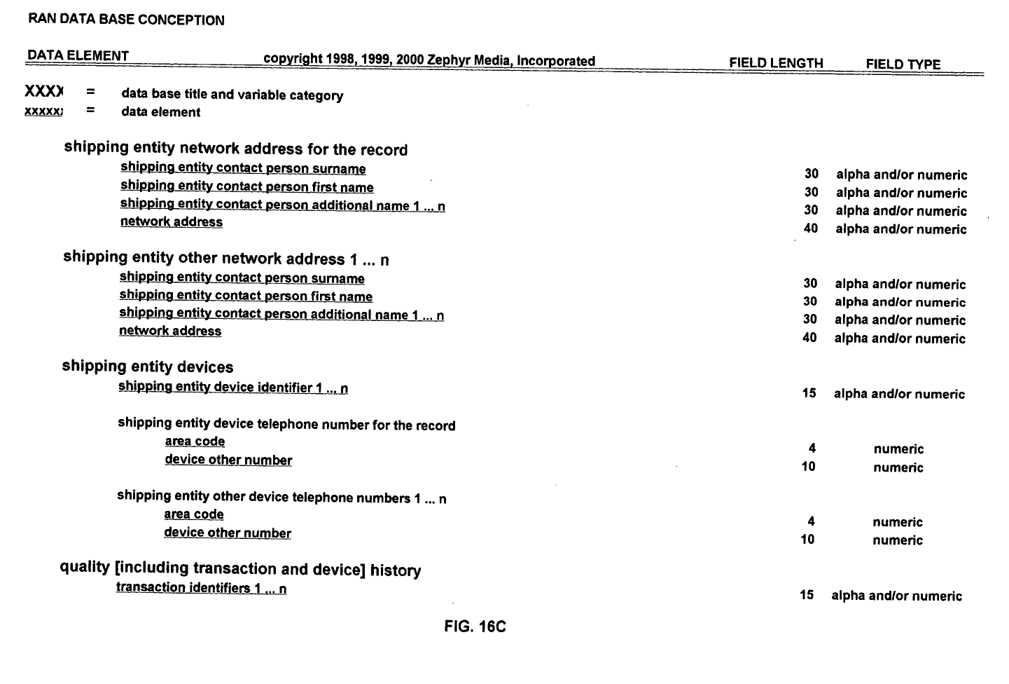

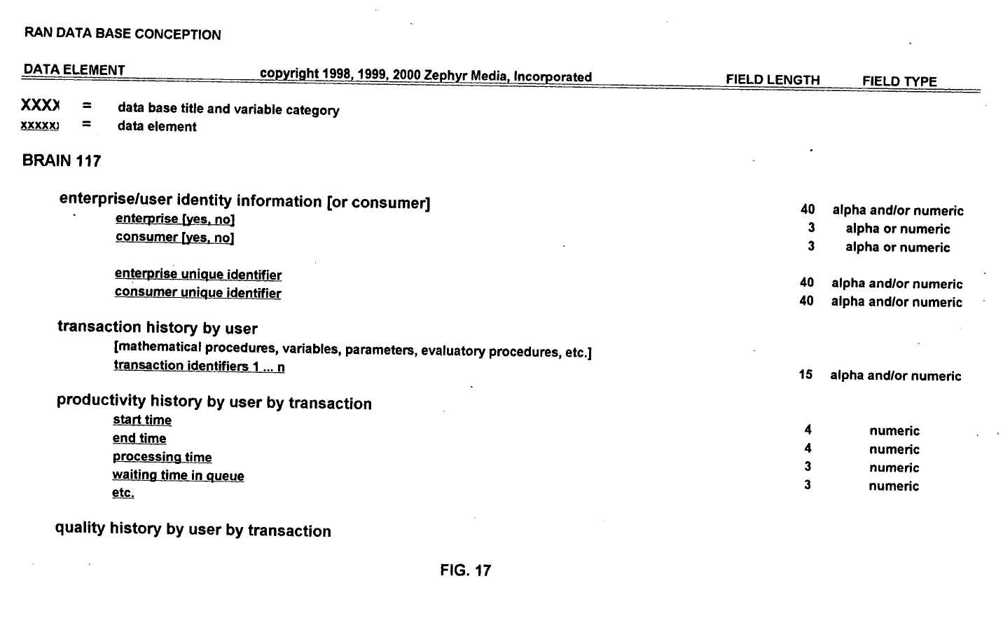

Referring to FIG. 1 and FIGS. 7, 9, 10, 11, 12, 14, 15 and 16, the data management system preferably records all elements from the single point of entry to the single point of exit on the global network, including events in each transaction by each user for each application at each enterprise site and each consumer site on the global network with each computer device at each device host enterprise site and at each other location and in each geographic area around the world at or/during each time period. All of these elements across the universal extension of any number, including all of the horizontal levels in the totality of the vertical hierarchy of the global network, are automatically transmitted in real-time (and/or batched) to the Ran Data Base, which is part of the global network's integrated unified comprehensive data system. The Ran Data Base is the destination and repository to which each of the recordable elements concerning the sets of the total universes of transactions, users, applications, enterprise sites on the global network, consumer sites on the global network, computer devices, device host enterprise sites, other locations, geographic areas around the world and each time period, all of these elements across the universal extension of any number, including all of the horizontal levels in the totality of the vertical hierarchy of the global network, are automatically transmitted in real-time (and/or batched).

Software programs utilizing data from the Ran Data Base preferably generate reports and perform analyses across all the recordable events, and any sub-classifications of the recordable elements concerning the sets of the total universes of transactions, users, applications, enterprise sites on the global network, consumer sites on the global network, computer devices, device host enterprise sites, other locations, geographic areas around the world and each time period, all of these elements across the universal extension of any number, including all of the horizontal levels in the totality of the vertical hierarchy of the global network. All such reports and analyses have confidence levels of about 100 percent and statistical margins of error about equal to (zero), as such reports and analyses are drawn across the sets of the total universes of the variables, of which such reports and analyses are comprised.

Revenue generated by each of the revenue-generating recordable elements concerning the sets of the total universes of transactions, users, applications, enterprise sites on the global network, consumer sites on the global network, computer devices, device host enterprise sites, other locations, geographic areas around the world and each time period, all of these elements across the universal extension of any number, including all of the horizontal levels in the totality of the vertical hierarchy of the global network, are automatically transmitted in real-time (and/or batched) to the Ran Data Base of the global network.

Software programs utilizing data from the RAN Data Base preferably generate revenue reports and perform analyses across all the revenue-generating recordable events, and any and all sub-classifications of the revenue-generating recordable elements concerning the sets of the total universes of transactions, users, applications, enterprise sites on the global network, consumer sites on the global network, computer devices, device host enterprise sites, other locations, geographic areas around the world and each time period, all of these elements across the universal extension of any number, including all of the horizontal levels in the totality of the vertical hierarchy of the global network. The revenue reports and analyses have confidence levels of about 100 percent and statistical margins of error about equal to (zero), as such reports and analyses are drawn across the sets of the total universes of the variables, of which such revenue reports and analyses are comprised.

As a further illustration of RAN, the RAN Central Unified Comprehensive Data Management and Services (hereafter, “Ran Data Management Services”) is the function of extracting data from the RAN Data Base and processing such data into reports aggregated across the set of the total universe of users of all classifications and sub-classifications across the universal extension of each horizontal level throughout the totality of the vertical hierarchy of the RAN global network 108 (hereafter, “reports”). Whenever a user having accessed the RAN Hypergate 105A (and also FIG. 3) and Data Services Option, and having communicated the user's single unique account identifier, the RAN System records data concerning various attributes of the user transaction, to the Transaction Data Base 109.

The RAN Transactions Data Base 109 preferably validates or non-validates the user identifier and the enterprise identifier (if applicable). If the user's personal enterprise identifier is validated, a message is transmitted which displays for the user the RAN Data Services Menu Display, comprised of any number of options, for example: a list of variables contained within the RAN Data Bases, a method(s) for the user to indicate each variable to be included in the report requested by the user, the hierarchical order in which those variables are to be sorted, analytical procedures, etc.

When the user communicates/specifies A) one or more specific variables; B) a specific hierarchical order covering all the variables to be sorted, the RAN System transmits a message to RAN Data Services Application, which RAN Data Services Application and RAN System computes the estimated amount of time and cost to such user to process the user requested reportanalysis, and displays the time and cost information for the user.

When the user communicates/selects approval of the execution of the user's selections of variables et al., and whereupon the user's method of payment is authorized/validated and recorded in the RAN Transactions Data Base 109 when the user communicates/selects confirmation of approval of the execution of the user's selections of variables et al., the RAN System transmits a message to execute the user's selections of variables et al., to RAN Data Services Application.

The RAN Data Services Application preferably transmits a message to retrieve such data set or file, from the RAN Data Base. The RAN Data Base transmits the data set or file to the RAN Data Services Application, performs on such data set or file the mathematical procedures et al., to generate report with the variables et al. selected by the user, and transmits a message, including the report selected by the user, to communicate to the user the report selected by the user. Data concerning various attributes of said user transaction is recorded, such as, variables, hierarchical order, and analytical methods executed/not-executed, amount of time estimated/actual start-end times for execution of the user selections, etc. to the RAN Transactions Data Base 109.

User Registration

For some RAN applications, it is appropriate for consumers or enterprises to formally register. A purpose of this registration process is for consumers and enterprises to provide the RAN System with sufficient information about themselves for the RAN System to establish for them unique individualized confidential and secure identities within the RAN System, and specifically the RAN Data Base. Such an identity enables a user to access and utilize various RAN applications in a confidential and secure mode.

As a further illustration of RAN, in order for the user to conduct some transactions in RAN Hyperspace, the user entity, such as a consumer or enterprise, etc., registers. The registration process for any particular RAN application/service is analogous to the registration process for any other RAN application/service.

To begin the registration process, the user utilizing the RAN Hypergate Menu Display 105A (and also FIG. 3), and then utilizing the RAN Hypergate Personal Menu 105B1 (and also FIG. 5) or RAN Hypergateway Enterprise Menu 105B2 (and also FIG. 6), selects the registration option, via such display.

The RAN System preferably records data concerning various attributes of such user transaction to the RAN Transactions Data Base 109, and displays for the user any number of alternative registration scenarios/options, including, for example, for consumers: A) registering a consumer site in the RAN Personal Trading Network Application; B) registering as a consumer to utilize the RAN ‘personal’ path while navigating through RAN Hyperspace; C) registering as a consumer to utilize the ‘distinguished’ path while navigating through RAN Hyperspace, but also to exercise the option of recording the user's distinguished traits for future utilization in RAN Hyperspace by said the; etc.; or for enterprises: A) registering an enterprise site in the RAN Interactive Communications & Commerce or related Applications; B) registering an enterprise site in the RAN Enterprise Trading Network Application: C) registering an enterprise as a host site location for one or more MARC Terminals or as a MARC Exchange; etc.

When said user selects any one of such registration scenarios/options the RAN System preferably records data concerning various attributes of such user transaction to the RAN Transaction Data Base, and displays a registration form for the scenario/option selected by the user. When the user communicates the information requested in such registration form, and the RAN System records data concerning various attributes of such user transaction to the RAN Transactions Data Base 109, and records the information from the registration form communicated by said user to the user's file to the to the RAN Consumer Data Base 111 (or RAN Enterprise Data Base 110, as appropriate), and transmits a message, which displays a confirmation for the user of the recording of the user's registration information in the user's file in the RAN Data Bases(s).

Advertising Via Software—AVS

Advertising Via Software extends the reach of advertising messages from enterprises of all kinds, all over the World, by embedding advertisements into any software applications. The advertisements are displayed and appear automatically, when a software application is launched, during operation, and as the application closes, for example:
when the computer is started, restarted, shutdown, or as a screen saver;
opening, starting, or launching an application;
embedded in the menu bar;
embedded in a specific menu as listed items that would provide access to the underwriting organization;
during operational functions such as, printing, sorting, merging, or within any type of operational functions;
any time that a dialog box appears, e.g., when a user selects to print and a dialog box appears, along with this dialog box an advertisement would be displayed;
at any particular time when the applications are being used, advertisements play as perimeter ads (ads that display around the perimeter of the viewable area); and
when any message appears, e.g., out of paper;
utilizing any and all types of advertisement media: (Any type of digitized traditional or computer generated media) e.g., Graphic, picture, illustration, line art, Animation; Video, or Text.

New advertisements are updated in a variety of ways, for example, at pre-programmed or other specific times via a network, or diskettes, compact disks, and other future media. The software applications could have a “time bomb” (an internal programmed clock) programmed into them, resulting in their being rendered inoperable after a specific time period as an incentive for the applications to be updated. During these updates advertisements are updated.

Users would preferably have options and selections, enabling their applications to be updated automatically, whenever they are on any type of network, i.e., RAN, Internet, intranet, extranet, or other distribution process (disk, CD, etc.). Users can also preferably select to update their applications at any particular time, any time of day or night, that would be the most convenient and productive for them, so that the process of downloading will be non-obtrusive and non-disruptive to their work practices and lifestyles.

Indeed the points in the operation of a software application could be managed as time cells akin to time cells on the RAN Network and updatable many times throughout a day, week, month or year.

The Advertising Via Software system transmits: advertisements from external entities, interconnected to the global network, to the global network; and from external entities via the global network to the RAN Data Base; and transmits advertisements from the Ran Data Base to any user computer device; and from any user computer device to the user display, which communicates the advertisements to the user.

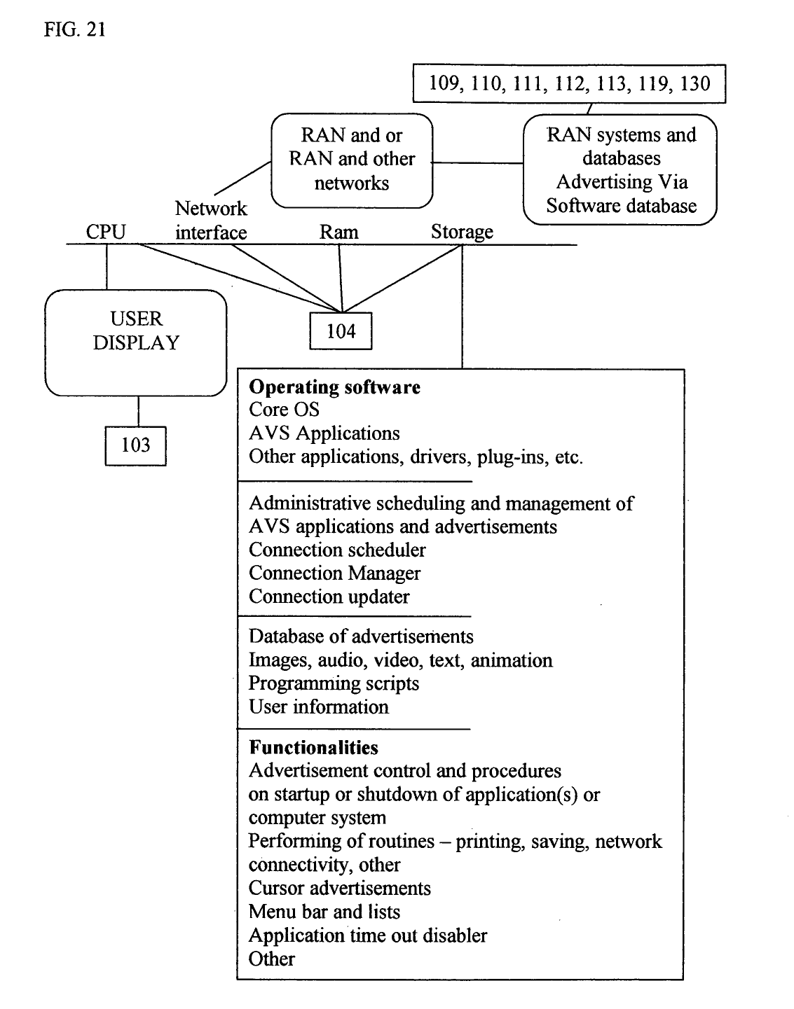

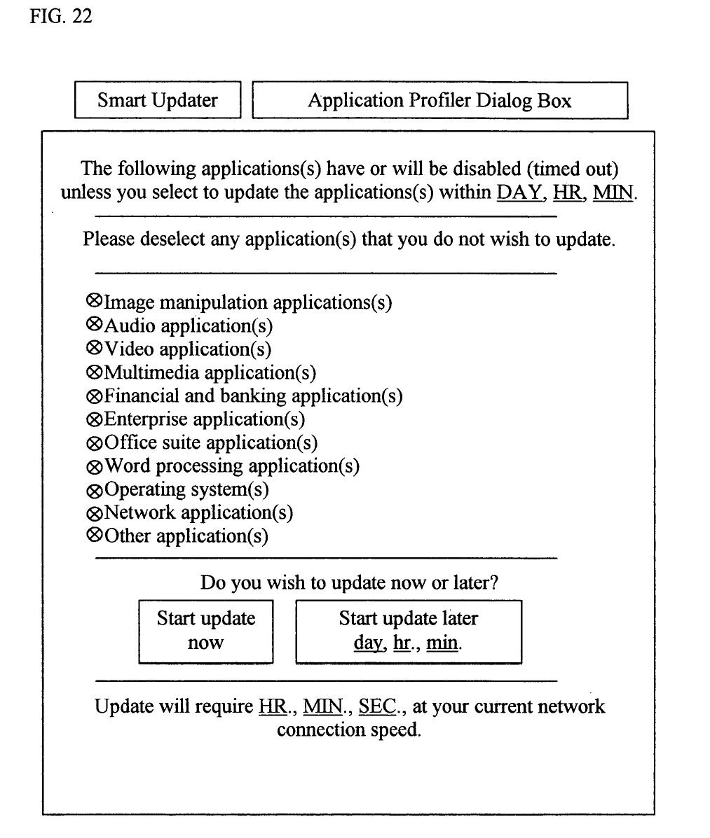

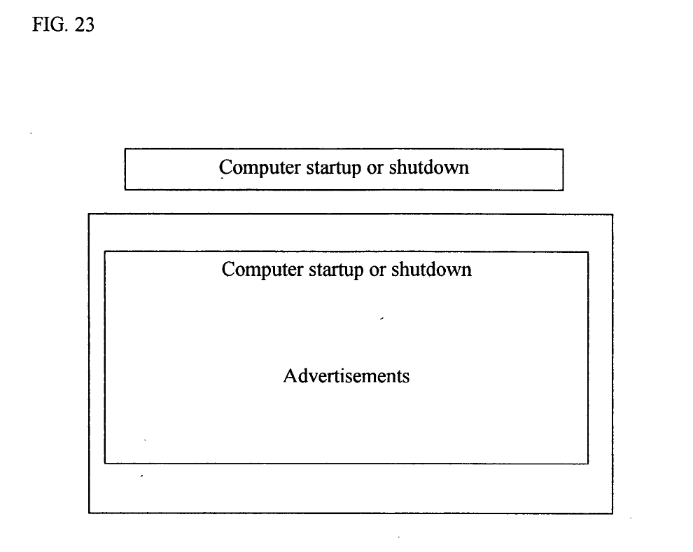

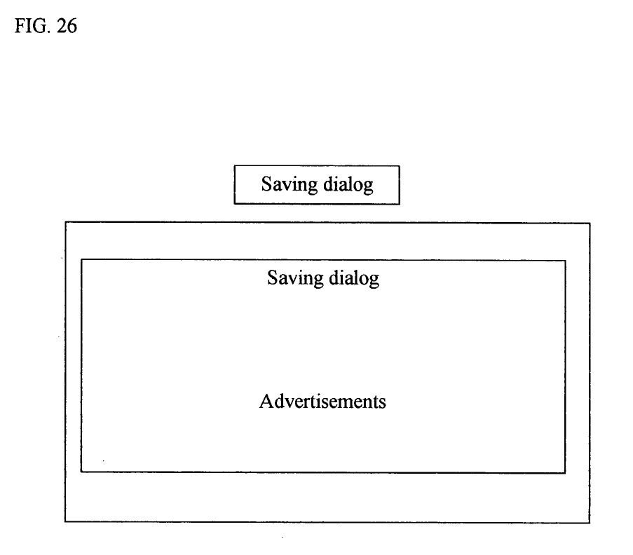

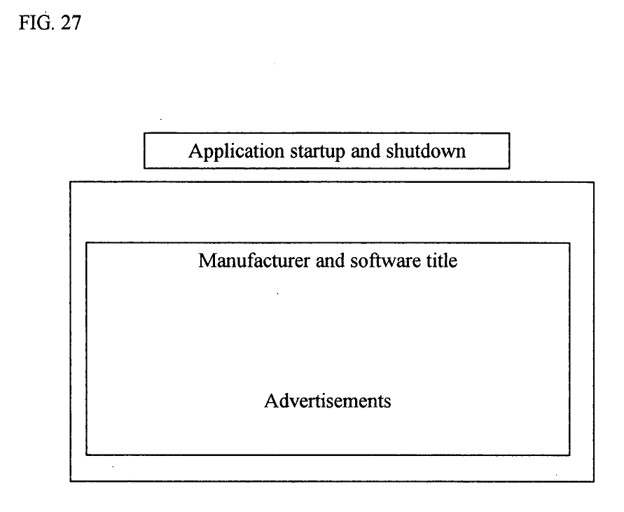

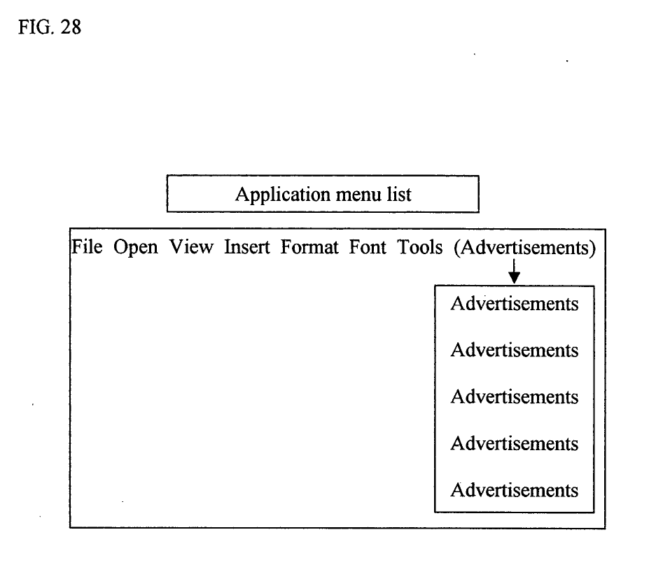

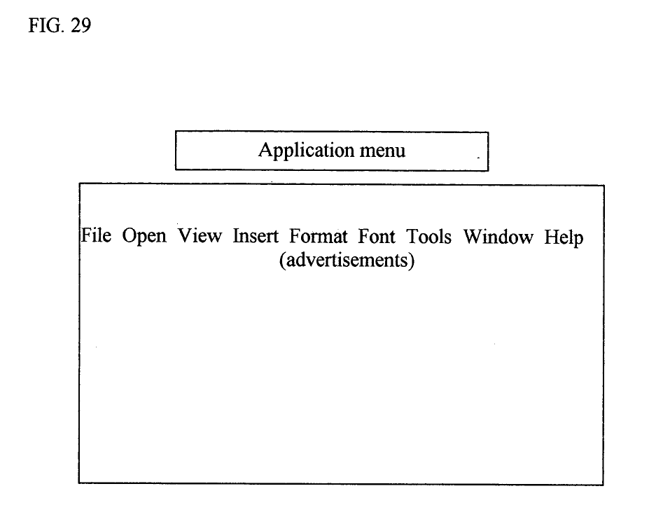

As shown in FIGS. 21-29, Advertising Via Software is a software process and method, through which advertisements are transmitted to and are displayed in software applications, while those software applications, being utilized by users, are performing specific functions. Referring to FIG. 22, as an illustration, when a user initially downloads an application at any and all times during which the installation process is being performed, specific advertisements are programmed to appear during particular times during such installation process, such that the user can communicate via any current or future technologies, including for example, clicking on an advertisement or the selecting of such advertisement, whereupon the application stores a message to display such advertisement for the user after the user has exited the installation process (or at anytime the user selects an option available resulting in such advertisement to appear during such installation process). When the user exits the installation process such advertisement(s) re-appear. If the user's computer is interconnected to the RAN global network 108 or any other network, the user can select such advertisement. A message is transmitted to display the enterprise or consumer site associated with such advertisement, via such display, as part of the display device 103, interconnected to the computer device 104, via the computer device 104, interconnected to a server 107, via the server 107, interconnected to the RAN global network 108, via the RAN global network 108 and/or external network(s) 139, interconnected to the enterprise or consumer site 131, which transmits a message back, via the server 107, via the RAN global network 108 and/or the external network(s) 139, via the server 107, via the computer device 104, via the display device 103, which displays the enterprise or consumer site 131, whereupon the user can perform any activities available at such site.

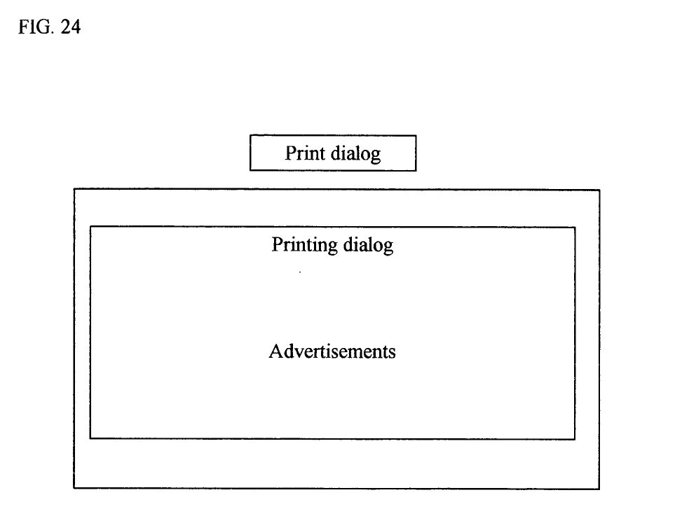

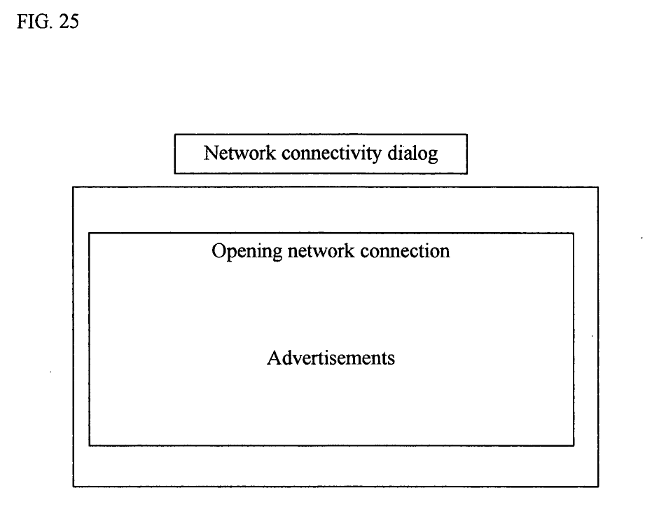

Analogously, at any other time at or during which such application is performing a specific function, e.g., referring to FIGS. 25-29 retrieving/opening or closing a file or functionality, or another application; referring to FIG. 24 printing; running a procedure/macro/etc.; etc. such application displays specific advertisements, which the user can choose to have re-appear at any other time while utilizing such application, including just before or just after closing such application or at any particular time or frequency in the future, whereupon such application stores such advertisement and displays it for the user at the time(s) and frequency requested by the user.

Also, at any time, whether during the operation of such application or any other application, or any time while the computer device 104 is able to receive such communication, the user can communicate with the computer device 104 to display or print the advertisement.

Also, whenever the user communicates for the advertisement to be displayed at any other time than when the advertisement first appears, when the user's computer is interconnected with the RAN global network 108, a message is transmitted, via the display, as part of the display device 103, interconnected to the computer device 104, via the computer device 104, interconnected to a server 107, via the server 107, interconnected to the RAN global network 108, via the RAN global network 108.

The RAN global network 108 is interconnected to the RAN Transactions Data Base 109. The RAN Transactions Data Base 109 records data concerning various attributes of the user transaction, such as, concerning the identification of the user, identification of the user's enterprise if applicable, application activated by the user, the identifier of the computer device 104 utilized by the user, the position of the display/computer device 104 being utilized by the user if applicable, in the case, e.g., of a MARC Terminal 101A with multiple displays, the time that the application was activated by such user, the identification of each advertisement selected for redisplay, the time at which each advertisement was selected for redisplay, and each time in future for which redisplay was selected, and in the case of an initial event in a transaction, the time of the initiation of the transaction by the user, etc.

The RAN global network 108 can also transmit appropriate data such as that recorded to the RAN Transactions Data Base 109, to the external network(s)/data base(s) of the enterprise entity or consumer entity 131 associated with such advertisement.

Alternatively, the application stores the information to be recorded until the next time such computer device 104 is interconnected to the RAN global network 108, at which time such information is transmitted to and recorded in the RAN Transactions Data Base 109.

Also, via the RAN global network 108 and/or other network(s) of the enterprise entity or consumer entity 131 of such advertisement, the RAN Advertising Via Software Data Base 130 or other data base(s) can refresh the advertisements in such application of said user at periodic or any time intervals.

Also, the user application can be pre-scheduled automatically to terminate, i.e., to cease functioning, after the lapse of some time interval, unless the user updates the version of the software and/or advertisement(s) that the user is utilizing. Notification(s) of impending termination of such application's operability can be provided one or more times to the user in advance of such termination. Whenever the RAN global network 108 performs the functions of notifying the user of impending termination of such application's operability, such network(s)/data base(s) of the enterprise entity or consumer entity 130 of such advertisement(s) will have transmitted such advertisement(s) and other relevant information to the RAN Advertising Via Software Data Base 130.

Further, the ‘cursor’ 103A (appearing in screen display 103 and able to be manipulated by the user via a device such as a keyboard, mouse, ball, or any other current or future technologies), whether at rest and/or in motion, can display the advertisements, at anytime such screen display 103 is active, including when the cursor 103A is in a ‘waiting’ state, while the computer device 104 and/or the software applications are performing any functionalities.

If any user's computer is interconnected to the global network or any other network, the user can select the advertisement, whereupon the user computer device and display displays the enterprise or consumer site associated with such advertisement, whereupon the user can perform any activities available at such site.

True View

From a Trucker's (or any driver's perspective), True View is a video screen (which can incorporate sound) to which he or she has convenient visual access, providing a real-time, dynamic view, covering all angles and relative position of vehicles/people/objects around the truck or vehicle. Depending on the type of vehicle and vehicle use the driver may have the option of viewing one or more alternative objects from a realistically scaled three-dimensional representation of other moving vehicles, persons or other objects to geometric symbols, or any manner of relational trigger mechanisms. The screen the driver views is linked to video or sensing devices distributed throughout the vehicle. Depending on whether the vehicle is in motion or stationary, various additional multimedia communications functions could be installed for access to the home or branch office, business clients (e.g., where he or she is scheduled to make a delivery or pick up), other drivers, law enforcement, emergency services, family, and the full range of RAN activities.

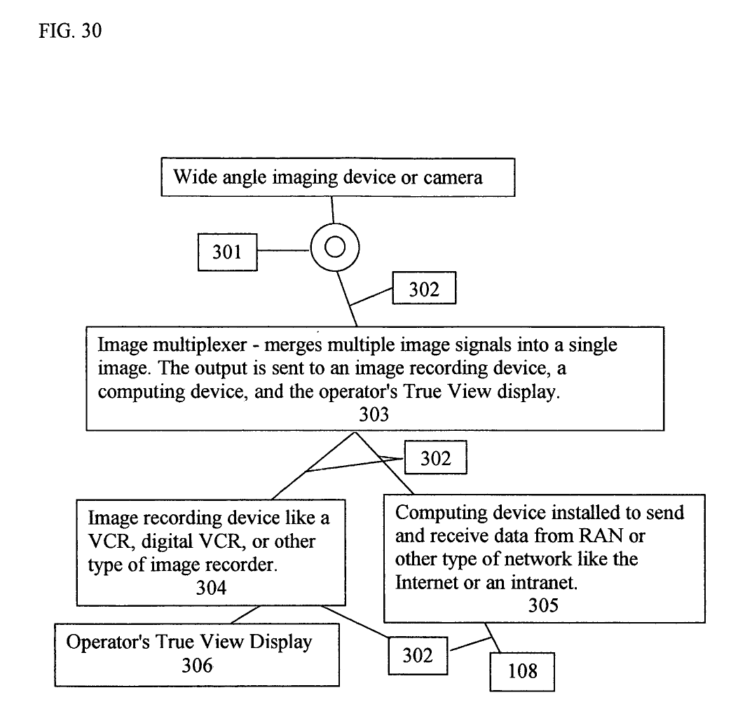

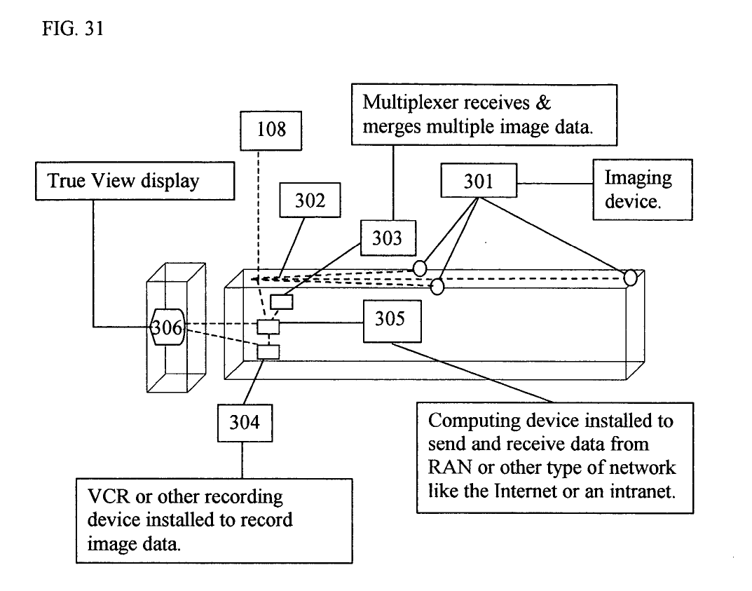

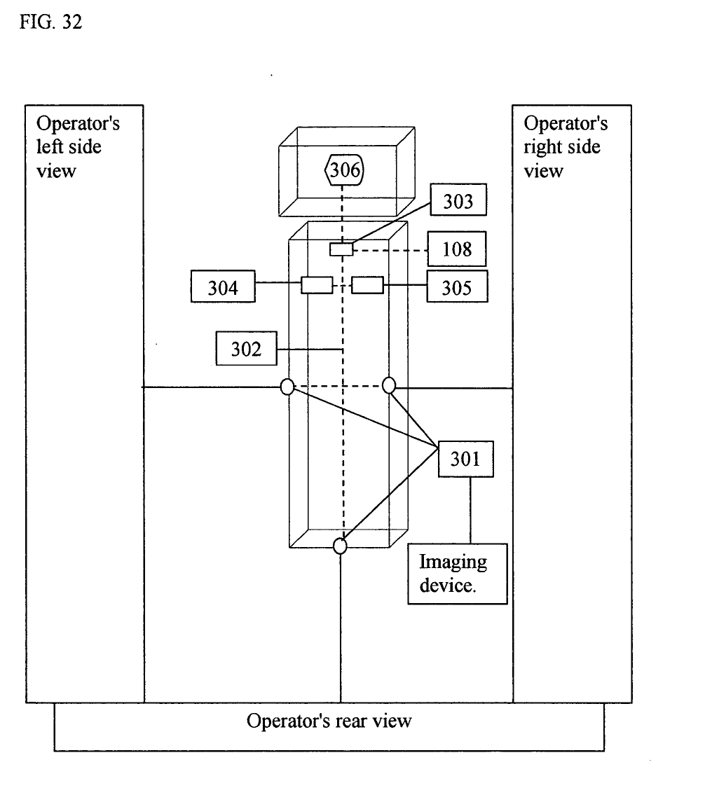

As shown FIG. 30, and additionally from a ‘side view’ in FIG. 31 and a ‘top view’ in FIG. 32, the True View is a system, installed in a motor vehicle, including several devices 301, utilizing any current or future technologies, over some time period, which capture moving images and sounds, emanating from an area for some distance around the external perimeter of a motor vehicle (whether such vehicle is moving or stationary), such as a truck.

Capture devices 301, interconnected to any current or future images and sound transmission technologies 302, transmit the images and sounds from several locations around the perimeter of the vehicle via the transmission technology, interconnected to a device 303, for processing and integrating the images and sounds, utilizing any current for future technologies, to such device 303, which processes and integrates the images and sounds, including multiplexing technologies.

The processing and integrating device 303, interconnected to the transmission technology 302, transmits the processed and integrated images and sounds via the transmission technology, interconnected to a display device 306, utilizing any current or future technologies, to the display device 306, which display device 306 communicates the processed and integrated images and sounds (in any number of alternate representations) for the motor vehicle operator.

The processing and integrating device 303, interconnected to the transmission technology 302, transmits the processed and integrated images and sounds via the transmission technology 302, interconnected to a device 304, for recording and storing, utilizing any current or future technologies, the images and sounds for retrieval, utilizing any current or future technologies, at some other time, to the device 304, which records and stores the processed and integrated images and sounds.

At any time the motor vehicle operator, or any other person (with access to the True View system within the motor vehicle), utilizing the display 306, interconnected to the transmission technology 302, interconnected to a computer device 305, interconnected to the transmission technology 302, interconnected to the recording and storing device 304, and which computer device 305, interconnected to any network, including the RAN global network 108, can transmit a message via the display 306 (with options allowing the user to select, according to any number of parameters, any of the recorded and stored information or segment of the information), via the transmission technology 302, via the computer device 305, via the transmission technology 302, via the recording and storing device 304, via the transmission technology 302, via the computer device 305, via the network, including the RAN global network 108, to communicate the recorded and stored images and sounds, and any other information, to one or more authorized entities, interconnected to the network, including the RAN global network 108, and such that at any time any authorized user at any such authorized entity, interconnected to the network, including the RAN global network 108, can transmit a message to retrieve the recorded and stored images and sounds, and any other information, from the motor vehicle, back to the entity.

The True View system and apparatus can be interconnected to the RAN global network and the RAN Data Base, providing the vehicle operator (or any other user at any time) with the full spectrum of applications on the global network: when the engine of the vehicle is not in any mode enabling the vehicle operator to move the vehicle; access to the Emergency Services system at any time; communications with other vehicles, personnel/offices of an enterprise(s) of which the vehicle operator is employed or which the vehicle operator owns, personnel/offices of law enforcement or other governmental entities, and other organizational entities for the purpose of conducting communications activities during the moving operation of a vehicle sanctioned by law and regulation.

Universal Software

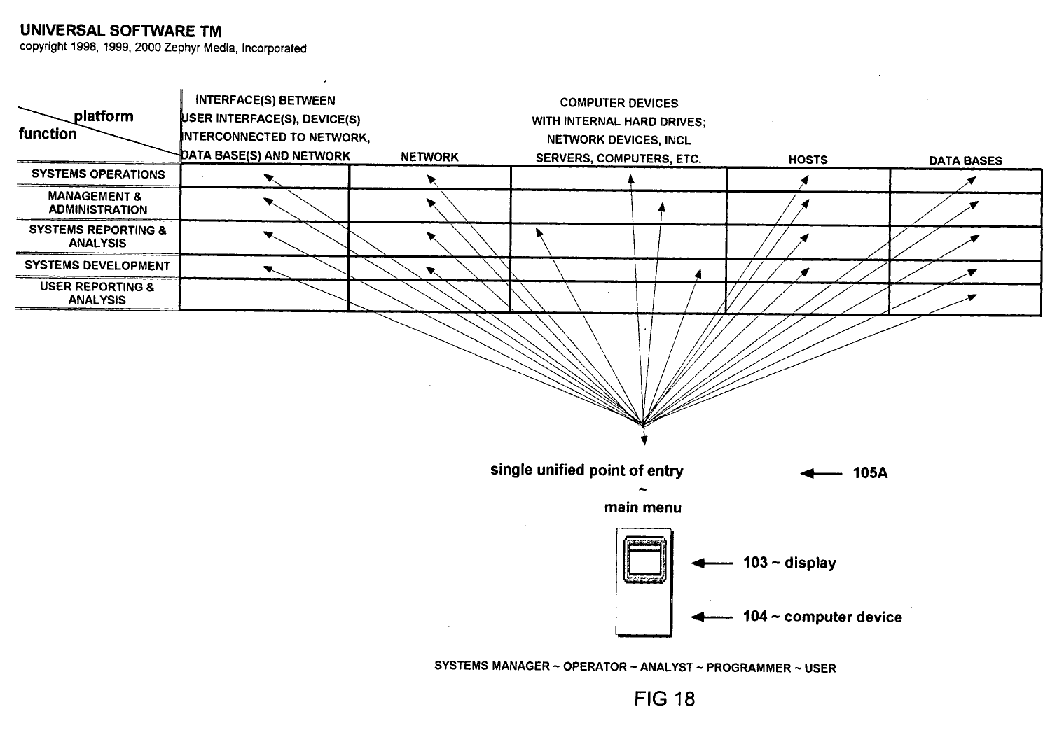

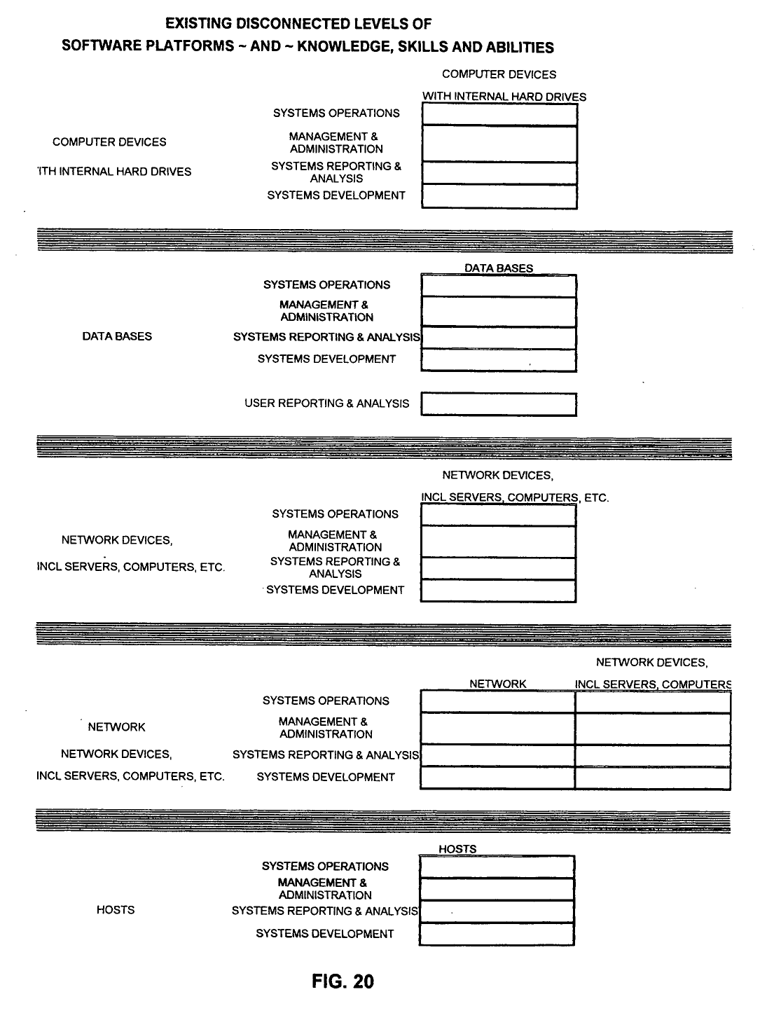

The Universal Software in FIG. 18 stands in stark contrast to the current fragmented state of software operation and management in FIG. 20. In the current state of software, designers, operators and managers of software face a number of different conventions, logics, protocols and styles across the range of software to operate and manage network versions of user applications, network interfaces, network communications and data bases et al. The Universal Software establishes a common set of conventions, logics, protocols, styles et al for all software design, operation and management functions in a unified software application. From any single computer device through a single point of entry a user has access to all of the modules, in their totality comprising the full spectrum of software design, operation and management et al functionalities. Considerable time in learning the accidental traits of software applications can be saved, in that one learning experience for such accidental traits suffices across all software platforms. What remains to be learned is only the specific functional content of each software platform. The extraneous waste of time learning a multiplicity of accidental traits is eliminated.

The Universal Software Platform preferably supports any number, including all of the software functionalities performed in or related to including but not necessarily limited to: support of higher level application(s) utilized directly by users; device(s) interconnected to a network(s); interface(s) between device(s) and a network(s); a network; interface(s) between data base(s) interconnected to a network(s) and such network(s); data base(s) integrated into one software application. The Universal Software can be comprised of several modules corresponding to the each of the various functionalities of the software platform.

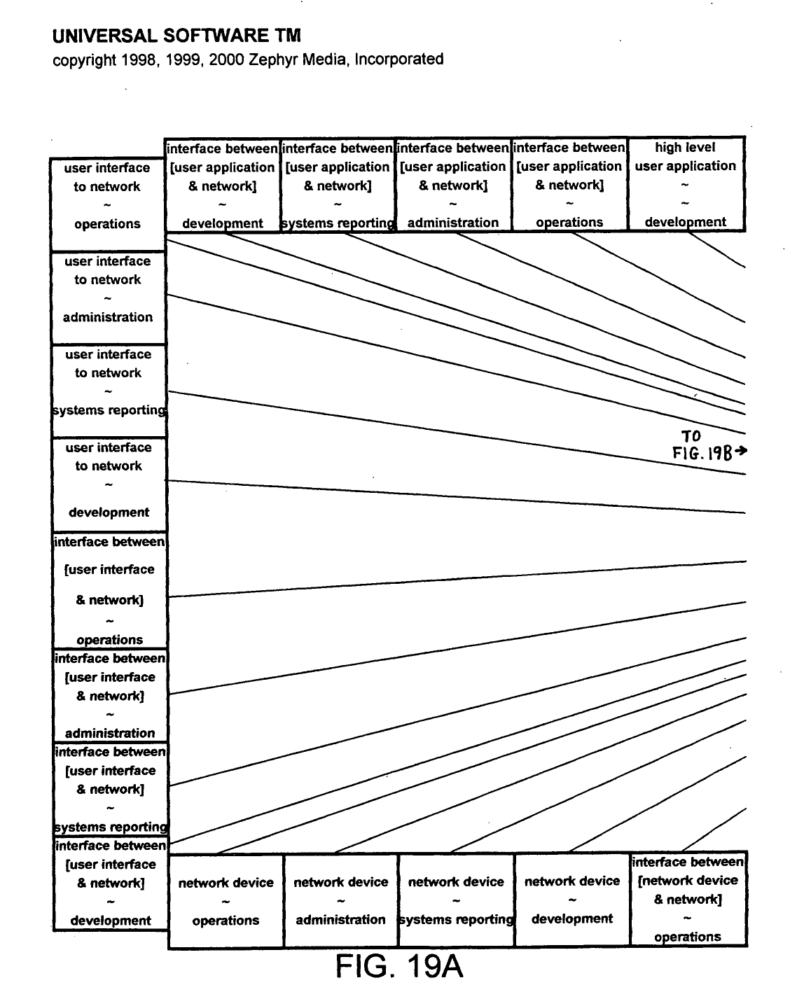

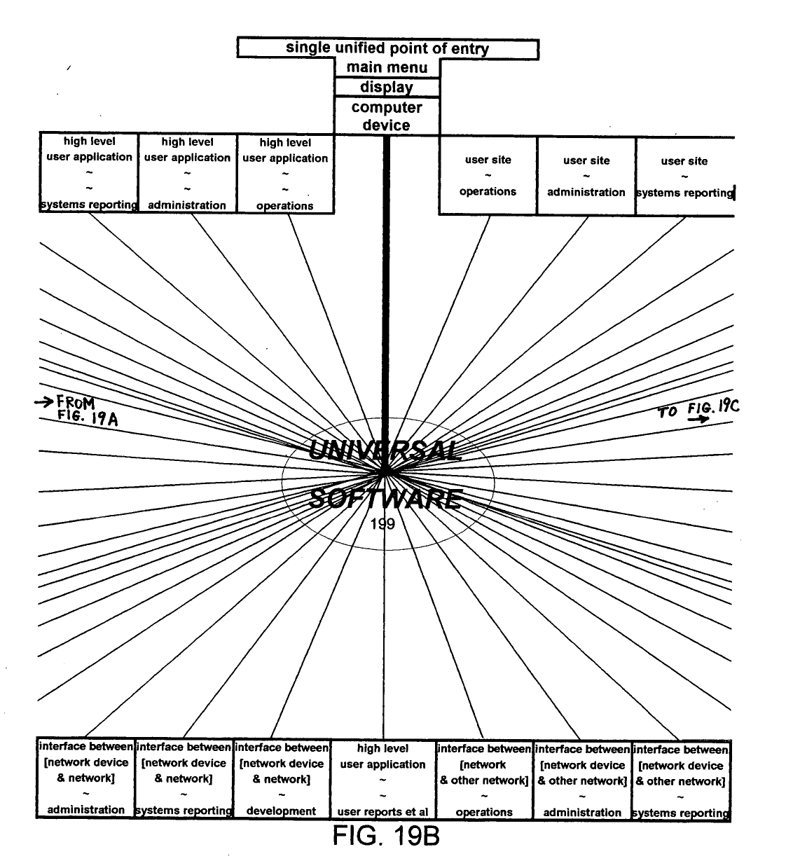

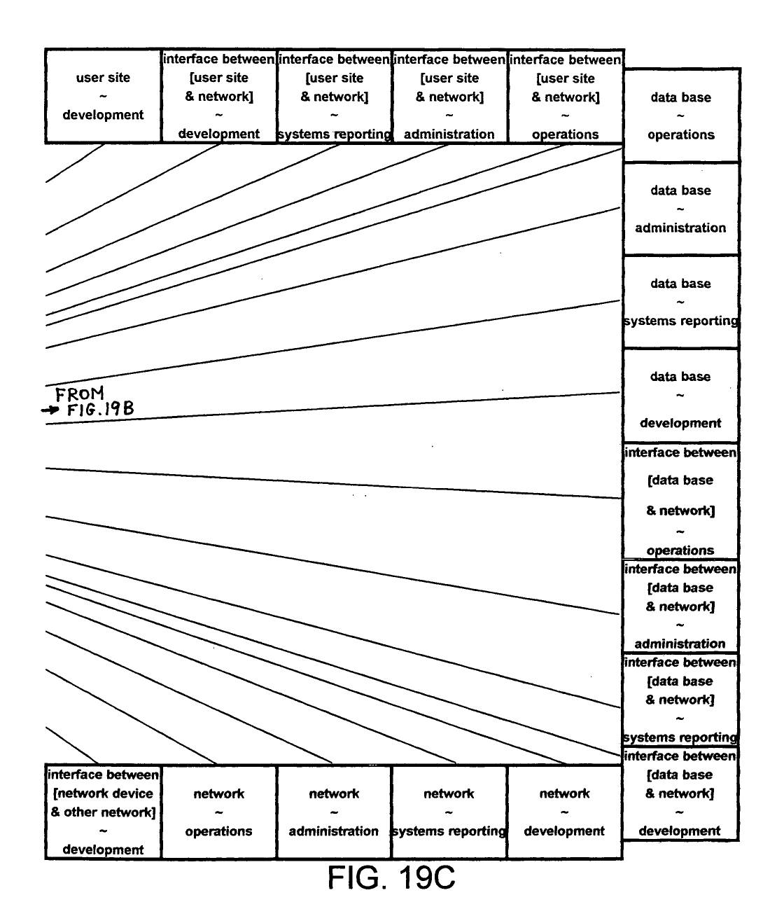

An illustration of the Universal Software platform is shown in FIGS. 19-20. Communications and transactions on the RAN global network 108, and any other network(s) are preferably performed by the Universal Software Platform 199. A Unified Comprehensive Software integrates software functionalities: such as providing, constituting or performing: A) network operations of high level user applications, e.g., spreadsheets, databases, graphics et al; B) user Hypergate interface to RAN Hyperspace, or a browser interface(s) on the Internet; C) stationary or mobile computer device(s) operations; C) operations of device(s) interconnected to a network(s); D) operations of interface(s) between device(s) and a network(s); E) network operations; etc. The Universal Software Platform, (hereafter, ‘Universal Software’), contains, synthesizes and integrates the full spectrum of software functionalities, capable of including, but not necessarily limited to, supporting and/or performing, constituting, executing:
network version(s) of high level user application(s);
user interface(s), comprised of one or more levels within such interface(s), interconnected to any network(s), including the RAN global network;
user site(s), e.g. consumer, enterprise or other types of user site(s), interconnected to any network(s), including the RAN global network, on which any kind of communication, commerce, etc. is conducted;
network devices;
data base(s), etc.;
interface(s) between user interface(s) and network(s); interface(s) between user site(s) and network(s);
interface(s) between network device(s) and network(s);
interface(s) between data base(s) and network(s);
network(s);
interface(s) between network(s) and other network(s);
operation of any number, including all, of network versions of high level user application functionalities, interconnected to any network(s), including the RAN global network; management/administration of the operation of any number, including all, of network versions of high level user application functionalities, interconnected to any network(s), including the RAN global network;
reporting/analysis for system manager/operator/analyst/programmer/etc. on the operation of any number, including all, of network versions of high level user application functionalities, interconnected to any network(s), including the RAN global network;
systems development (including but not necessarily limited to analysis, requirements definition, design, modelling, specification, coding, testing, implementing, etc.) of operation of any number, including all, of network versions of high level user application functionalities, interconnected to any network(s), including the RAN global network;
user (non-management/non-administrative) reporting/analysis utilizing any number, including all, of network versions of high level user application functionalities, interconnected to any network(s), including the RAN global network;
any other functionality of or related to any number, including all, of network versions of high level user application functionalities, interconnected to any network(s), including the RAN global network;
operation of any number, including all, of the interface(s) between user application(s) and network(s);
management/administration of the operation of any number, including all, of the interface(s) between user application(s) and network(s);
reporting/analysis for system manager/operator/analyst/programmer/etc. on the operation of any number, including all, of the interface(s) between user application(s) and network(s);
systems development, including but not necessarily limited to analysis, requirements definition, design, modelling, specification, coding, testing, implementing, etc., of any number, including all, of the interface(s) between user application(s) and network(s);
any other functionality of or related to any number, including all, of the interface(s) between user application(s) and the network(s);
operation of any number, including all, of the user interface(s), interconnected to any network(s), including the RAN global network;
management/administration of any number, including all, of the user interface(s), interconnected to any network(s), including the RAN global network;
reporting/analysis for system manager/operator/analyst/programmer/etc. of any number, including all, of the user interface(s), interconnected to any network(s), including the RAN global network;
systems development, including but not necessarily limited to analysis, requirements definition, design, modelling, specification, coding, testing, implementing, etc., of any number, including all, of the user interface(s), interconnected to any network(s), including the RAN global network;
any other functionality of or related to any number, including all, of the user interface(s), interconnected to any network(s), including the RAN global network;
operation of any number, including all, of the interface(s) between user interface to/from any network(s), including the RAN global network and network(s);
management/administration of the operation of any number, including all, of the interface(s) between user interface to/from any network(s), including the RAN global network and network(s);
reporting/analysis for system manager/operator/analyst/programmer/etc. on the operation of any number, including all, of the interface(s) between user interface to/from any network(s), including the RAN global network and network(s);
systems development (including but not necessarily limited to analysis, requirements definition, design, modelling, specification, coding, testing, implementing, etc.) of any number, including all, of the interface(s) between user interface to/from any network(s), including the RAN global network and network(s);
any other functionality of or related to any number, including all, of the interface(s) between user interface to/from any network(s), including the RAN global network and network(s);
operation of any number, including all, of user site(s), interconnected to any network(s), including the RAN global network;
management/administration of any number, including all, of user site(s), interconnected to any network(s), including the RAN global network;
reporting/analysis for system manager/operator/analyst/programmer/etc. of any number, including all, of user site(s), interconnected to any network(s), including the RAN global network;
systems development (including but not necessarily limited to analysis, requirements definition, design, modelling, specification, coding, testing, implementing, etc.) of any number, including all, of user site(s), interconnected to any network(s), including the RAN global network;
any other functionality of or related to any number, including all, of user site(s), interconnected to any network(s), including the RAN global network;
operation of any number, including all, of the interface(s) between user site(s) and network(s);
management/administration of the operation of any number, including all, of the interface(s) between user site(s) and network(s);
reporting/analysis for system manager/operator/analyst/programmer/etc. on the operation of any number, including all, of the interface(s) between user site(s) and network(s);
systems development (including but not necessarily limited to analysis, requirements definition, design, modelling, specification, coding, testing, implementing, etc.) of any number, including all, of the interface(s) between user site(s) and network(s);
any other functionality of or related to any number, including all, of the interface(s) between user site(s) and network(s);
operation of any number, including all, of the device(s) interconnected to the network(s);
management/administration of the operation of any number, including all, of the device(s) interconnected to the network(s);
reporting/analysis for system manager/operator/analyst/programmer/etc. on any number, including all, of the device(s) interconnected to the network(s);
systems development (including but not necessarily limited to analysis, requirements definition, design, modelling, specification, coding, testing, implementing, etc.) of any number, including all, of the device(s) interconnected to the network(s);
any other functionality of or related to any number, including all, of the device(s) interconnected to the network(s);
operation of any number, including all, of the interface(s) between any network(s), including the RAN global network, and any device(s) interconnected to the network(s);
management/administration of the operation of any number, including all, of the interface(s) between any network(s), including the RAN global network, and any device(s) interconnected to the network(s);
reporting/analysis for system manager/operator/analyst/programmer/etc. on the operation of any number, including all, of the interface(s) between any network(s), including the RAN global network, and any device(s) interconnected to the network(s);
systems development (including but not necessarily limited to analysis, requirements definition, design, modelling, specification, coding, testing, implementing, etc.) of any number, including all, of the interface(s) between any network(s), including the RAN global network, and any device(s) interconnected to the network(s);
any other functionality of or related to any number, including all, of the interface(s) between any network(s), including the RAN global network, and any device(s) interconnected to the network(s);
operation of any number, including all, of the data base(s) interconnected to any network(s), including the RAN global network;
management/administration of the operation of any number, including all, of the data base(s) interconnected to any network(s), including the RAN global network;
reporting/analysis for system manager/operator/analyst/programmer/etc. on the operation of any number, including all, of the data base(s) interconnected to any network(s), including the RAN global network;
systems development (including but not necessarily limited to analysis, requirements definition, design, modelling, specification, coding, testing, implementing, etc. of operation of any number, including all, of the data base(s) interconnected to any network(s), including the RAN global network;
user (non-management/non-administrative) reporting/analysis utilizing any number, including all, of the data base(s) interconnected to any network(s), including the RAN global network;
any other functionality of or related to any number, including all, of the data base(s) interconnected to any network(s), including the RAN global network;
operation of the interface(s) between any network(s), including the RAN global network, and any data base(s) interconnected to the network(s);
management/administration of the operation of the interface(s) between any network(s), including the RAN global network, and any data base(s) interconnected to the network(s);
reporting/analysis for system manager/operator/analyst/programmer/etc. on the operation of the interface(s) between any network(s), including the RAN global network, and any data base(s) interconnected to the network(s);
systems development (including but not necessarily limited to analysis, requirements definition, design, modelling, specification, coding, testing, implementing, etc.) of the interface(s) between any network(s), including the RAN global network, and any data base(s) interconnected to the network(s);
any other functionality of or related to the interface(s) between any network(s), including the RAN global network, and any data base(s) interconnected to the network(s);
operation of any number, including all, of the network(s) supporting the operating software/hardware of any number, including all, of the device(s) interconnected to the network(s);
management/administration of the operation of any number, including all, of the network(s) supporting the operating software/hardware of any number, including all, of the device(s) interconnected to the network(s);
reporting/analysis for system manager/operator/analyst/programmer/etc. on the operation of any number, including all, of the network(s) supporting the operating software/hardware of any number, including all, of the device(s) interconnected to the network(s);
systems development (including but not necessarily limited to analysis, requirements definition, design, modelling, specification, coding, testing, implementing, etc.) of any number, including all, of the network(s) supporting the operating software/hardware of any number, including all, of the device(s) interconnected to the network(s);
any other functionality of or related to any number, including all, of he network(s) supporting the operating software/hardware of any number, including all, of the device(s) interconnected to the network(s);
operation of the interface(s) between network(s), including the RAN global network, and any other network(s);
management/administration of the operation of the interface(s) between network(s), including the RAN global network, and any other network(s);
reporting/analysis for system manager/operator/analyst/programmer/etc. on the operation of the interface(s) between network(s), including the RAN global network, and any other network(s);
systems development (including but not necessarily limited to analysis, requirements definition, design, modelling, specification, coding, testing, implementing, etc.) of the interface(s) between network(s), including the RAN global network, and any other network(s);
any other functionality of or related to the interface(s) between network(s), including the RAN global network, and any other network(s);

As an illustration, when a systems manager, administrator, operator, analyst, programmer or other kind of user, etc. (hereafter, “user”) initially communicates a message to open a session in the Universal Software via any current or future technologies, including via the display, interconnected to the display device 103, to the display device 103, via the display device 103, interconnected to the computer devices 104, to the computer devices 104, via the computer devices 104, interconnected to the RAN global network 108, to the RAN global network 108, via the RAN global network 108, interconnected to the Universal Software, to the Universal Software, which Universal Software transmits a message back, via the RAN global network 108, via the computer device 104, via the display device 10, via the display, which displays the Universal Software Main Menu for the user and constitutes a single unified point of entry, as shown in FIG. 19, to the totality of the functionalities in the Universal Software.

The main menu preferably contains, as options, each of the set of functionalities (e.g., modules) in the Universal Software, whereupon when the user selects an option via any current or future technologies, including via the display, the display, interconnected to the display device 103, to the display device 103, via the display device 103, interconnected to the computer devices 104, to the computer devices 104, via the computer devices 104, interconnected to the RAN global network 108, to the RAN global network 108, via the RAN global network 108, interconnected to the Universal Software, to the Universal Software, which Universal Software transmits a message back, via the RAN global network 108, via the computer device 104, via said display device 10, via such display, which displays the initial Universal Software Menu for such option selected by the user. The user is preferably able to utilize the functionalities in such option.

Analogous to the verification/validation of personal and/or enterprise identity of the user, illustrated in the Personal option via the RAN Hypergate Menu, presented above, of the Preferred Embodiment, security provisions concerning any user access to any one or more, or all, of such functionalities or any one or more, or all levels within such functionalities, are able to be incorporated into the Universal Software.

As a further illustration, when a user has accessed and is utilizing a particular functionality within the Universal Software, the user with any display within the Universal Software currently present to the user at any time can select an option to record the user's commands, statistics and any other kind of information concerning the user's session in such functionality, such that the user has continuous ability to access, e.g., see, read, edit, etc., such information, while utilizing such functionality within the Universal Software, or to access any other functionality, which the user utilized at any previous time.

The user with any display within the Universal Software currently present to the user at any time also can select an option to save the information in the user's personal and/or enterprise account, e.g., on the RAN global network (as illustrated in numerous sections above) or any other file or any other network or computer device, for future use by the user or some other user(s) after the user's current session in the Universal Software is concluded.

Moreover, the user with any display within the Universal Software currently present to the user at any time can select an option to continue or discontinue the user's access to such information recorded in any functionality, even after the user has exited said functionality and entered another functionality other than functionality.

The user with any display within the Universal Software currently present to the user at any time can select an option to continue or discontinue such accumulation of the totality or any lesser set of such information from one functionality to another, throughout the totality of the duration of the user's current session in the Universal Software.

Streamlined Initial Access

RAN has a streamlined process for users, whether consumers or enterprises to gain initial access to the RAN System. A consumer can contact RAN via a communications device, such as a telephone or computer, for example, using a toll free number, and RAN can automatically complete the remaining steps.

A message explains:
1) that in order to gain automatic access to RAN, that the consumer only has to punch in (or if preferred, to speak over the telephone to a live representative) the numbers or other information identifying that consumer's computer, e.g., that computer's address on the network of the public telecommunications carrier which services that consumer's computer;
2) the RAN System will then A) automatically install access to the RAN applications onto that consumer's computer, B) automatically restart that consumer's computer if required, C) and automatically display access for that consumer, e.g., as a RAN icon on that consumer's display interconnected to that consumer's computer,
3) and any other useful information, (e.g., that that consumer needs to leave in an active status his or her computer, modem or any other communications device, telephone or any other kind of media line, and any other appropriate device or media, etc.).

When access to RAN is provided, the consumer can select RAN, (e.g., by clicking or double clicking on the RAN icon), at which point the RAN Main Hypergate Menu is displayed for the consumer, who can enter RAN Hyperspace.

Enterprises have a similar streamlined process for initial access, which may also be accompanied by a registration process for enterprises.

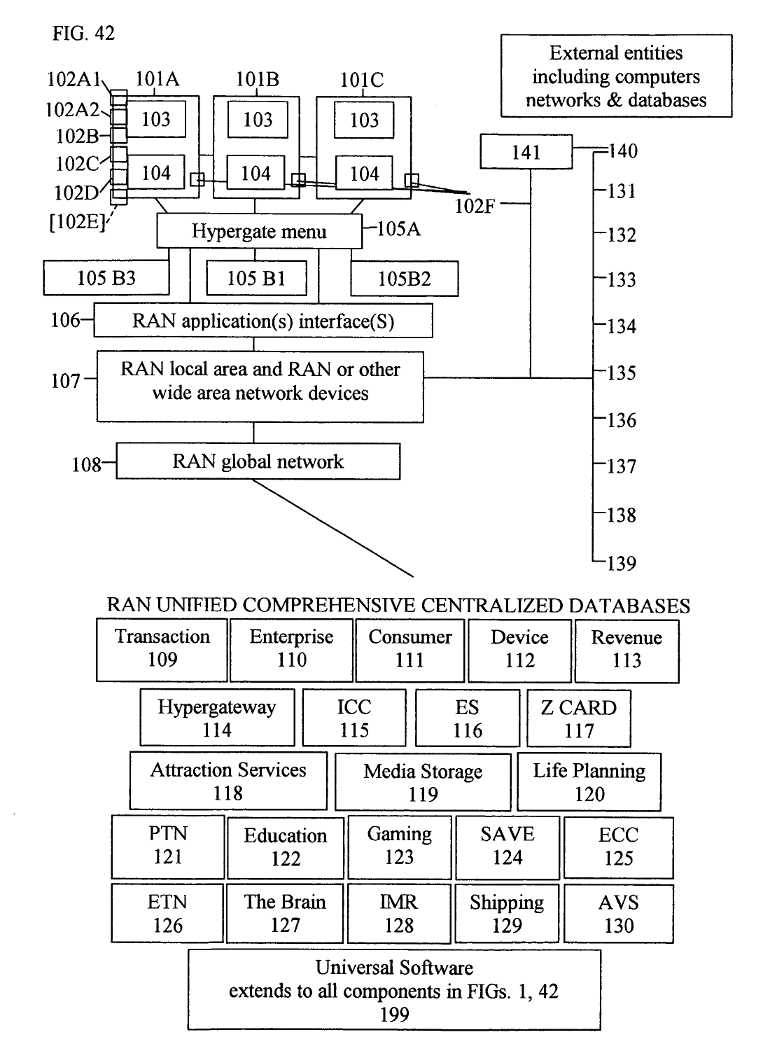

As an illustration, referring to FIG. 42, any user (e.g., consumer or enterprise, as referred to elsewhere, et al.) contacts the entity responsible for the RAN System by utilizing a communication device 102F1, (e.g., a telephone or display screen 103 or any other current or future technology), interconnected to the user's computer 103, and enters the minimum (or any other) set of characters, e.g., alpha, numeric, etc. required by the user's own computer 104, 131 and/or network 131, in order for the RAN System to identify and locate that user's computer 104, 131, including on the user's own network(s) 131 and/or any other or additional network(s), including the network(s) of common public telecommunications carrier(s) 140), utilizing the communication device 102F1, e.g., a telephone or display screen 103 (or any other current or future technology) interconnected to the user's computer 103 (or any other current or future technology) and, for example, a user's communications device 102F2, such as a modem (or any other corresponding current or future technology). Whereupon the public telecommunications network 140, interconnected to the RAN network 107, transmits a message via the RAN network 107 to the RAN Device Data Base 112, which records the identity and location of the user's computer, and any additional information, and to the RAN System.

The RAN System transmits a message back via the Ran Network 107, via the public telecommunications network 140 via the user's communication device(s) 102F1, 102F2, e.g., telephone and modem (or any other current or future configuration of corresponding technologies) to the user's computer 104.

The message results in the A) automatic installation of the RAN applications onto the user's computer 104, B) the automatic restart of the user's computer 104, and C) the automatic communication for the user of access to RAN Hyperspace, e.g., via the user's display 103 (or any other current or future technology) in the form of a RAN icon. When the user selects access to RAN Hyperspace, (e.g., by clicking or double-clicking on said RAN icon or any other current or future technology, the RAN System preferably displays the RAN Hypergate Menu Display 105A (see also FIG. 3), which constitutes the single unified integrated point of entry to the totality of RAN Hyperspace throughout the RAN System, as is comprised of any number of options, but for the sake of example: option A) Public; option B) Distinguished; option C) Personal; option D) Enterprise, and records data concerning various attributes of the user transaction to the RAN Transactions Data Base 109.

If a user selects, the user can also communicate the required minimum (or other) information to a live representative of the entity responsible for the RAN System, which live representative or automated system can initiate the automatic process for providing the user with access to RAN Hyperspace.

As a further illustration, any enterprise 140, e.g., represented by the enterprise's systems manager, contacts the entity responsible for the RAN System by utilizing a communication device 140, e.g., a telephone or display screen or any other current or future technology) interconnected to the systems manager's computer 140 or host or server, etc., (or any other current or future technology), and enters the minimum (or any other) set of characters, e.g., alpha, numeric, etc. (required by any set of the enterprise's own computer(s) 140 and/or network(s) 140, in order for the RAN System to identify and locate that enterprise's computer(s) 140, on the enterprise's own network(s) 140 and/or any other or additional network(s), including the network(s) of common public telecommunications carrier(s) 141, utilizing the communication device 140, e.g., a telephone or display screen (or any other current or future technology) interconnected to the user's computer 140 (or any other current or future technology) and, for example, a user's communications device 140, said as a modem (or any other corresponding current or future technology), and communicates any other information required as a matter of policy during a registration process for enterprises, and/or with a live representative of the entity responsible for the RAN System or any other process (or any other current or future technologies).

The public telecommunications network 141, interconnected to the RAN network 107, transmits a message via the RAN network 107 to the RAN Device Data Base 112, which records the identity and location of each of the enterprise's computer(s), and any additional information, and to the RAN Enterprise Data Base 110, which records the information from the registration process communicated by the user to the user's file to the and to the RAN System.

The RAN system transmits a message back via the Ran Network 107, via the public telecommunications network 141, via the enterprise's computer(s) 141, which message results in the A) automatic installation of the RAN applications onto the enterprise's computer(s) 140, B) the automatic restart of the user's computer 104, and C) the automatic communication for the user of access to RAN Hyperspace, e.g., via the user's display 103 (or any other current or future technology) in the form of a RAN icon, or the automatic installation onto the enterprise's own or any other host(s)/server(s)/network(s)/etc. 140 of the ability for the enterprise's own or any other host(s)/server(s)/network(s)/etc. 140 to perform an automatic installation of the RAN applications onto the enterprise's computer(s) 140.

When any member of the enterprise 140 selects access to RAN Hyperspace, e.g., by clicking or double-clicking on the RAN icon (or any other current or future technology), the RAN System preferably displays for the member the RAN Hypergate Menu Display 105A (also FIG. 3), which constitutes the single unified integrated point of entry to the totality of RAN Hyperspace throughout the RAN System, and is comprised of any number of options, but for the sake of example: option A) Public; option B) Distinguished; option C) Personal; option D) Enterprise, and records data concerning various attributes of the user transaction to the RAN Transactions Data Base 109.

Streamlined Initial Access

RAN has a streamlined process for users, whether consumers or enterprises to gain initial access to the RAN System. A consumer can contact RAN via a communications device, such as a telephone or computer, for example, using a toll free number, and RAN can automatically complete the remaining steps.

A message explains:
1) that in order to gain automatic access to RAN, that the consumer only has to punch in (or if preferred, to speak over the telephone to a live representative) the numbers (or other information) identifying that consumer's computer, e.g., that computer's address on the network of the public telecommunications carrier which services that consumer's computer;
2) the RAN System will then A) automatically install access to the RAN applications onto that consumer's computer, B) automatically restart that consumer's computer (if required), C) and automatically display access for that consumer, e.g., as a RAN icon on that consumer's display (interconnected to that consumer's computer);
3) and any other useful information, (e.g., that that consumer needs to leave in an active status his or her computer, modem or any other communications device), telephone (or any other kind of media) line, and any other appropriate device or media, etc.

Then, when access to RAN is provided, the consumer can select RAN, (e.g., by clicking or double clicking on the RAN icon), at which point the RAN Main Hypergate Menu is displayed for the consumer, who can enter RAN Hyperspace.

Enterprises have a similar streamlined process for initial access, which may also be accompanied by a registration process for enterprises.

As an illustration, referring to FIG. 42, any user (e.g., consumer or enterprise, as referred to elsewhere, et al.) contacts the entity responsible for the RAN System by utilizing a communication device 102F, (e.g., a telephone or display screen 103 or any other current or future technology) interconnected to the user's computer 103 (or any other current or future technology), and enters the minimum (or any other) set of characters, e.g., alpha, numeric, etc. required by said user's own computer 104, 131 and/or network 131, in order for the RAN System to identify and locate that user's computer 104, 131, including on the user's own network(s) 131 and/or any other or additional network(s), including the network(s) of common public telecommunications carrier(s) 140, utilizing the communication device 102F, e.g., a telephone or display screen 103 (or any other current or future technology) interconnected to the user's computer 103 (or any other current or future technology) and, for example, a user's communications device 102F, such as a modem (or any other corresponding current or future technology). Whereupon the public telecommunications network 140, interconnected to the RAN network 107, transmits a message via the RAN network 107 to the RAN Device Data Base 112, which records the identity and location of said user's computer, and any additional information, and to the RAN System.

The RAN System transmits a message back via the Ran global network 107 via the public telecommunications network 140 via the user's communication device(s) 102F, e.g., telephone and modem (or any other current or future configuration of corresponding technologies) to the user's computer 104.

The message results in the A) automatic installation of the RAN applications onto the user's computer 104, B) the automatic restart of the user's computer 104, and C) the automatic communication for the user of access to RAN Hyperspace, e.g., via the user's display 103 (or any other current or future technology) in the form of a RAN icon, when the user selects access to RAN Hyperspace, e.g., by clicking or double-clicking on the RAN icon (or any other current or future technology), the RAN System preferably displays the RAN Hypergate Menu Display 105A (also FIG. 3), which constitutes the single unified integrated point of entry to the totality of RAN Hyperspace throughout the RAN System, as is comprised of any number of options, but for the sake of example: option A) Public; option B) Distinguished; option C) Personal; option D) Enterprise, and records data concerning various attributes of the user transaction to the RAN Transactions Data Base 109.

If a user selects, the user can also communicate the required minimum or other information to a live representative of the entity responsible for the RAN System, which live representative or automated system can initiate the automatic process for providing the user with access to RAN Hyperspace.

As a further illustration, any enterprise 140, e.g. represented by the enterprise's systems manager, contacts the entity responsible for the RAN System by utilizing a communication device 140, e.g., a telephone or display screen (or any other current or future technology) interconnected to the systems manager's computer 140 (or host or server, etc., or any other current or future technology), and enters the minimum (or any other) set of characters, e.g., alpha, numeric, etc. required by any set of said enterprise's own computer(s) 140 and/or network(s) 140, in order for the RAN System to identify and locate that enterprise's computer(s) 140, on the enterprise's own network(s) 140 and/or any other or additional network(s), including the network(s) of common public telecommunications carrier(s) 141], utilizing the communication device 140, e.g., a telephone or display screen (or any other current or future technology) interconnected to the user's computer 140 (or any other current or future technology) and, for example, a user's communications device 140, said as a modem (or any other corresponding current or future technology), and communicates any other information required as a matter of policy during a registration process for enterprises, and/or with a live representative of the entity responsible for the RAN System or any other process (or any other current or future technologies).

The public telecommunications network 141, interconnected to the RAN global network 107, transmits a message via the RAN global network 107 to the RAN Device Data Base 112, which records the identity and location of each of the enterprise's computer(s), and any additional information, and to the RAN Enterprise Data Base 110, which records the information from the registration process communicated by the user to the user's file to the and to the RAN System.

The RAN System transmits a message back via the Ran global network 107 via the public telecommunications network 141 via the enterprise's computer(s) 141, which message results in the A) automatic installation of the RAN applications onto the enterprise's computer(s) 140, B) the automatic restart of the user's computer 104, and C) the automatic communication for the user of access to RAN Hyperspace, e.g., via the user's display 103 (or any other current or future technology) in the form of a RAN icon, or the automatic installation onto the enterprise's own or any other host(s)/server(s)/network(s)/etc. 140 of the ability for the enterprise's own or any other host(s)/server(s)/network(s)/etc. 140 to perform an automatic installation of the RAN applications onto the enterprise's computer(s) 140.

When any member of the enterprise 140 selects access to RAN Hyperspace, e.g., by clicking or double-clicking on the RAN icon (or any other current or future technology), the RAN System preferably displays for the member the RAN Hypergate Menu Display 105A (also FIG. 3), which constitutes the single unified integrated point of entry to the totality of RAN Hyperspace throughout the RAN System, and is comprised of any number of options, but for the sake of example: option A) Public; option B) Distinguished; option C) Personal; option D) Enterprise, and records data concerning various attributes of the user transaction to the RAN Transactions Data Base 109.

Advertising Via Advanced Media Channels Devices

There is an insistent pursuit of alternative higher speed, higher quality advanced media channels for network communications beyond the dial-up copper wire media widely in use today. These alternative communications media include, but are not necessarily limited to: fiber optics; T1, T2, T3, etc.; fragmented T1, DSL, ISDN, MMDS, Ethernet et al.

In general, these higher speed, higher quality media channels entail utilization of ‘communications devices,’ as one example, modems, sometimes externally interconnected to a computer device. These externally interconnected ‘communications devices’ can and do have various three-dimensional physical configurations and shapes.

In one aspect, the present invention is a ‘communications device(s)’ for advanced media channels with physical configurations, such that displays exist on the external surface of the communications device, via which interactive multimedia content (and any other current or future kind of transmitted content and/or media channel) can be experienced by the user of such ‘communication device, interconnected to a network(s), such a RAN, Internet, or any other networks(s).

The market problem is that currently both the ‘communications devices’ and the service fees regularly to access these advanced media channels are very expensive from the perspective of most residential users of network systems, such as the Internet. This system and method of the present invention is preferably designed to enable sponsors, including advertisers, to purchase time for the transmission of their messages, the revenue from which can be used, e.g., by the RAN entity, to underwrite the cost of advanced media channel ‘communications devices’ and service, thus providing such advanced media channel ‘communications devices’ and services for free or for significantly reduced cost.

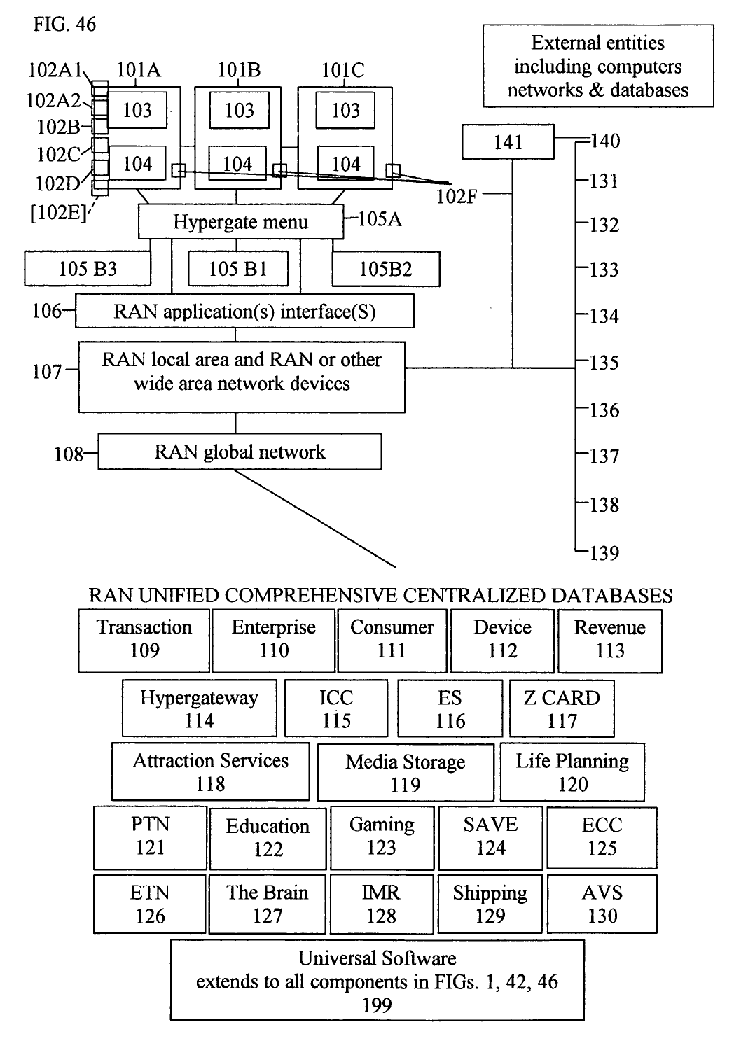

As an illustration, referring to FIG. 46, an external entity, such an enterprise 131 (and/or such enterprise's advertising or other agency(ies)) interconnected to the RAN global network 108, or any other network(s), via the RAN global network 108, interconnected to a server 107, via such server 107, interconnected to such user's ‘communications device(s)’ 102F (for any current or future media channel, including but not limited to: copper wire, fiber optics; T1, T2, T3, etc.; fragmented T1, DSL, ISDN, MMDS, Ethernet et al.), via such ‘communications device(s)’ 102F, transmits via a display 102F (utilizing any current or future technology), as part of or interconnected to such ‘communications device(s)’ 102F (interconnected to such user's computer device(s) 101A, 101B, 101C), a message, for example, in the form of interactive multimedia, for example, of advertisements or any other information.

A user can interact with such message via such display 102F, including being able to enact a transmission via such user's ‘communications device(s) 102F including via such user's computer device(s) 101A, 101B, 101C via the server 107 via the RAN global network 108 (or any other network(s)), interconnected to the RAN Unified Comprehensive Data Base 109 (RAN Data Base, elsewhere) to the RAN Transactions Data Base 109, which records various elements of the transaction(s) associated with such transmission, and via such external entity's network(s) to such external entity 131, which enacts a transmission back via such external entity's network(s) via the RAN global network 108, and any other network(s) to the RAN Data Base 109, which records various elements of the transaction, and via the server 107 to the display 102F, as part of the user's ‘communications device(s)’ 102F, interconnected to the user's computer device 101C.

The external entity's 131 site on the RAN Network, or any other network(s), is displayed for such user, whereupon the user is able to interact with the entity's site and access the full range of functionalities, applications and services on the RAN Network, or any other network(s).

Intelligent Mobile Devices

The current state of mobile devices is fragmentation. Traditional portable devices provide access to radio and may accommodate compact disks (CDs). Cameras are portable. There are portable televisions. Some newer devices provide telephone service. Some devices provide Internet access. Sometimes Internet access and related telephony service may be jointly offered. Nonetheless, none, of the mobile devices on the market today provide for the ‘full’ integration of mobile technologies and services. The suite of mobile devices of an embodiment of the present invention provides the total integration of services and content, absent from the concept, design and functionality from portable devices up to this point in the history of mobile device technology.

The lack of integration means, that a single consumer must purchase, maintain and safeguard multiple devices, in order to benefit from and enjoy the full range of content and services available across the whole telecommunications market. The full integration of content and services on a single unified yet diversified mobile device platform can substantially reduce the overall cost of acquisition and maintenance to consumers.

Moreover, some mobile devices, especially traditional devices, but even some newer devices are not interconnectable with personal computers, local networks or wide area networks. This suite of mobile devices of an embodiment of the present invention has personal computer, and local and wide area network functionality embedded in their inherent concept and design.

Ultimately, it is still the case, that a consumer must give up functionalities, such as radio/CD, of traditional devices, in order to use new devices, or give up new functionalities, such as Internet access, in order to use traditional devices. This suite of mobile devices eliminates such trade-off.

The special aspect of these new mobile devices is that they combine the full spectrum of wireless and wireline communications not just one or a couple wireless functionalities, but ALL. This suite of new mobile devices is a revolution in the intelligent integration of functionality, design and wireless and wireline protocols, enabling a SINGLE device to transmit in any wireless and wireline formats.

Each device is intelligent, compact, convenient, and can be used in virtually any position, on a desk, in a seat next to the user, on the user's lap, slipped in and out of a carrying case, book bag, backpack, pocketbook, et al., in virtually any location, virtually anywhere in the World.

Combine smallness, portability, world-wide network accessibility with information, e-mail, telephony, videphony, entertainment, music, videos, concerts, movies, television, radio, interactive games, electronic commerce smart card use, the full range of RAN services, including Graphical Button Interfaces and Emergency Services, wireless and wireline media, open hardware, software architecture, synchronicity and asynchronicity, large screen, keyboard, DVD/CD, radio tuner, earphones for private listening, built-in state-of-the art audio speakers (detachable with wires or wireless) for open air listening, camera (stored inside with detachable option), portable and with collapsible tripod, storage capacity for writing implements and/or other useful items and laptop personal computer, wide (and local) area network for digital DVD/CD, radio, television, interactive television, satellite communications and any other current or future technology, and you have the Intelligent Boom Box and its companions, and the Intelligent Brief Case, two embodiments of one aspect of the present invention.

In addition, there is the expansion of the Palm Device to a bigger foldout screen for better viewing, interconnected to the full spectrum of RAN Hyperspace (and/or Internet and/or any other network(s)), also equipped with Graphical User Interface Buttons, Palm Device technology taken to the next level, as the Intelligent Communicator.

Each device in the mobile suite constitutes ONE easy-to-carry, easy-to-situate, easy-to-store, light weight cool looking, high speed communications device with the full range of entertainment and information media with the freedom, control, flexibility, security, convenience, pleasure, fun, excitement to communicate business or personal matters, send, utilize, take advantage of information, review products and services, and make intelligent choices, make purchases and have what one desires or needs, and to be entertained and informed through every technological medium available.

Intelligent Boom Box™, The Intelligent Brief Case™, The Intelligent Communicator™

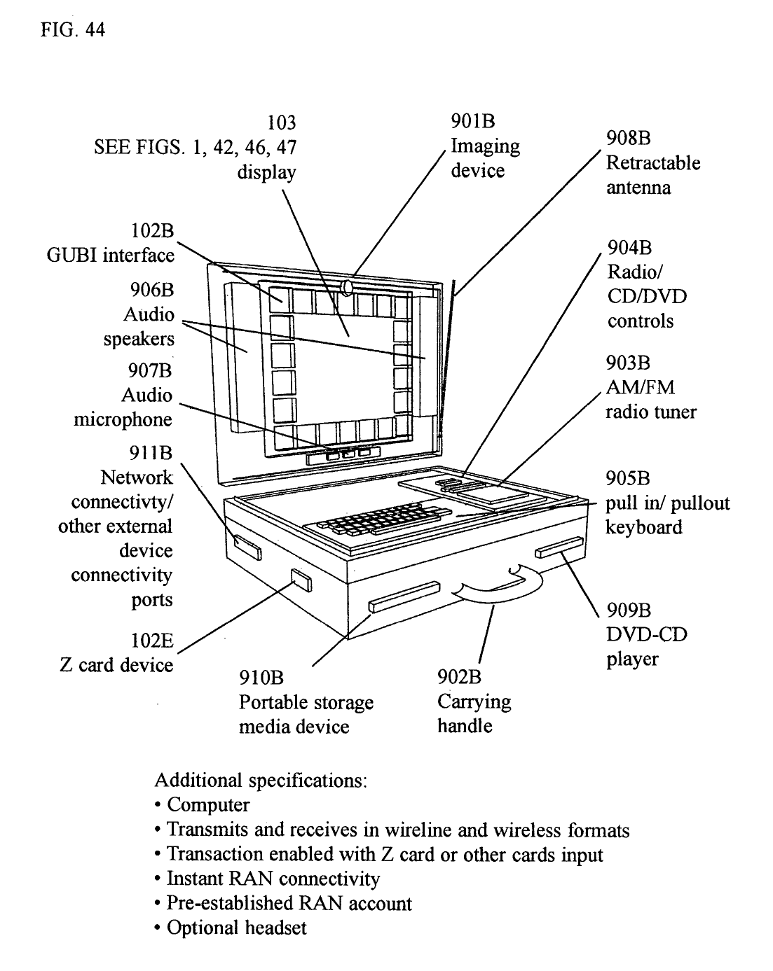

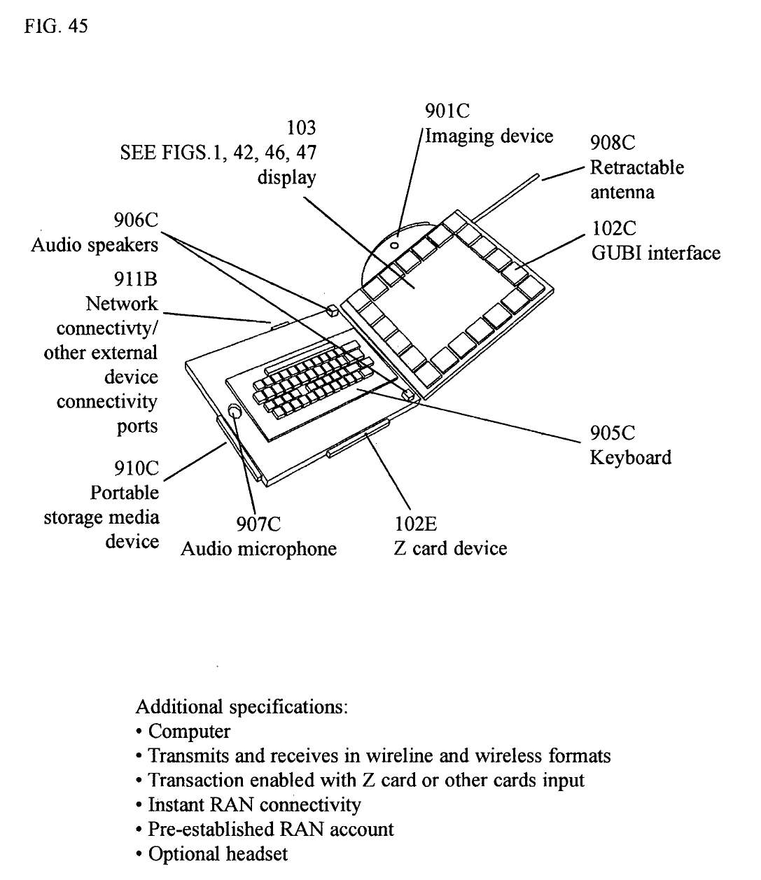

As an illustration, referring to FIG. 43 the Intelligent Boom Box and referring to FIG. 44 the Intelligent Brief Case, and referring to FIG. 45 The Intelligent Communicator:

Each device preferably synthesizes into one mobile (i.e., portable) device all, or any combination of, the functionalities for any user to experience any combination of data, sound and interactive multimedia content via any combination of the following platforms: A) imaging device, 901A, 901B, 901C, e.g,. camera utilizing digital media (or any other current or future technology); B) radio via tuner 903A, 903B, 903C, or digital medium (or any other current or future technology) for AM/FM (or any other current or future radio bands or channels); C) controls 904A, 904B, 904C, for any and all functionalities, including radio, DVD/CD (or any other current or future technology); D) keyboard 905A, 905B, 905C, accessed via ‘pull in and out’ or ‘fold up and down’ (or any other current or future technology); E) connectivity, referring to FIG. 46, 102F, to computer device(s) and/or to headset(s) for private listening and/or to the RAN Network and/or to the Internet and/or to any other computer device(s) and/or to any other network(s) via any wireless or any wireline protocol(s), e.g., fiber optics; T1, T2, T3, etc.; fragmented T1; DSL; ISDN; MMDS; Ethernet; cellular; et al (or any other current or future technology); F) audio speakers 906A, 906B, 906C, for open-air listening (or any other current or future technology); G) audio microphone 907A, 907B, 907C, for voice or other sound pickup (or any other current or future technology); H) Graphical User Button Interface, referring to FIG. 46, 102, 102A, 102A1, 102A2, 102B, 102C, 102D; I) display, referring to FIG. 46, 103, e.g., LCD screen (or any other current or future technology); J) device, referring to FIG. 46, 102E, utilized to interconnect Z-Card and any other current or future smart card technology to such computer; K) retractable antenna, 908A, 908B, 908C (and any other current or future technology); L) media player, 909A, 909B, 909C, e.g., DVD/CD (and any other current or future technology); M) computer, referring to FIG. 46, 104; N) Portable Storage Device, 910A, 910B, 910C, e.g., Zip Disk/Drive (and any other current or future technology); 0) Data Ports or other external device connectivity, 911A, 911B, 911C, e.g., RJ-45, RJ-11, USB, Infrared, (and any other current or future technology).

As a further illustration, a user is able to transmit data and/or image and/or sound and/or interactive multimedia content from any platform to any other platform, as intermediated by such computer, as a component of such mobile device.

Referring to FIG. 46, the total set of the components comprising the Graphical User Interface Buttons ‘GUBI’, including the components labelled 102A1, 102A2, 102B, 102C and 102D are components of the MARC Terminal and also the Mobile Devices, including the Intelligent Boom Box, the Intelligent Brief Case and the Intelligent Communicator.

Also, referring to FIG. 46, the component labelled 101B represents each of the components in this addendum, referring to FIGS. 43, 44 and 45, referring to the Intelligent Boom Box, the Intelligent Brief Case and the Intelligent Communicator.

The present invention may be implemented with any combination of hardware and software. If implemented as a computer-implemented apparatus, the present invention is implemented using means for performing all of the steps and functions described above. The present invention can also be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

In the above discussion of the Intelligent Mobile Devices, each occurrence of the term (screen) should be understood to be any current or future display of technology.

Direct Digital Distribution of Films to Distribution Outlets

As the digital production of films, i.e., movies, has become more and more prevalent, the distribution of digital films over digital communications platforms becomes more economically feasible. This includes the distribution of digital films via a digital communications platform to movie theatres equipped with digital film display capability.

One embodiment of the system of the present invention provides for the distribution via a digital communications media platform, which can entail a dedicated, private, confidential network of digital films to movie theatres for the digital projection of such films at such movie theatres. The digital films can be stored at and transmitted from a film production or distribution entity, or the RAN Data Base, as a service to the film company. The system is preferably scalable for global distribution.

The system constitutes a marked elimination of the cumbersome process for the physical logistics of distribution of film tape throughout the world, and the marked reduction in the cost of the distribution of film tape world-wide.

As an illustration, referring to FIG. 46, a film company or film distribution source 131 transmits a digital film from its own network which can include data base and computer, server et al., interconnected to a server 107, interconnected to the RAN global network 108, interconnected to the network (which can include computer, server et al) of a film distribution outlet 139, such as a movie theatre. The digital film can then be displayed within the outlet 139 for viewers.

As a further illustration, a film company or film distribution source 131 can transmit a digital film and a schedule for a time and place for display of such digital film and any other information from its own network. The film company network can include data base and computer, server et al., interconnected to a server 107, interconnected to the RAN global network 108, interconnected to the RAN Data Base 119, which stores such digital film and schedule and any other information and transmits such digital film to the outlet 139 according to the schedule and any other information.

As a further illustration, the RAN System, including the RAN global network and RAN Data Base et al., can be utilized to transmit digital film to private residences and various kinds of organizations for viewing at such places with computers, home entertainment systems, etc., with the capacity to store such digital film locally at such places for a limited period of time or indefinitely, or to receive such digital film via streaming protocols.

As a further illustration, the RAN System, including the RAN global network and RAN Data Base et al., can be utilized to transmit, record, store and report to the film outlets and other places, the film companies various information related to each viewing, as part of RAN's data management services.

The following is a list of some of the preferred elements of an embodiment of the system of the invention;
RAN MARC Terminals 101A
Intelligent Boom Box 101B
Intelligent Brief Case 101B
Graphical User Button Interfaces 102
Attraction Services GUBI Buttons 102A1
Featured Application GUBI Buttons 102A2
Time GUBI Button 102B
Emergency Services GUBI Button 102C
Emergency Service Distress Device 102D
Z-Card Device 102E
Display device 103
Computer devices 104
RAN Hypergate Menu Display 105A
RAN Hypergate Personal Menu Display 105B1
RAN Hypergate Enterprise Menu Display 105B2
RAN Hypergate Distinguished Menu Display 105B2
RAN Applications 106
Server 107
RAN global network 108
RAN Transactions Data Base 109
RAN Enterprise Data Base 110
RAN Consumer Data Base 111
RAN Hypergate Data Base 114
RAN Interactive Communications & Commerce Data Base 115
RAN Emergency Services Data Base 116
RAN Z-Card Data Base 117
RAN Time Data Base 118
RAN Gaming Data Base 123
RAN Enterprise Communications & Commerce Data Base 125
RAN Brain Data Base 127
RAN Shipping Data Base 129
RAN Advertising Via Software Data Base 130
Enterprise sites and consumer sites 131
Emergency Services entity 133
External network(s) and data base(s) 134
External shipping entities 135
External time keeping entity 138
Other external entities 139
Enterprise users 140
Public telecommunications carriers 141
RAN organization 142

As a further illustration, when via the RAN Primary Enterprise Hypergateway Menu Display a user selects the Enterprise Communications & Commerce option.

The present invention may be implemented with any combination of hardware and software. If implemented as a computer-implemented apparatus, the present invention is implemented using means for performing all of the steps and functions described above. The present invention can also be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A publicly accessible horizontally and vertically integrated management network architecture system for the management, operation and provision of data and services to users comprising:
(a) one or more consumer computer devices;
(b) one or more enterprise computer devices; and
(c) a communication network interconnecting the consumer computer devices and the enterprise computer devices.
